(19) United States
(12) Patent Application Publication
(10) Pub. No.: US 2025/0196012 A1
(43) Pub. Date: Jun. 19, 2025

(54) SOCIAL NETWORKED GAMING MERCENARY

(71) Applicant: Adeia Guides Inc., San Jose, CA (US)

(72) Inventors: Christopher Phillips, Hartwell, GA (US); Charles Dasher, Lawrenceville, GA (US); Reda Harb, Tampa, FL (US)

(21) Appl. No.: 18/539,731

(22) Filed: Dec. 14, 2023

(51) Int. Cl. A63F 13/69; A63F 13/48; A63F 13/79; A63F 13/847

(52) U.S. Cl. CPC A63F 13/69; A63F 13/48; A63F 13/79; A63F 13/847

(57) ABSTRACT

Systems and methods for enhancing a first user's video gaming experience by enabling a second user to join as a mercenary. The systems and methods comprise transmitting an invitation to the second user to join the first user's gaming session, and receiving an acceptance from the second user. The systems and methods then include determining whether a current point in the first user's gaming session corresponds to an insertion point for the second user to be added. In response, the systems and method modify the gaming session to be a multiplayer gaming session and add the second user. The systems and methods then identify an end trigger point in the modified gaming session, and responsively remove the second user from the modified gaming session and revert the gaming session back to a single player mode.

### FIELD OF INVENTION

The present disclosure relates to integrating gaming and social media to provide a dynamic, interactive, and personalized gaming experience. For example, the present disclosure describes techniques for enhancing a first user's video gaming experience by enabling a second user to join as a mercenary and, more particularly, to enabling a switch from a single player gaming session to a multiplayer gaming session after the mercenary accepts an invitation to join the first user's gaming session.

### SUMMARY

Personal computer (PC)-based video gaming and console-based video gaming experiences have been disconnected in some ways from the social media experiences of many users. That is, while in one approach, video games have been created for, or targeted to, particular social media platforms, there is a lack of advanced integration between social media and more advanced PC and console-based games. Further, while in one approach, game subscription services enable a link between a user's social media profile and their gaming profile, such linking fails to provide for advanced social media integration with the user's game play.

In another approach, video game systems offer a user to play the video game in either multiplayer mode or single player mode. In multiplayer mode, a user can join a battle where players' characters play against other players' characters or against characters controlled by the video gaming system. In some cases, there are specific modes where all players are human and play against each other. In some examples of multiplayer mode, a player may be part of a team and the game may include multiple teams each having an even number of players. Some game modes may specify that each player forms his or her own team, otherwise known as a free-for-all. In many instances, these games may be time-based, kill limit based, or based on capturing the most area in the game space, for example. Other game types are possible in multiplayer mode as well. Many games, including those that offer multiplayer game modes, also offer single player experiences where a player plays against computer-controlled enemies also known as “bots.” In such approach, video games may either be in a multiplayer state or a single player state and may not allow for easy switching between multiplayer and single player modes when the user is currently playing in one of those modes. For example, at best, the user might be the only player that is participating in a multi-player game, such as if other users leave the game session, but this does not involve transitioning between single and multi-player gaming modes. In some cases, a user playing in single player mode may get stuck in a boss fight or at a point of the game the user cannot complete. In many games, the user is unable to request help, and has no option but to continue to try to get past the boss fight on his own. In some further approaches, adding a second player to a first player's gaming session takes a relatively long time, may be complex, and may include many different processes. Additionally, adding the second player may be noticeable to the first player, which in some circumstances may be counter to the purpose of adding the second player (e.g., when the second player is a mercenary sent to eliminate the first player).

To help overcome these problems, the present disclosure provides for systems, methods, and apparatuses configured for: transmitting an invitation to join a future or a current gaming session of a first user; receiving, from a second user via a second computing device, an acceptance of the invitation; and determining that the gaming session has commenced, the gaming session comprising the video game being played, by the first user on a first computing device, in a single player mode in which a first character of the first user is participating without characters of other users. The systems, methods, and apparatuses are also configured for determining whether a current point in the gaming session for the video game corresponds to an insertion point. Further, the systems, methods, and apparatuses are configured for, in response to determining that the current point in the gaming session for the video game corresponds to the insertion point: modifying the gaming session by (1) instantiating a multiplayer mode to cause the gaming session for the video game to change from the single player mode to the multiplayer mode, and (2) causing the first computing device to connect to a multiplayer video game server, wherein the multiplayer video game server enables the second user to control a second character of the modified gaming session (either directly or via an emulation of the second user), and wherein the modified gaming session comprises each of the first character of the first user and the second character of the second user participating in the video game. Further, the systems, methods, and apparatuses are configured for determining whether a current point in the modified gaming session for the video game corresponds to an end trigger point; and in response to determining that the current point in the modified gaming session corresponds to the end trigger point: (1) removing the second user from the modified gaming session, and (2) causing the modified gaming session for the video game to change from the multiplayer mode back to the single player mode.

For example, such aspects of the present disclosure enable a first user to invite a second user (and/or emulated second user) to the first user's game to assist the first user with a level, boss fight, challenge, or other portion of the game. Alternatively, a user may request a mercenary user to join a target user's game (e.g., an elimination target), so as to eliminate the target user's character. In each of these scenarios, a user may transmit an invitation via the gaming system associated with the particular game, and/or via a connected social media account or accounts. As described in further detail below, the invitation may be a request for help completing a level or boss fight or may be an invitation to eliminate a target user's character. Once a second user accepts the invitation, the system may monitor for an insertion point in the first user's (or target user's) gaming session. The insertion point may be the point at which the game is started, when the player character reaches a cutscene or begins a level, or any other suitable point in the gaming session. The modified gaming session then continues until an end trigger point is reached. The end trigger point may be the completion of a task (e.g., completing a level, eliminating a boss, etc.). Once the end trigger point is reached, the second user (or mercenary) may be removed from the gaming session, and the gaming session may transition back to a single player gaming session.

By providing a system for advanced social media integration with a user's gaming experience, embodiments of the present disclosure provide various advantages. In some examples, the system enables a user to link their gaming profile for a particular game or gaming account with their social media accounts. In some examples, the system enables a user to maintain a mercenary ranking related to but separate from any single game, such that the mercenary ranking can be improved by playing in multiple different games. In some examples, the system enables the user to request assistance in a particular game from a mercenary via their social media accounts. In some examples, the requested assistance may be a hit or elimination of another user's character in a particular game. In other examples, the request may be for some other antagonistic action against another user (which may depend on the game being played). The system may enable the user to search for assistance from friends, all players of the video game, and more. Additionally, the system may enable a user to search for a particular mercenary or select from a set of mercenaries via social media accounts, and such mercenaries may be ranked based on mercenary skill levels, the mercenaries' player character types, whether there is an emulated version available, or any other suitable criterion.

In some examples, the system also enables the user to unlock additional gameplay by linking gaming profile to social media accounts. The additional gameplay may include the ability for the user to play as a mercenary alongside or in opposition to another user in the other user's game (e.g., as a second protagonist character, as an antagonist character, or as a boss or some other character typically controlled by the gaming system). The additional gameplay may also include mercenary mode challenges or minigames, which may be used to provide a ranking system for mercenaries. Further, in some examples, the system disclosed herein may enable a user to record, share, and/or stream audio and video of their gaming experience via their social media accounts.

In some examples the invitation may be sent to a set of other users including friends of the first user, users currently playing the video game, users with a skill level in the video game above a threshold level, and/or users of the video game having a character with a predetermined class (e.g., medic, support, sniper, tank, etc.).

In some examples, the invitation may be sent by a third party, and may be a request to eliminate the first user's character. In this case, the first user may be prevented from being alerted that the invitation was transmitted, accepted, and/or that the second user or mercenary has joined.

In some examples, the insertion point of the gaming session comprises the start of the gaming session for the video game, or that the first user playing the video game has reached a checkpoint that initiates a cutscene. In some examples, such as where the second user is a mercenary tasked with eliminating the first user, adding the second user (or emulation of the second user) to the first user's gaming session at the insertion point may enable the gaming system to prevent the first user from being made aware that the second user is being added. The gaming system may add the second user to the gaming session at the insertion point, even if the second user cannot actually play or interact with the first user until a later point in the gaming session. The gaming system may essentially preload the second user into the gaming session at the insertion point, such that when the later point in the gaming session arrives (e.g., the point at which the second user can interact with the first user), the gaming session does not need to pause or delay to load in the second user. The gaming session may continue as normal, without any indication to the first user that the gaming session has been modified and a second user has joined.

In some examples, the end trigger point may be a death of the first user's character in the video game, a death of the second user's character or mercenary's character in the video game, a death of a boss in the video game, a completion of a level of the video game, a completion of a task in the video game, and/or a passage of a predetermined duration of play of the video game.

In some examples, the invitation may be transmitted by a third user, wherein the invitation includes a request to eliminate the first user's character. In this case, the invitation may be transmitted at a first point in time, whether or not the first user is currently playing a game. When the first user then begins playing the game to which the invitation corresponds, the mercenary who accepted the invitation may be provided with an alert. The alert may be a social media post or other notification indicating that the first user has started a gaming session of the relevant video game. Furthermore, where the invitation is an elimination request, the end trigger point may be the elimination of the first character of the first user in the video game or the elimination of the second character of the second user (e.g., mercenary) in the video game. In either case, the system may provide an alert to the first user, second user, and/or third user (who initiated the elimination request), indicating whether the first user's character was eliminated or not. Additionally, once the end trigger point has occurred, a reward may be provided to the mercenary depending on whether the mercenary successfully completed the requirements of the invitation.

In some examples, the first user may select a standby request option, for example in the first user's settings or user profile. The standby request may be an automatic transmission of an invitation for help if certain conditions are met. That is, if one or more requirements in the first user's gaming session are satisfied (e.g., dying to the Boss X number of times in a row), an invitation requesting help from a mercenary may be automatically transmitted. The standby request may also enable the gaming system to anticipate the request for assistance, and responsively perform a fast start-up of the multiplayer gaming session. In anticipation of the standby request being sent, the gaming system may preload files and/or execute some or all of the required processes for transitioning from the single player gaming session to the multiplayer gaming session. The gaming system can thereby enable fast and seamless transition for a first user who is stuck in a game from the single player mode to a multiplayer mode including the second user who is there to assist.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 shows a block diagram for a process for inviting a second user to a first user's gaming session, modifying the first users gaming session to include the second user, and removing the second user after an end trigger point is reached, in accordance with some embodiment of the disclosure;

FIG. 2 is an illustrative user interface presented during a first user's gaming session enabling the first user to invite a second user, in accordance with some examples of the disclosure;

FIG. 3 is an illustrative user interface presented during a first user's gaming session enabling the first user to select a mercenary to invite, in accordance with some examples of the disclosure;

FIG. 4 is an illustrative user interface presented during a first user's gaming session providing information about a list of candidate mercenaries to invite, in accordance with some examples of the disclosure;

FIG. 5 is an illustrative user interface presented during a first user's gaming session after an invitation has been sent to a candidate mercenary, in accordance with some examples of the disclosure;

FIG. 6 is an illustrative user interface presented to a candidate mercenary illustrating options for progressing through a ranking system associated with the mercenary mode for a game, in accordance with some examples of the disclosure;

FIG. 7 is an illustrative user interface presented to a first user illustrating an option to hire a mercenary in response to being eliminated during a game, in accordance with some examples of the disclosure;

FIG. 8 is an illustrative social media post including an invitation to join a first user, in accordance with some examples of the disclosure;

FIG. 9 is an illustrative system architecture for enabling the functions described herein with respect to a mercenary mode, in accordance with some examples of the disclosure;

FIG. 10 is an illustrative system diagram for a client device to enable the functions described herein with respect to a mercenary mode, in accordance with some examples of the disclosure;

FIG. 11 is an illustrative flowchart of a process for a user to enter mercenary mode during a gaming session, in accordance with some examples of the disclosure;

FIG. 12 is an illustrative flowchart of a process for a user to download mercenary mode minigames during a gaming session, in accordance with some examples of the disclosure;

FIG. 13 is an illustrative flowchart of a process for a user to play and complete mercenary mode minigames, in accordance with some examples of the disclosure;

FIGS. 14A-B are illustrative flowcharts for a user to request help from a mercenary during a gaming session, in accordance with some embodiments of the disclosure;

FIGS. 15A-C are an illustrative flowchart for an invited mercenary to join a user and help the user complete a level in the user's game, using the mercenary's player controlled character or emulated character, in accordance with some examples of the disclosure;

FIGS. 16A-C are illustrative flowcharts for enabling an invited mercenary to join a user and help the user complete a level in the user's game, in accordance with some embodiments of the disclosure;

FIG. 17 is an illustrative flowchart of a process for a user to make a hit or elimination request with respect to a target user's player character, from a gaming system platform, in accordance with some embodiments of the disclosure;

FIG. 18 is an illustrative flowchart of a process for a user to make a hit or elimination request with respect to a target user's player character, from a social media account, in accordance with some embodiments of the disclosure;

FIG. 19 is an illustrative flowchart of a process for notifying a mercenary when the target player of a requested hit or elimination request is playing a relevant game, in accordance with some embodiments of the disclosure;

FIGS. 20A-D are an illustrative flowchart of a process for a mercenary to send an emulated player character to perform a hit or elimination request, in accordance with some embodiments of the disclosure;

FIGS. 21A-C are an illustrative flowchart of a process for a mercenary to join the target user's gaming session to perform a hit or elimination request, in accordance with some embodiments of the disclosure;

FIG. 22 is a block diagram representing devices, components of each device, and data flow therebetween for carrying out the functions and features disclosed herein, in accordance with some embodiments of the disclosure.

### DETAILED DESCRIPTION

Embodiments of the present disclosure relate to using social media to enhance the video gaming experience of users. Users' experiences can be enhanced in a number of ways, such as by enabling a first user to request assistance from a second user or enabling a third user to request that a first user (target user) be eliminated by a second user, for example. Other benefits are provided as well, as described herein. In the first scenario (e.g., a first user requesting assistance), the first user may be playing a video game and may reach a point where they are having difficulty progressing. The first user may request assistance from a mercenary via the gaming platform on which the video game is played, via social media, or via some other system. For example, if the first user is stuck at a boss fight or is having difficulty completing a particular level in a single player game, the player may make a request (invitation) for a mercenary to join and assist in getting past the boss fight or level. In the second scenario a third user (requesting user) may request the elimination of a first user (target player) by a second player (mercenary). This may occur, for example, in response to the third user being eliminated by the first user, and seeking revenge by putting out an elimination request on that first user. In both of these scenarios, the video game may operate in conjunction with a “mercenary mode,” described in further detail below.

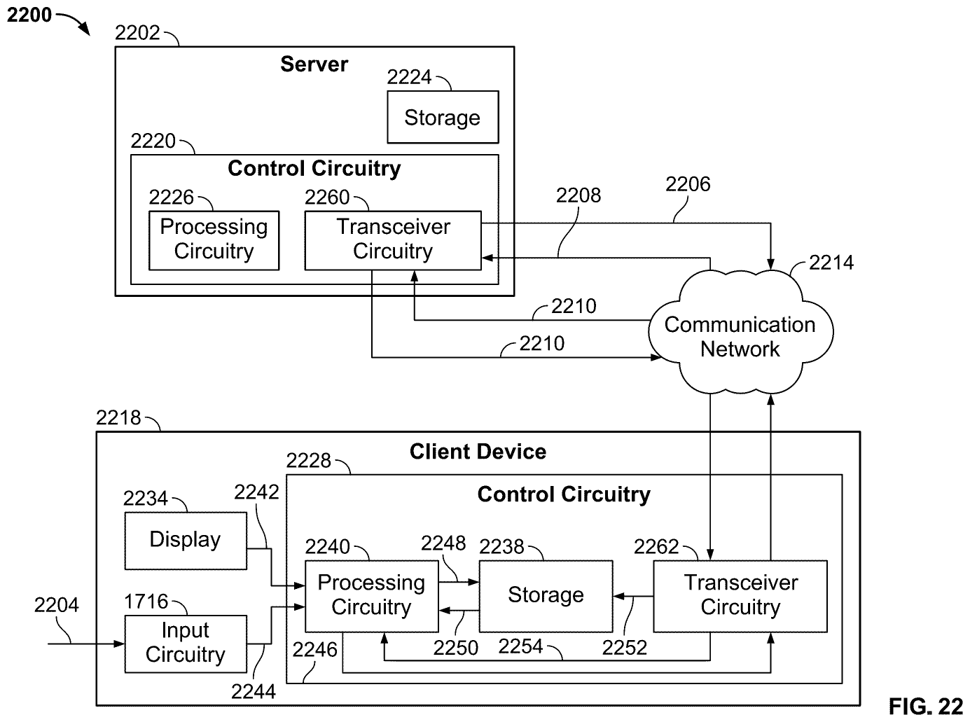

Within this disclosure, a gaming platform or gaming system may be understood as any suitable combination of electronic and/or computer hardware and software created for hosting, enabling playing of, and/or displaying of, video games. For example, a Sony PlayStation®, Xbox®, Nintendo Switch®, or cloud-based gaming platform such as Nvidia's GeForce Now® and Sony's PS Now®, which offer remote game streaming as a service (GaaS), or any other suitable video game platform, or any combination thereof. A social media platform may be any website, application, or infrastructure that enables internet-based communication between users of the platform. Depending on the embodiment, a social media platform may enable users to share content such as text, images, audio, and/or video. In some embodiments, the gaming system, configured to perform the functionalities described herein, may comprise one or more applications executed at least in part on client devices (e.g., client device 2218 of FIG. 22) and/or at one or more remote servers (e.g., server 2200 of FIG. 22) and/or at or distributed across any of one or more other suitable computing devices, in communication over any suitable type of network (e.g., the Internet). In some embodiments, the gaming platform or gaming system may be in communication (e.g., via an application programming interface (API) or via any other suitable mechanism) with the social media platform, and/or the gaming platform may comprise its own social media platform.

Within this disclosure, certain embodiments may make use of an emulated player character. An emulated player character may make use of artificial intelligence (AI) to create a model of a specific user or player's character within a video game. The model may be created using, for example, a reinforcement learning architecture for machine learning (ML). In some embodiments, that specific player character may be modeled or emulated on a gaming platform, enabling numerous users to experience playing with the specific player (by way of the model or emulation) even when, for example, the specific player is not online or is busy in another gaming session.

In this disclosure, a mercenary mode may be a mode of operation with respect to one or more gaming systems that is selectable by a user. The mercenary mode may include functionality and content related to one or more video games but may not be specific to any one particular video game.

In some examples, the mercenary mode may be user activated. That is, each user may decide individually whether to activate or deactivate mercenary mode. Activating mercenary mode may allow the user to request assistance in a video game, request the elimination of another player, and/or be selectable as the target of another user's elimination request. In some examples, the user may have the option to select a subset of functionality. For example, the user may be able to turn on the ability to request assistance without turning on the ability to request the elimination of other users, or to become a target of an elimination request. This may enable a user to request assistance without fear of being the target of an elimination request. In some embodiments, mercenary mode may be automatically, e.g., as a default setting, implemented in certain video games.

In some examples, mercenary mode may be activated (or deactivated) on a per game basis. Each game may have a separate option. Additionally, mercenary mode may be activated for certain types of games (e.g., all first person shooters, all racing games, etc.). Further, in some examples, mercenary mode may be activated by a user for all games, or all games on a certain gaming system (e.g., PC games, XBOX games, etc.). Other subsets may be used as well.

In some examples, upon activating mercenary mode for a certain game, the user may be placed into a pool of mercenaries available to be selected for that game. Additionally, upon activation of mercenary mode, the social profiles associated with a user may then be suggested to other users who may share similar gaming history, expressed interests, geographic location, or other characteristics.

As noted above, activating mercenary mode may enable the various functions and features described herein. For example, in a portion of a game ordinarily completed by a single player (e.g., a single player game or the story portion of a multiplayer game), the user may request assistance from a mercenary. This may enable turning a single player game into a multiplayer game by inviting the second user to join. The second user may play the game as a second protagonist alongside the first user, as an NPC (e.g., boss, or any other suitable character otherwise controlled by gaming system), or as an adversarial character competing against the first user.

In another example, the mercenary mode enables the features associated with an elimination request, wherein a third user invites a second user to eliminate the first user. In this example, the mercenary mode enables the mercenary to join the first user's single player game or multiplayer game for the purpose of eliminating the first user. The first user (target) may be kept unaware that the mercenary has joined and is controlling a character within the game. Alternatively, the first user (target) may be alerted or notified that a mercenary is present in the game, and/or which character is controlled by the mercenary.

In some examples, mercenary mode may operate in conjunction with multiplayer games as well (e.g., Call of Duty, Fortnite, etc.). These multiplayer games may include a matchmaking functionality that joins multiple users together for a gaming session. In this case, mercenary mode may enable the mercenary performing the elimination request to be matched with a target user during the matchmaking, to ensure that both players are joined to or placed in the same gaming session.

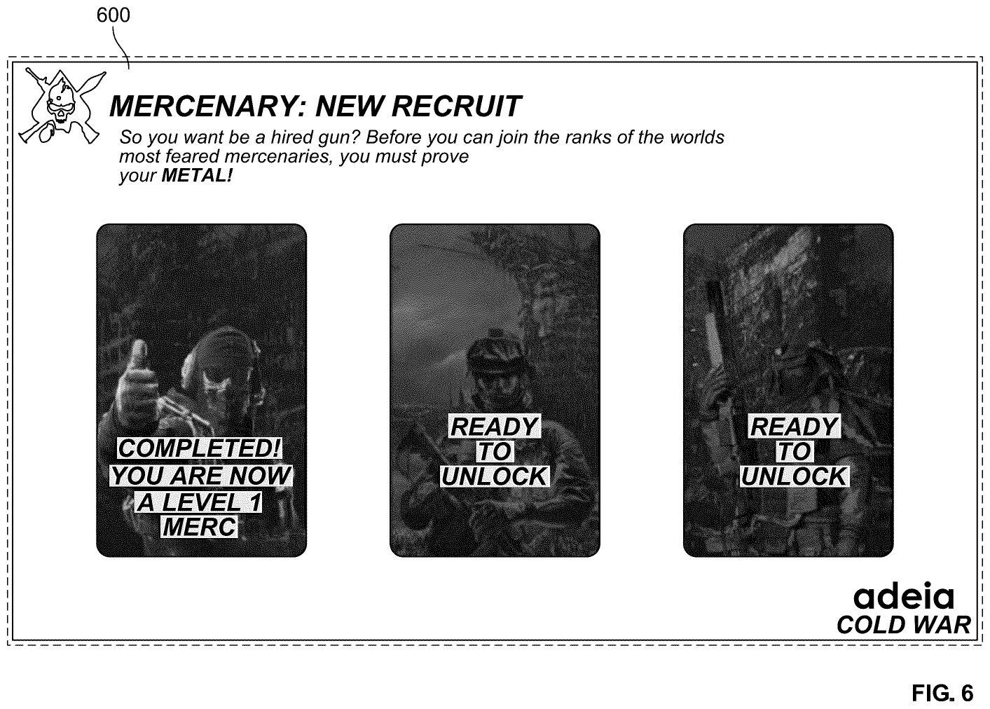

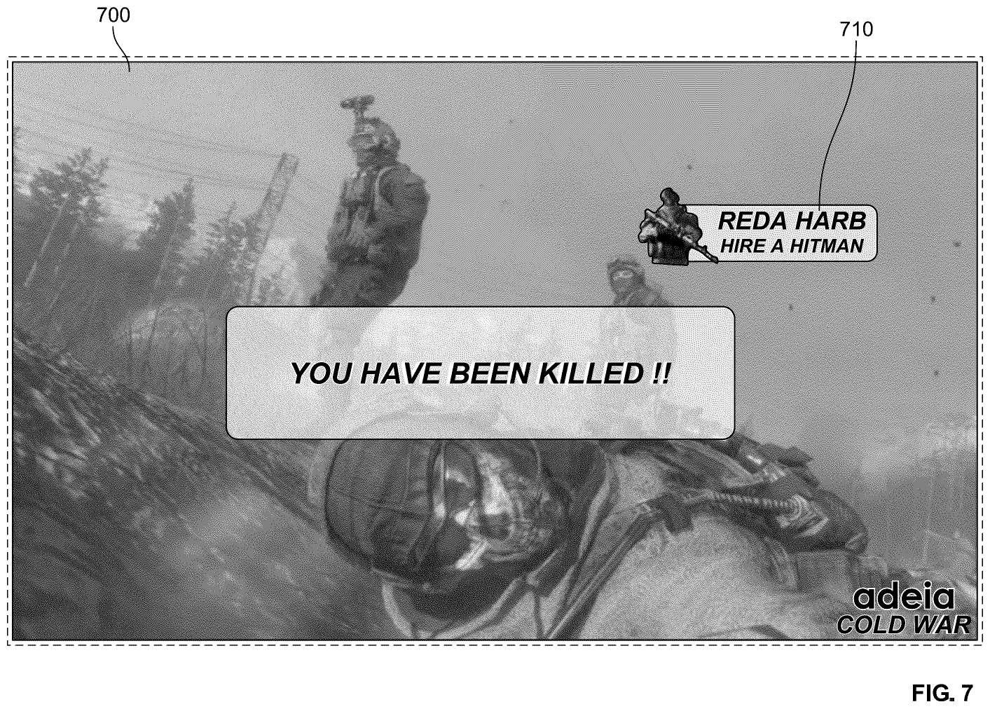

In some examples, each user may have a mercenary level or rank. The user's mercenary level or rank may be a rank of the user across all games, across all games for which mercenary mode is activated for that user, for only a particular game, for only a particular, game type (e.g., first person shooter, strategy, racing, etc.), and more. That is, each user may have a single mercenary level, or may have multiple levels associated with subsets of games. As discussed in further detail below (particularly with respect to FIGS. 6, 12 and 13), the user may perform tasks, play minigames, or other challenges to increase their level. The tasks, minigames, or challenges may be specific to one or more games or game types. That is, a certain type of minigame may level up the user's mercenary rank for a racing game, but may not affect the user's mercenary rank for a first person shooter game.

When an invitation to join the first user's gaming session is sent, there may be multiple candidate mercenaries vying to accept the invitation. If there are multiple candidate mercenaries who accept the invitation, the gaming system may initiate a competition to determine which candidate mercenary is accepted. The competition may be a determination of which candidate achieves the highest score in a minigame, which candidate has the highest level or ranking in a relevant area, and/or some other ranking criteria. In an example, the candidate mercenaries may be asked to complete a 30-second challenge based on the role that they will be hired for based on the invitation. This challenge may be determined by the gaming system, and/or by the first user or player hiring the mercenary. For instance, if the first user requests the assistance of a sniper in an FPS game, the challenge may be a 30 second game in which the candidate mercenaries need to find and kill a target using a sniper.

As disclosed herein, mercenary mode may provide added game content. For example, if mercenary mode activated for a particular game, this game may enable additional content that is only playable by a mercenary character (e.g., an extra boss level where the mercenary plays as the boss), or is only playable by the first user when a mercenary character is part of the gaming session (e.g., levels of the game that are only accessible to the first user when a mercenary is also present). In some examples, the gaming system may enable or prevent a mercenary from being added for certain levels or portions of a game. Additionally, the first player's progress may dictate when to insert the mercenary into the game. For instance, if an elimination request is sent for a first player who is currently at level 7 of a game, and levels 7, 8 and 9 do not allow mercenary mode or content, the gaming system may wait until the first user reaches level 10 to insert the mercenary. Additionally, the mercenary mode may include otherwise inaccessible minigames that allow users to increase their mercenary rank for X game, X game type, etc. In some examples, added functionality may apply to one or more characters in a video game when controlled by a mercenary. For example, a Boss character may be granted additional health when controlled by a mercenary as opposed to if such character is controlled by the gaming system. FIG. 6 illustrates an example user interface 600 presented to a candidate mercenary, illustrating the options for progressing through a mercenary ranking system associated with the mercenary mode.

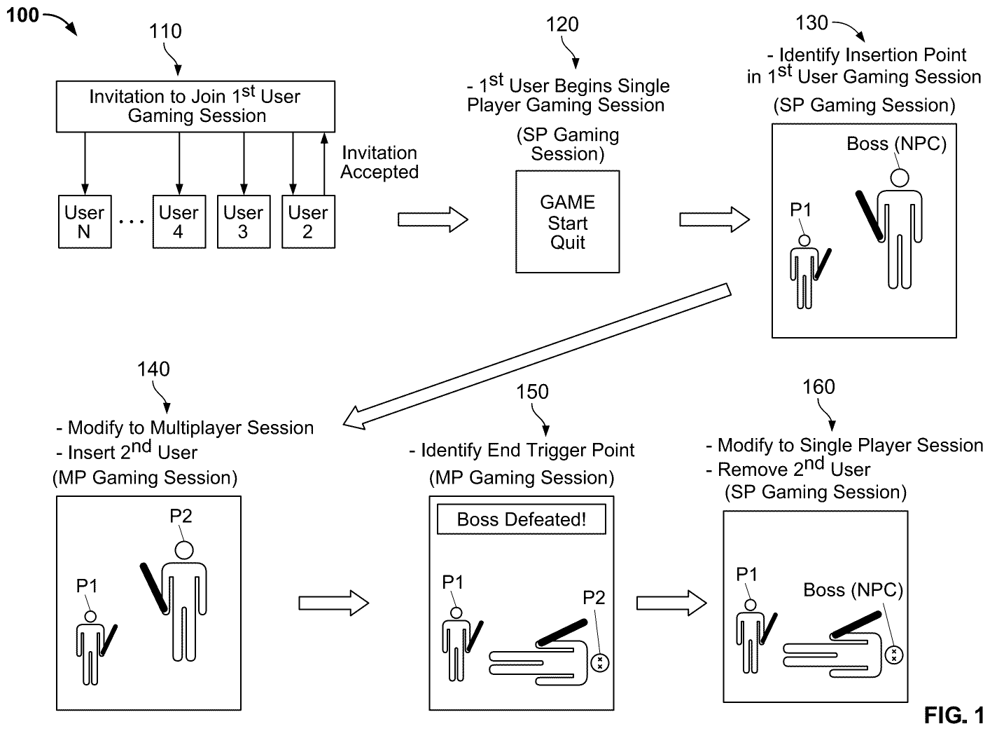

Turning now to FIG. 1, diagram 100 shows a block diagram for a process for a gaming system to invite a second user to a first user's gaming session, modify the first user's gaming session to be a multiplayer session including the second user, and then remove the second user after an end trigger point is reached, in accordance with some embodiments of the disclosure. In the illustrated example, the second user is invited by a third player to control the boss character in the first user's game. The third user may have sent an invitation to multiple candidate mercenaries including an elimination request, wherein the third user requests that a mercenary (in this case the second user) eliminate the target user (e.g., the first user) within the selected video game.

At step 110, the gaming system receives, from a computing device of the third user, an invitation, e.g., via social media, to join the first user's gaming session and eliminate the target. As described in further detail below, an invitation may be sent by the first user (e.g., to request assistance), or by a third party seeking to eliminate the first player's character in a game (as illustrated in FIG. 1). The invitation may be sent to multiple candidate mercenaries, such as users 2-N in FIG. 1. If the gaming system determines that one or more of the candidate mercenaries accepts the invitation (e.g., the second user), the gaming system may cause the invitation to be deleted or hidden for the other candidate mercenaries so that only one mercenary is accepted into the gaming session. Additionally, the gaming system may create a record linking the accepting mercenary to the first player (e.g., target). This record may be used by the gaming system for other steps described herein, such as to set up a multiplayer gaming session including both the mercenary and the first player.

At step 120, sometime after the invitation was sent and accepted, the first user begins playing the game in a single player mode or in a single player gaming session. That is, the invitation may be a request to join the first user's gaming session immediately, or at any point in the future. In some embodiments, the gaming session may be ongoing, e.g., the gaming system may be providing the first user's single player gaming session when the invitation at 110 is received.

At step 130, the gaming system identifies an insertion point in the first user's gaming session, at which to insert the second user into the first user's game. As described below, the insertion point may be when the first user starts the game, reaches a checkpoint, reaches a boss, or at any other point in time. In the illustrated example of FIG. 1, the insertion point in the first user's gaming session is the point during the game at which the boss character spawns. At step 130, the gaming session is a single player gaming session with the player character P1 controlled by the first user, and the boss character controlled by the gaming system as an NPC (non-player character). In some embodiments, the insertion point may be set automatically by the gaming system (e.g., based on historical insertion points in the video game), by the user having transmitted the invitation at 110, or by the first user having been participating in the single player mode.

At step 140, in response to determining that the insertion point has arrived (e.g., that the current point in the first user's gaming session is the identified insertion point), the gaming system modifies the first user's gaming session from a single player session to a multiplayer session. This may include the gaming system instantiating a multiplayer mode or instantiating a multiplayer gaming session that may be joined by one or more users. In some examples, a mercenary may join the gaming session at a beginning of the session (e.g., when the session begins, when the first user starts the game, etc.) but the mercenary may not be active or able to control any in-game character until the first user reaches a certain point (e.g., when the first user reaches a location where a boss fight is set to occur). By adding the mercenary to the gaming session at a point prior to when the first user reaches the boss fight, the first user may remain oblivious to the fact that the gaming session has transitioned from single player to multiplayer mode, and may thus remain unaware that the boss is controlled by the mercenary. The gaming system may insert the second user into the modified gaming session. In FIG. 1, the second user is inserted into the modified gaming session to control the boss character, identified as P2 in step 140. In an alternative scenario, the second user may be inserted to control a second protagonist, to control a different NPC (e.g., not the boss), or to control some other character or aspect of the game. Once added to the modified gaming session, the second user then controls the boss character in the modified gaming session. The first user may or may not be made aware of the fact that the second user now controls the boss character.

At step 150, the gaming system determines whether an end trigger point has occurred. As described in further detail below, the end trigger point may be the end of a level, the elimination of the boss, the elimination of the first user, the elimination of the second user, or any other suitable occurrence in the gaming session, or any combination thereof. In the illustrated example of FIG. 1, the end trigger point is the elimination of the boss character controlled by the second user P2. In an alternative scenario where the second user controls a second protagonist, the end trigger point may be when the first user and the second user together eliminate the boss character.

At step 160, in response to determining that the end trigger point has occurred, the gaming system may modify the gaming session from the multiplayer gaming session back to a single player gaming session. The gaming system may also remove the second user from the gaming session. The gaming system may essentially revert the gaming session back to the original state wherein the first user plays the game in a single player mode via a single player gaming session. Control of the boss character may also be reverted back to the gaming system.

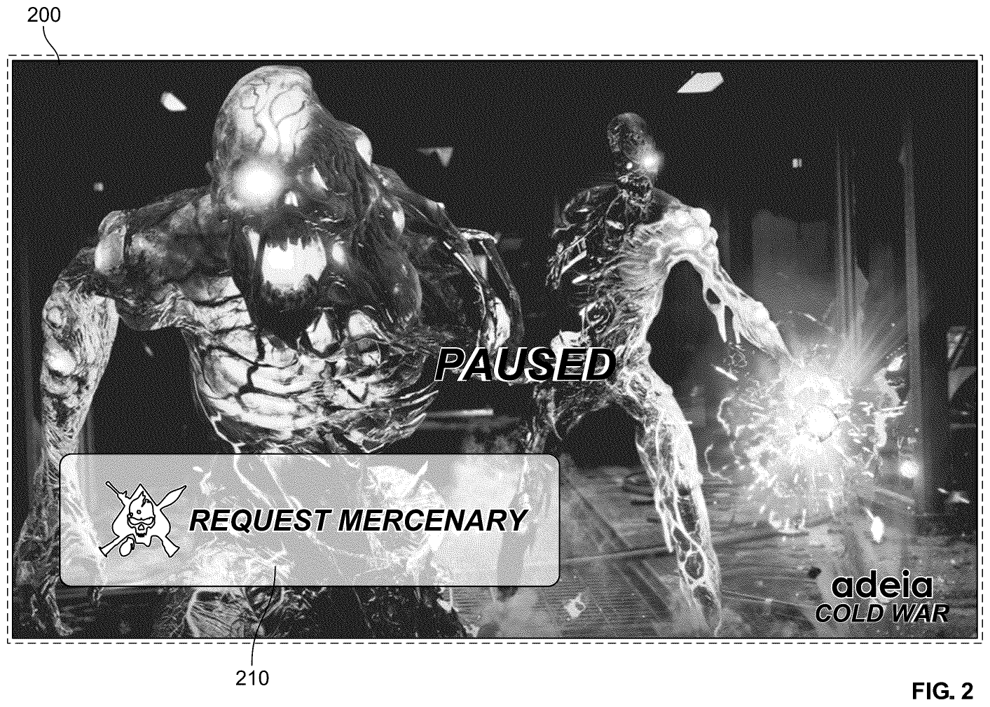

Referring now to FIGS. 2-8 in combination with the disclosure of FIG. 1, various aspects are described in further detail. As indicated above, an invitation may be sent to invite a mercenary to a first user's gaming session. The invitation may be sent as a post or other social media item via a social media account, or may be sent via a gaming system account associated with the requesting user. The invitation may include various information such as the game, the user requesting help, the particular task the user needs help with, a link for mercenary to select to accept invitation, and/or a link that allows the mercenary to accept and automatically load/start the relevant game.

In some examples, the invitation may be sent by a user based on a menu selection within a game, based on a combination of controller presses, and/or in response to a voice input.

The invitation may be a request for assistance. For example, the invitation may include a request for help completing a task within a video game, completing a level, eliminating a boss, progressing to a checkpoint, or any other suitable task within a game. The invitation may also be a request to assist the first user immediately, or at some future point in time. FIG. 2 illustrates an example user interface 200 of a first user's video game providing an option 210 for the first user to request help from a mercenary.

In some examples, the invitation may be a hit or a request to eliminate a user's character. An elimination request invitation may be sent by the first user (e.g., placing a hit on himself), or may be sent by a third user (e.g., requesting the elimination of the first user or target user). The invitation requesting the elimination of a target may be sent even if the target is not currently playing the game. Additionally, the invitation may include a time period or duration attached, such as a requirement that the invitation be accepted within a certain time, or that the requested elimination be carried out within a certain time, otherwise the elimination request is revoked or canceled.

In some examples, the invitation may include a request to assist with or carry out some other game specific function, depending on the particular game associated with the invitation.

In some examples the user requesting help via the invitation (or requesting a mercenary to eliminate a target) can search or filter users to whom the invitation is sent. As a non-exhaustive list the user may filter users to send the invitation to, for example, (a) a single or group of individual users selected by the first user, (b) all players of a particular game with or without mercenary mode active, (c) players of a game using a particular gaming system (e.g., only PC user, only XBOX users), (d) players of the game playing in either single or multiplayer mode (e.g., in a separate session), (e), players that are currently playing in other gaming sessions separate from the first user, (f) players with the same or higher skill level in the game than the requesting user or target user, (g), players in a certain geographic area, (h) all friends of the requesting user, (i) all currently playing players of the game, (j) players of game with above a threshold skill level, (k) players of the game with a character having certain class (e.g., medic, support, tank, etc.), (l) all players with certain progress in the game (e.g., players who have completed a particular task, have a certain score, etc.), (m) players who completed a certain task in less than some threshold number of attempts, (n) all players with a mercenary level higher than a threshold level, (m) all players with a mercenary subscore relevant to the particular task that is above a threshold level, (o) a combination of any of the criteria above.

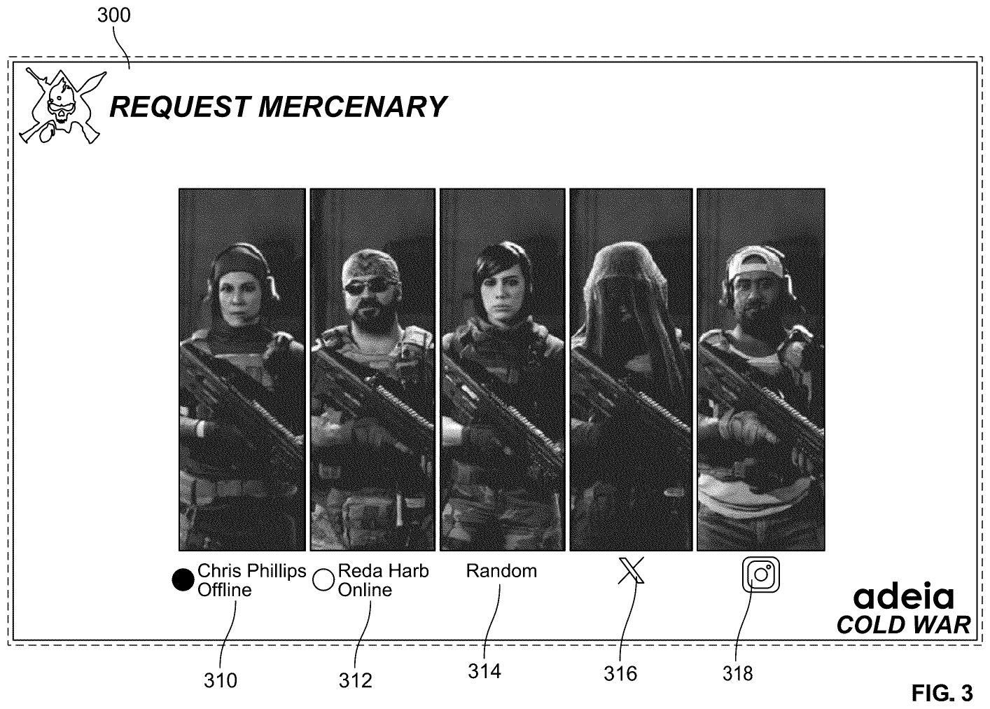

FIG. 3 illustrates an example user interface 300 of a first user's video game providing an option to select which candidate mercenary or mercenaries from whom to request help. In the illustrated example, the first user has the option to select one or more of their friends 310 and 312, a random player of the game 314, or to post the invitation via social media via the user's connected accounts with Twitter (now X) 316 and Instagram 318.

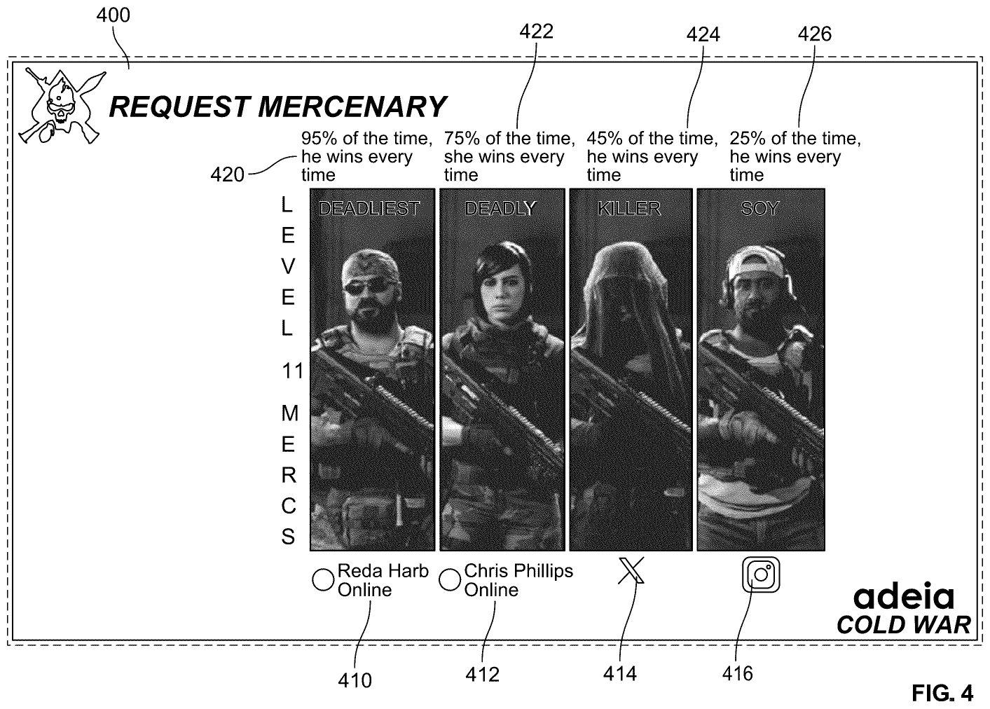

FIG. 4 illustrates an example user interface 400 of a first user's video game providing an option to select which candidate mercenary or mercenaries from whom to request help. In this example, the system presents the first user with additional information about each candidate mercenary which may be relevant to the first user's selection of a mercenary. The first user may select one of their friends 410 or 412 to send the invitation, and/or to post the request via social media sites 414 and/or 416. The additional information 420-426 associated with each of the options may indicate the success rate for each candidate mercenary at completing a task for which the user is requesting assistance. For example, the additional information 420 and 422 for friends 410 and 412 may specify each candidate's success rate at completing the task. For social media sites 414 and 416, the additional information 424 and 426 may reflect the average success rate at the task for users available as mercenaries from the pools of players accessible via each social media site.

The invitation may be sent to a single candidate mercenary, or to a group of candidate mercenaries. If sent to a group, the candidates may then complete one or more challenges related to the task associated with the invitation (described above). The challenge may correspond to the task the first user seeks help with (e.g., eliminating a boss, passing a level, completing a puzzle, completing a challenge as a particular character type, etc.). The challenge may also or alternatively be a short minigame based on the role the mercenary is being hired for. In some examples, the user sending the invitation may be presented videos of a subset of available mercenaries (e.g., the top 5 at a particular task), and may issue a request to one or more mercenaries of the subset directly from the corresponding video (e.g., by pressing on an “Invite” button overlaid the showcased video).

After the invitation is sent to the candidate mercenary or mercenaries, the requesting user awaits a response or acceptance of the invitation.

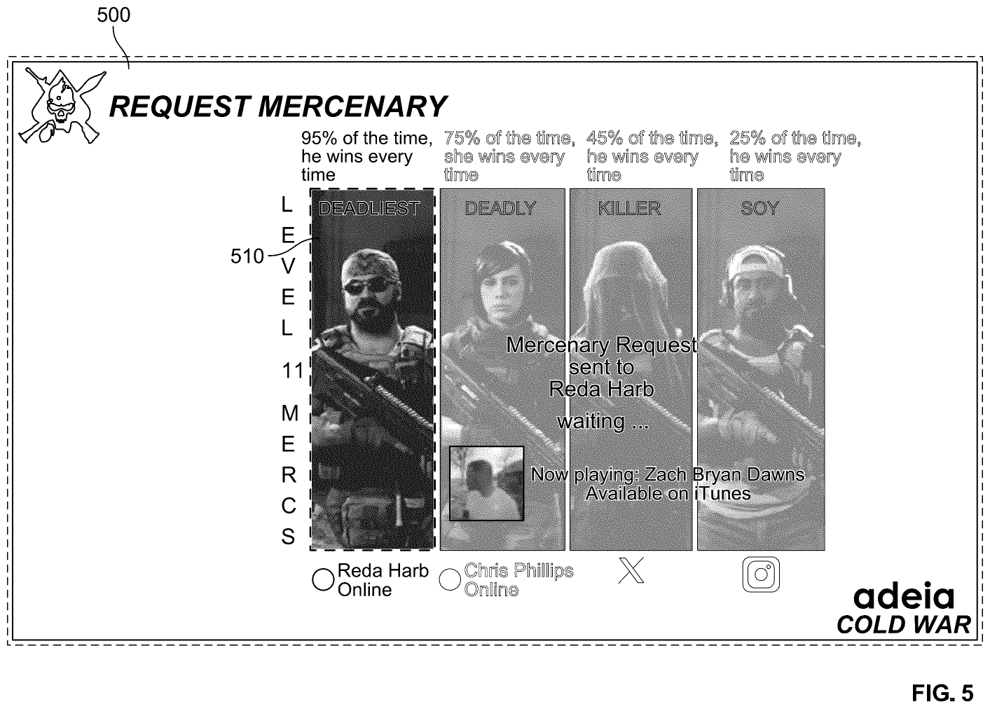

FIG. 5 illustrates an example user interface 500 of a first user's video game indicating that an invitation has been sent to the candidate mercenary 510. The user interface may also provide additional information to the first user, such as whether the candidate mercenary is currently online, whether an acceptance or response has been received from the candidate mercenary, and/or whether the candidate mercenary is currently using a different application or playing a different game (in FIG. 5, the candidate mercenary 510 is listening to a song in a music application).

In some examples, an invitation may be sent to a candidate mercenary who is not currently online, or is not currently playing the game. In this case, the first user may resume playing the single player game while awaiting a response to the invitation.

In some examples, the first user may select an option for a standby request (e.g., in the user's profile or settings). A standby request may be an invitation for help that is transmitted automatically if certain conditions are met. For example, the conditions may include when the first user loses to the same boss a threshold number of times in a row, or when the first user plays a lever for greater than a threshold duration of time without completion. In this case, the invitation for help may be automatically sent at or near the point during the first user's game at which the boss or level the user needs help with is about to occur.

In some examples, in response to determining that the conditions for the standby request are met, the system may also automatically spin up a multiplayer gaming session to enable the mercenary (once a mercenary is found) to join quickly upon accepting the invitation.

In some examples, the standby request may allow the first user to automatically request help, and enable the mercenary to join and complete task with or without help from the first user. The first user may allow the mercenary to complete the task on their own, and then review a recording of the mercenary's actions at a later time.

In some examples, users may compile lists of reliable mercenaries with whom they've previously interacted. These lists may be maintained and accessed for future gaming sessions. This serves a dual purpose, by making it easier for users to send out targeted invitations for help, and to act as a form of endorsement or review system for mercenaries.

After the invitation is sent, the requesting user awaits an acceptance of the invitation. The invitation may be presented to candidate mercenaries via their respective gaming systems, via social media notifications, or via some other source. The candidate mercenaries may accept the invitation may clicking on a link in the invitation or notification (e.g., a link in the social media post including the invitation).

The invitation may be accepted by a single user or by multiple users. Where the invitation is a request for assistance, one or multiple mercenaries may accept, depending on the specifics of the invitation. Where the invitation is an elimination request, the system may limit the acceptance to a single candidate mercenary. If multiple candidates accept, the candidates may be placed in a queue or may complete challenges to determine which candidate's acceptance is confirmed. If placed in a queue, the first accepting candidate mercenary may be given an opportunity to perform the elimination, and if they fail the next candidate may be given an opportunity. Alternatively, if multiple candidate mercenaries accept the invitation, the requesting user may be given the opportunity to select which candidate's acceptance to confirm. This may also be done automatically based on the candidate mercenaries' levels or ranks. In some examples, if an invitation is sent to a group of users and a candidate mercenary accepts the invitation, the invitation is revoked for the other candidate mercenaries (and the request may be deleted or hidden). In some examples, an invitation sent to multiple candidate mercenaries may include a timer (e.g., 30 seconds), and the first player that accepts the invite is confirmed. Further, in some examples if multiple mercenaries are requested, once a maximum limit for acceptance is reached, the request may be hidden or deleted for other candidates.

In response to accepting the invitation, the gaming system of the accepting user (mercenary) may pause the game and store the current game state, if the mercenary was playing a game when the invitation was accepted. Additionally, in response to the acceptance of the invitation, the first user and the mercenary may both connect to a multiplayer server for the game (described below). The mercenary's player character may be added to the first user's game, and/or an emulated character of the mercenary may be added. If the candidate mercenary accepts the invitation while not playing the game, the mercenary may select to send an emulated version of the candidate mercenary's player to the first user's game. In some examples, the system may spin up a gaming session that supports the emulated version of the player before the candidate mercenary accepts the invitation, in anticipation of the mercenary electing to send an emulated version, or in response to the mercenary electing to send an emulated version.

In some examples, for instance when the invitation is an elimination request, the system may create a session ID when the invitation is accepted. When the target starts the relevant game, the mercenary that accepted the invitation can then join the target and appear as an NPC in the target's gaming session using the created session ID.

In some examples, after a mercenary accepts an invitation (e.g., an elimination request), the system may alert the mercenary when certain conditions are met. For example, the system may alert the mercenary when the target starts the relevant game, or reaches or is about to reach a certain point within the game (i.e., a point in the game at which a mercenary is permitted to join). In some examples, the mercenary may specify a day or time range during which they would like to receive an alert. For instance, the mercenary may only be available to play the game on Saturdays, so may request an alert when the target starts or is playing the game on a Saturday.

After an acceptance is received, the gaming system next joins the mercenary or second user to the first user's gaming session. This may occur right after the acceptance is made, or may occur minutes, hours, or days later (depending on when the first user plays the game). Joining the mercenary to the first user's game may include transitioning from a single player gaming session to a multiplayer gaming session. The gaming system may create a multiplayer instance or multiplayer game server if the first user is playing a single player game. The first user and/or mercenary may each be playing on a local gaming system or on a cloud-based gaming system.

In order to join the mercenary to the first user's gaming session, the multiplayer game server may send the game dynamics of the first user, including the game level and the exact state of the first user in the game, including the first user's health and location in the level, for example. The multiplayer game server may also send the computer controlled characters' information and their current states including health levels and locations in the level. The mercenary game engine may thereby include an exact mirror image of the first user's game state in the mercenary's game engine. In some examples, the gaming system may provide a subset of information to the mercenary's game engine, such as the pseudo random number generator seeds or other variables and values associated with the first user's game.

The gaming system may also determine an insertion point within the first user's gaming session at which the mercenary user can be inserted (e.g., when the transition from single player to multiplayer can occur). The insertion point may be the point in time at which the first user starts the gaming system, starts the game, reaches a cutscene, reaches a loading screen, during display of an advertisement, when the first user reaches a checkpoint, when the first user reaches a level or area of the game set up for mercenary inclusion (e.g., while levels 1-4 don't include support for mercenaries, level 5 does include support), when the loading of a level begins (to ensure random numbers in memory are the same between first user and mercenary game systems), upon the occurrence of some event within the game (e.g., spawning of a character, elimination of character, reaching a threshold score, etc.), and more.

When the mercenary is about to be joined to the first user's game, or has already been joined but has not yet taken control of a character in the first user's game, the mercenary may have the option to join the first user's game as one character of several options (e.g., mercenary may select character A, B, or C). The mercenary may also have the option to join as a protagonist alongside the first user, to play in a collaborative manner against the NPCs or player controlled enemies.

Where the first user's game is a multiplayer game by default (e.g. certain modes in Call of Duty), the insertion point may be a point in time prior to or during the matchmaking process for the game during which players are sorted or selected and inserted together into a game. In some examples, identifying the insertion point may include identifying when the target is entering matchmaking to join a game. The gaming system may ensure that the mercenary is placed in the same game as the target, by modifying the rules by which the matchmaking process occurs. For example, the gaming system may modify the matchmaking process for a given game to prioritize joining the mercenary and the target in the same game during the matchmaking process for that game.

After joining the mercenary or second user to the first user's gaming session, the gaming system may next identify and determine whether an end trigger point has occurred. When the end trigger point occurs, the gaming system may remove the mercenary from the first user's gaming session. The first user may then resume playing in single player mode if they were originally doing so. Similarly, the mercenary game may resume from the previously saved state (if the mercenary was mid game when the invitation was accepted. Where the game is a multiplayer game by default, since the matchmaking priorities may have been modified to ensure the mercenary was added to the same game as the first user, reaching the end trigger point may simply cause the gaming system to revert the matchmaking priorities to default or previous values so that the mercenary being added to first user's game during matchmaking is no longer prioritized.

The end trigger point may be the completion or failure to complete a task (e.g., a task specified in the invitation), the end of a level, a threshold amount of time passed, the elimination of the target, the elimination of the mercenary, or some other action. In some examples, if the mercenary is eliminated by an NPC or another player character other than the target user, the gaming system may end the mercenary mode but the mercenary may remain in the gaming session (e.g., where the game includes matchmaking). The target user may receive a notification that the mercenary (e.g., the player who had been tasked with eliminating the target user) has been eliminated.

In some examples, the first user and/or the mercenary game play may be recorded. In response to detecting the end trigger point, the gaming system may transmit an alert or the recording of the first user and/or mercenary to the requesting user who sent the invitation, particularly where the invitation is an elimination request. The alert may include information about whether the mercenary completed the task (e.g., eliminated the first user). The recording may also show how the mercenary completed task, which may be particularly helpful for a user who requested assistance with a particular task and wants to learn how to complete the task in the future.

In some examples, in response to detecting the end trigger point, the gaming system may (a) alert the target that there was a mercenary in their game that had an elimination request being carried out, (b) alert the target that they were eliminated by a mercenary (e.g., there was a bounty on their head), (c) alert target that they eliminated the mercenary that was after them (e.g., that the elimination request may be completed at this point, because the mercenary only had one chance to eliminate the target), and more.

FIG. 7 illustrates an example user interface 700 of a first user's game indicating that the first user has been eliminated by a mercenary 710. The gaming system may provide the opportunity to return the favor, enabling the first user to send an invitation to hire a new mercenary to eliminate the previous mercenary 710 as revenge.

After the end trigger point is reached, the gaming system may present the mercenary or second user with a reward. The reward may be granted upon successful completion of a task specified in the invitation, or agreed upon during acceptance of the invitation. For an invitation including an elimination request, the reward may be granted only upon successful elimination of the target. The reward may be, for example, trophies, game loot boxes, special weapons, experience, points, badges, health, skins, game items/currency from the game, game items/currency from a different game, an experience boost, gaming system currency/points (i.e., not specific to a particular game), real money, some other reward agreed to by acceptance of the invitation, and/or a combination of the above.

In some examples, the reward may be negotiated and/or included in the invitation. The requesting user may offer an initial payment or reward suggestion, and the mercenary may accept or counteroffer. The requesting user may also offer options of payment to the mercenary, (e.g., select one of three same or different game items), and the mercenary may select one as payment (or counteroffer) either when accepting the invitation, or upon successful completion.

In some examples, the reward may be provided by the user requesting assistance, or by the user sending the invitation (e.g., where the invitation is an elimination request). In some examples, the gaming system may facilitate a virtual marketplace that allows players to sift through a roster of available mercenaries. This marketplace could be integrated as a special tab or page within various social media platforms. The integration is designed to work only if the user has opted to link their gaming profile with their social media accounts. This facilitates easy searching for players who need help in a game and for mercenaries looking to offer their services.

In some examples, various features described herein may include social media integration. The gaming system may be configured to record, upload, and/or stream audio and video from a user's gaming session, and/or from the mercenary or emulated character sent by the mercenary. The portion of the game that the mercenary and the first user participate in together may be recorded, and may be used to showcase the mercenary's work in a highlight video for other players looking for a mercenary. The mercenary may be tagged or emphasized in the recording to differentiate from the user receiving assistance. For example, the in-game character controlled by the mercenary may have an icon or visible tag positioned above their head to indicate that the character is controlled by the mercenary.

In some examples, the gaming system may enable a user to search for a mercenary and send invitations via their social media accounts. The recorded videos of mercenaries may be used by users seeking help to differentiate between mercenaries when selecting which candidates to invite. For example, a user may be stuck on task A in a game. The user may review recordings of mercenaries who helped other users complete task A as a mercenary, in order to find the ideal mercenary for their purposes.

In some examples, the gaming system may enable posting of content via social media accounts, such as the invitations, badges or rewards granted from successful mercenary work, the user's mercenary level, etc.

In some examples, the gaming system may enable live streaming of game content. Users may have the option to live stream their gaming sessions directly to their social media profiles. This feature may enhance the interaction between the user and their social media audience. If a user faces a challenge or gets stuck at a certain point in the game, viewers from the social media platform can opt to join the game as a mercenary, if the game supports mercenary mode, to assist the user. The gaming system may allow for a seamless transition from viewer to participant, achievable through a simple click. In some examples, a popular streamer may have a large social media audience. The streamer's audience may bid on the opportunity to join the streamer in playing the game (i.e., a reverse of first user payment noted above). In this case, rather than the streamer providing the payment or reward, the candidate mercenaries may provide payment to join the streamer. The payment may be real money, game items/currency, and/or other items such as those noted above.

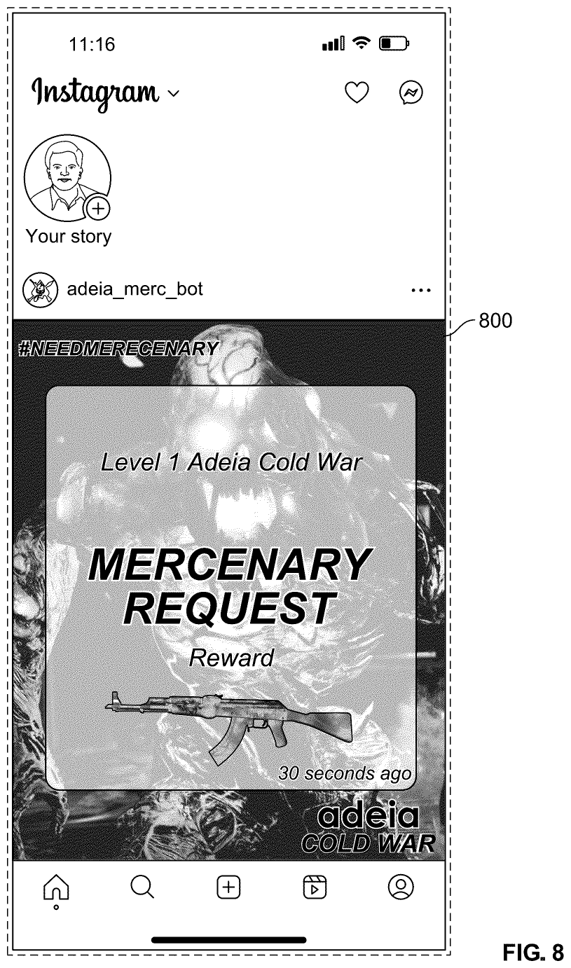

In some examples, the gaming system may include a dedicated bot on one or more social media platforms, with which users can interact using specific hashtags. The social media bot may be different from a game bot, discussed herein. The social media bot may perform automatic functions with respect to social media (e.g., automatic posts). In contrast, a game bot may be an NPC controlled by a gaming system within a game. For instance, users using the hashtag #NeedMercenary or #HelpInGameXYZ in a tweet to the bot may prompt the bot to retweet the request. This makes the request for help visible to a broader audience, especially those who follow the specific hashtags. Furthermore, the gaming system may generate unique hashtags or identifiers for particular games, in-game challenges, or levels, adding another layer of specificity and community interaction. This could be, for example, a common hashtag that is recognized by all console or cloud based/remote rendering platforms like Xbox, Sony, Nintendo and may also integrate studio specific platforms like Activision or EA Games. FIG. 8 illustrates an example social media post 800 by a bot including the hashtag #NeedMercenary.

In some examples, users may receive or be offered special filters based on their mercenary level and/or mercenary success, similar to those found on Instagram. These filters may allow users to create photos or videos where they stand alongside their in-game characters, or even include background scenes from the game. This can serve as a fun way to celebrate victories, mercenary kills or milestones in the game and with respect to mercenary mode, which can then be shared on social media.

In some examples, an emergency broadcast or “SOS” feature may be activated when a user finds themselves stuck at a particularly difficult level. This feature may cause the gaming system to send out an urgent, highlighted request for help on social media platforms, and can even include short video clips from the user's game play to show exactly where the player is stuck, attracting immediate attention.

In some examples, the gaming system may commemorate milestones like the anniversary of a user's first team-up with a mercenary or the completion of a hundred missions together. This may be done via automated social media posts or tweets, adding a sense of celebration and achievement to the player-mercenary relationship.

In some examples, the gaming system may include a verification badge which may be similar to the verification badges used by Twitter (now X). This verification badge may be presented to recognized, high-performing mercenaries after completion of a certain number of tasks. The badge may be displayed next to their username on social media platforms, as well as on their gaming profile, thus enhancing their credibility and social standing.

In some examples, the gaming system may allow users to publish their team requirements directly on social media platforms. Interested mercenaries may then join these teams, selecting positions like “sniper” or “healer” based on their skill sets. A virtual “briefing room” may also be provided, where players and mercenaries can congregate before the mission starts. The gaming system may be configured to provide a live stream of this briefing room, allowing followers to join, offer advice, vote on strategies, or simply watch the mission planning unfold in real time.

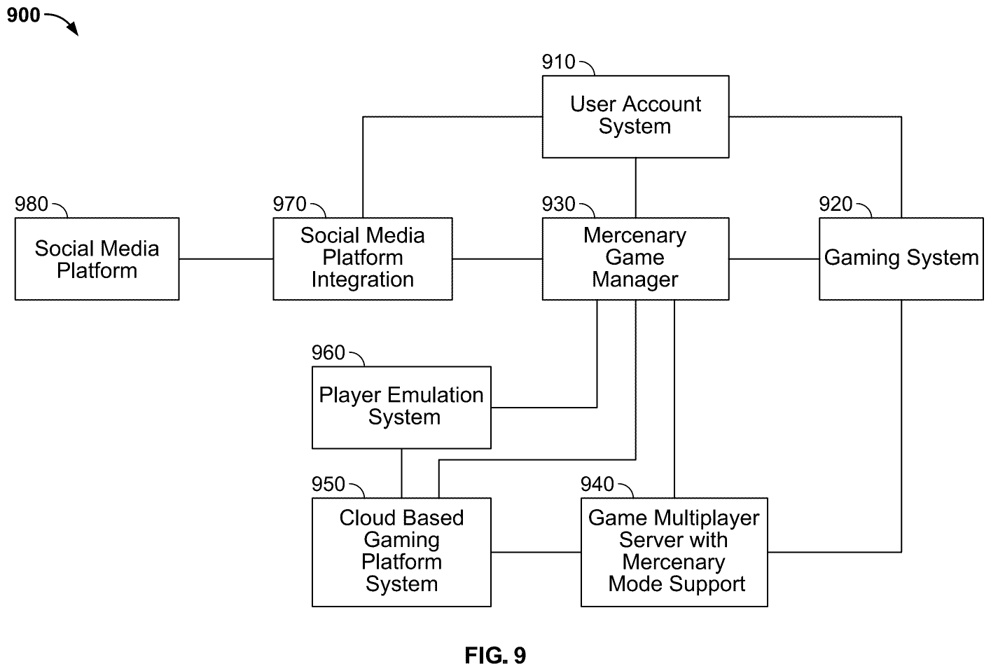

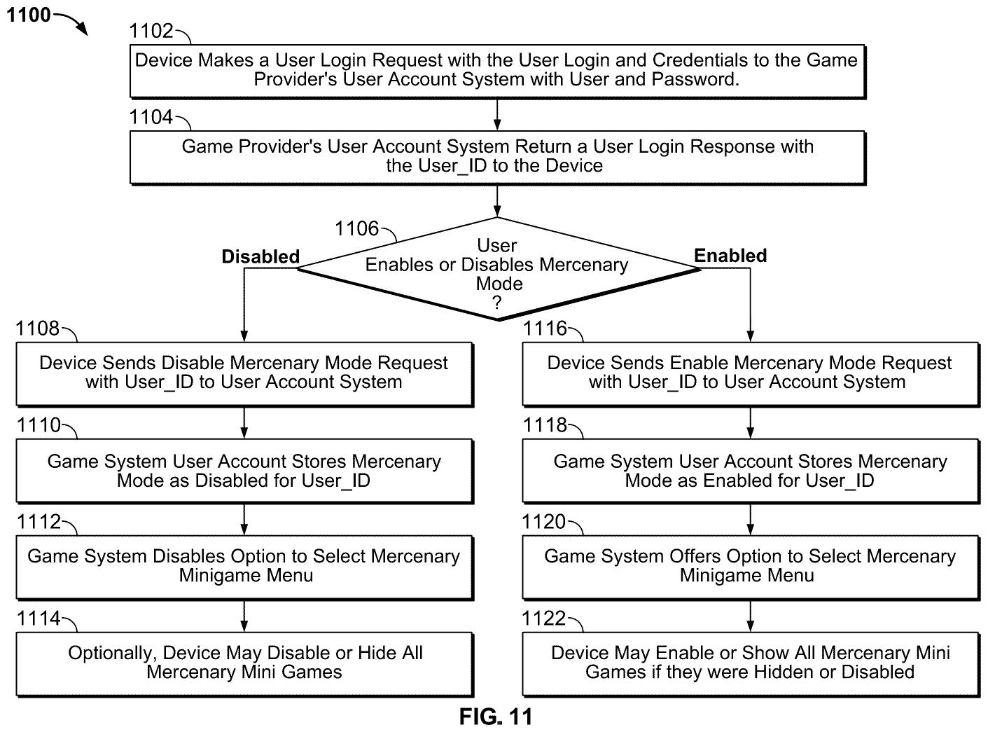

FIG. 9 is an example gaming system architecture 900 for enabling the functions described herein with respect to a mercenary mode, in accordance with some examples of the disclosure. The gaming system architecture 900 includes a user account system 910, a gaming system 920, a mercenary game manager 930, a game multiplayer server with mercenary mode support 940, a cloud based gaming platform system 950, a player emulation system 960, social media platform integration 970, and social media platform 980. Each of these may communicate with each other to enable the various functions described herein. To appreciate the breadth of the type of information communicated between each of these parts of the gaming system 900, examples will be described below. Each of the processes described in FIGS. 11-21 may provide additional explanation regarding the information and context during which information is communicated between each of the parts of the gaming system 900.

As a non-exhaustive list, the user account system 910 may communicate with the gaming system 920 to share information regarding user login requests, responses to these requests, and information regarding enabling and disabling mercenary mode. The user account system may communicate with the mercenary game manager 930 to share information regarding mercenary minigame player statistics, mercenary levels, hiring a user to be a mercenary, payment or reward items for mercenaries, notifications regarding the success or failure of a mercenary, and more. The user account system may also communicate with the social media platform integration system 970 to share information regarding user IDs of the mercenary, target, requesting user, and more, as well as the corresponding user IDs of the social media accounts of these users.

The gaming system 920 may be a gaming console, computer of PC, a phone, an XR headset, and/or a cloud based gaming service. The gaming system 920 may communicate with the user account system 910 as described above. The gaming system 920 may also communicates with the mercenary game manager 930 to share information regarding (a) mercenary minigame catalog requests, (b) minigame download requests, (c) minigame completion information, (d) mercenary list requests, (e) emulation player help requests, (f) available mercenary stats and information, (g) mercenary requests (invitations), (h) mercenary acceptances, (i) notifications that a target player is currently online or playing a game, (j), requests to join a multiplayer server, (k) emulation player hit requests, (l) mercenary elimination videos, (m), multiplayer mode switch requests, (n), stream requests, and more.

The gaming system 920 may also communicate with the game multiplayer server with mercenary mode support 940 (e.g., multiplayer server), to share information regarding (a) multisession game data, (b) encoded live video streams, and more.

The mercenary game manager 930 may facilitate the various functions and features described herein. The mercenary game manager 930 may communicate with the user account system 910, and the user account system 920, as described above. The mercenary game manager 930 may also communicate with the game multiplayer server with mercenary mode support 940 to share information regarding (a) game multiplayer join requests and responses, (b) multiplayer server start requests, and more.

The mercenary game manager 930 may also communicate with the cloud based gaming platform system 950 to share information regarding (a) mercenary join session requests and responses, (b) multiplayer join notifications, (c) stream requests and responses, (d) save video requests, and more.

The mercenary game manager 930 may also communicate with the player emulation system 960 to share information regarding (a) emulation player requests, and mercenary game play data (e.g., minigames, mercenary test games, mercenary play style, etc.), and more.

The mercenary game manager 930 may also communicate with the social media integration platform 970 to share information regarding (a) mercenary notification requests, (b) emulation player help requests, (c) hit requests, (d) single or multiplayer in-progress game information, (e) videos of emulated players, (f) videos of mercenary players, (g) stream requests, (h) mercenary minigame player stats, and more.

The game multiplayer server with mercenary mode support 940 (e.g., multiplayer server 940), may communicate with the gaming system 920 and mercenary game manager 930 as described above. Additionally, the multiplayer server 940 may communicate with the cloud based gaming platform system 950 to share information regarding multiplayer game session data. In some examples, the game multiplayer server with mercenary mode support 940 may be configured to enable a player to join a single player game, wherein this single player game enables a second user (e.g., a remote user) to be added to the game, and to switch control of an in-game character from control by the gaming system to control by the second user. The mercenary mode enables the single player game to allow the second user to control the in-game computer controlled character. The game multiplayer server with mercenary mode support 940 may also enforce the multiplayer game matchmaking, wherein a mercenary accepting a hit on another player is joined to the same game as the target player.

The cloud based gaming platform system 950 may communicate with the game multiplayer server with mercenary mode support 940 and mercenary game manager 930 as described above. The cloud based gaming platform system 950 may also communicate with the player emulation system 960 to share information regarding (a) controller inputs, (b) mercenary game session data, game engine start requests, and more.

The player emulation system 960 may communicate with the cloud based gaming platform system 950 and mercenary game manager 930 as described above.

The social media integration platform 970 may communicate with the user account system 910 and the mercenary game manager 930 as described above. The social media integration platform 970 may also communicate with the social media platform 980 to share information regarding (a) mercenary notification help requests, (b) single or multiplayer in-progress game information, (c) hit requests, (d) notifications that a target layer is currently online or playing a game, (e) emulation help requests, (f) emulation player hit requests, (g) videos of emulated or mercenary players, (h) stream requests, (i) minigame player stats and recordings, and more. The social media platform 980 may communicate with the social media integration platform 970 as described above.

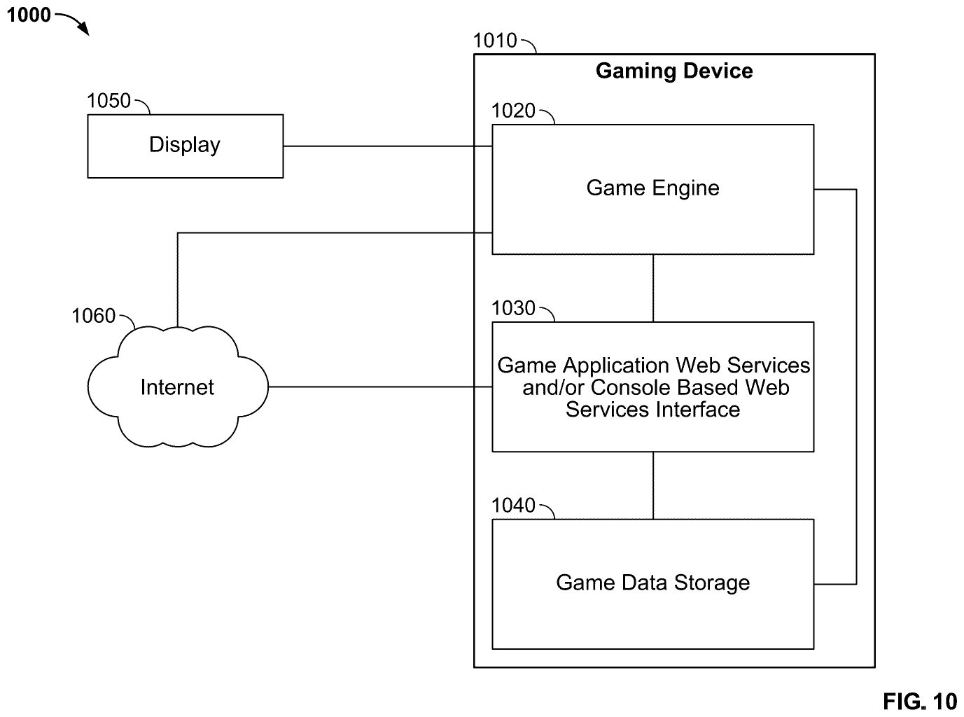

FIG. 10 is an example system diagram 1000 for a client device to enable the functions described herein with respect to a mercenary mode, in accordance with some examples of the disclosure. System diagram 1000 illustrates an example gaming system architecture for the client device which may be a cloud-based game engine running remotely rendering a game session or a locally running game engine on a PC, game console or phone.

The gaming system 1000 may include a gaming device 1010, which may include the game engine 1020, the game application web services 1030, and the game data storage 1040. The gaming system 1000 may also include a display 1050, and one or more systems accessible via the internet 1060.

The game engine 1020 may communicate various information with the game application web services, such as (a) multiplayer mode connection information, (b) mercenary mode settings, (c) requests to switch to multiplayer mode, (d) and more. The game engine 1020 may also communicate with the game data storage to share information regarding generated mercenary elimination videos, as well as various other information. The game engine 1020 may also communicate with the display 1050 to send rendered video to the connected display device.

The game application web services interface may communicate with the one or more other systems (such as those described with respect to FIG. 9) via the internet 1060, to share information regarding (a) mercenary minigame catalog requests and responses, (b) minigame download requests and responses, (c) minigame complete statistics and information, (d) mercenary list requests, (e) emulation player help requests, (f) mercenary list responses, (g) mercenary requests, (h) mercenary accept requests and responses, (i) notifications that a target user is playing a game, (j) single or multiplayer in-progress game session information, (k) join mercenary session requests and responses, (l) emulation player hit requests, (m) recorded videos, (n) multiplayer mode switch requests, (o) stream requests, (p) multiplayer join notifications, and more.

FIG. 11 is an example flowchart of a process 1100 for a user to enter mercenary mode during a gaming session, in accordance with some examples of the disclosure. The process 1100 may be implemented, in whole or in part, by the gaming systems shown in FIGS. 9 and 10. One or more actions of the process 1100 may be incorporated into or combined with one or more actions of any other process or embodiments described herein. The process 1100 may be saved to a memory or storage (such as any one or more of those shown in FIGS. 9-10) as one or more instructions or routines that may be executed by a corresponding device or system to implement the process 1100.

At step 1102, the gaming system determines that a user device makes a user login request including the user login and credentials to the game provider's user account system (e.g., user account system 910) with the username and password. At step 1104, the game provider's account system returns a user login response with the user ID to the user device. In some examples, this may include leveraging the game application web services 1030.

At step 1106, the gaming system determines whether the user has enabled or disabled mercenary mode. If the user has disabled mercenary mode, steps 1108-1114 include the user device sending a disable mercenary mode request with the user ID to the user account system, the game system user account storing the mercenary mode as disabled for the user ID, the game system disabling the option to select the mercenary minigame menu, and optionally, the user device may disable or hide all mercenary minigames.

If the user has enabled mercenary mode, steps 1116-1122 include the user device sending an enable mercenary mode request with the user ID to the user account system, the game system user account storing mercenary mode as enabled for the user ID, the game system offering the option to select the mercenary minigame menu, and optionally, the user device may enable or show all mercenary minigames if they were hidden or disabled.

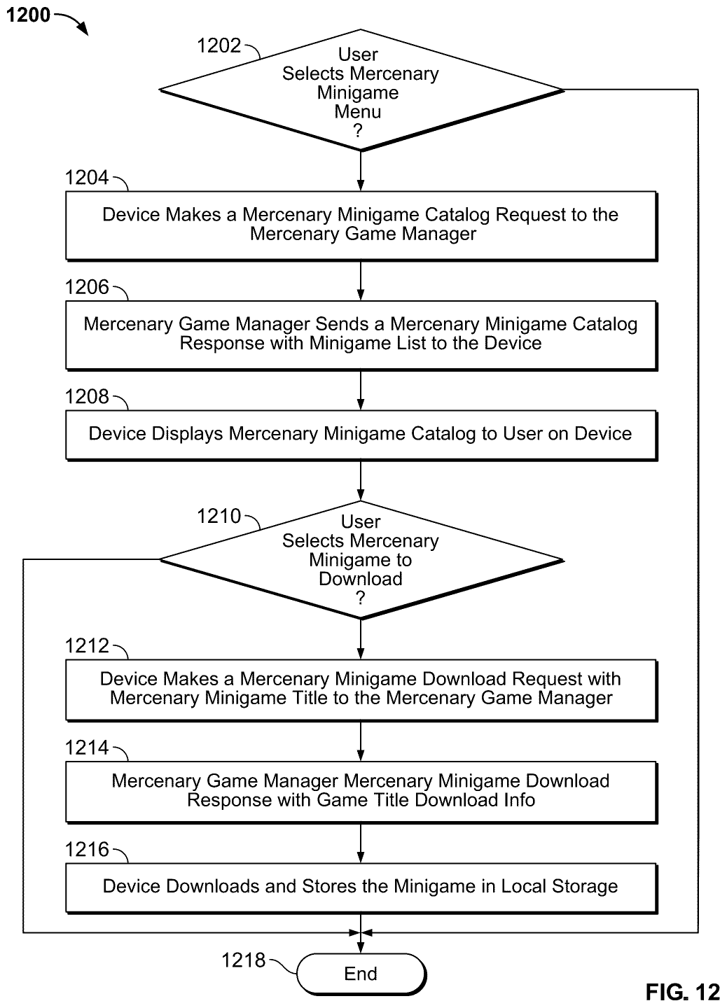

FIG. 12 is an example flowchart of a process 1200 for a user to download mercenary mode minigames during a gaming session, in accordance with some examples of the disclosure. The process 1200 may be implemented, in whole or in part, by the gaming systems shown in FIGS. 9 and 10. One or more actions of the process 1200 may be incorporated into or combined with one or more actions of any other process or embodiments described herein. The process 1200 may be saved to a memory or storage (such as any one or more of those shown in FIGS. 9-10) as one or more instructions or routines that may be executed by a corresponding device or system to implement the process 1200.

At step 1202, the gaming system determines whether the user has selected the mercenary minigame menu. If the user has not selected the menu, the process 1200 proceeds to end at step 1218. If the gaming system determines that the user has selected the mercenary minigame menu, the process proceeds to step 1204.

At step 1204, the user device makes a mercenary minigame catalog request to the mercenary game manager. In response, at step 1206, the mercenary game manager sends a mercenary minigame catalog response with the minigame list to the user device. This list includes the available minigames for the user to play.

At step 1208, the user device displays the mercenary minigame catalog to the user on a display of the user device. At step 1210, the gaming system determines whether the user has selected a mercenary minigame to download. If no minigame is selected, the process 1200 proceeds to end at step 1218.

If a minigame is selected for download, step 1212 includes the user device making a mercenary minigame download request with the minigame title to the mercenary game manager. The mercenary game manager then provides a minigame download response with the game title download information at step 1214, and at step 1216, the user device downloads and stores the minigame in local storage. The process 1200 then ends at step 1218.

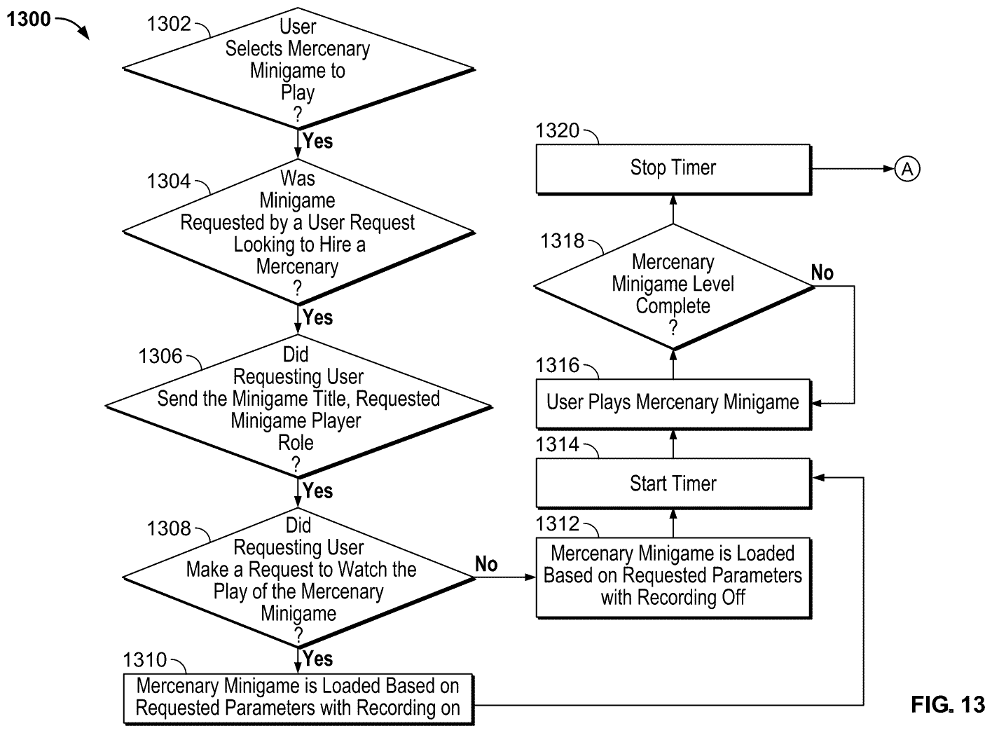

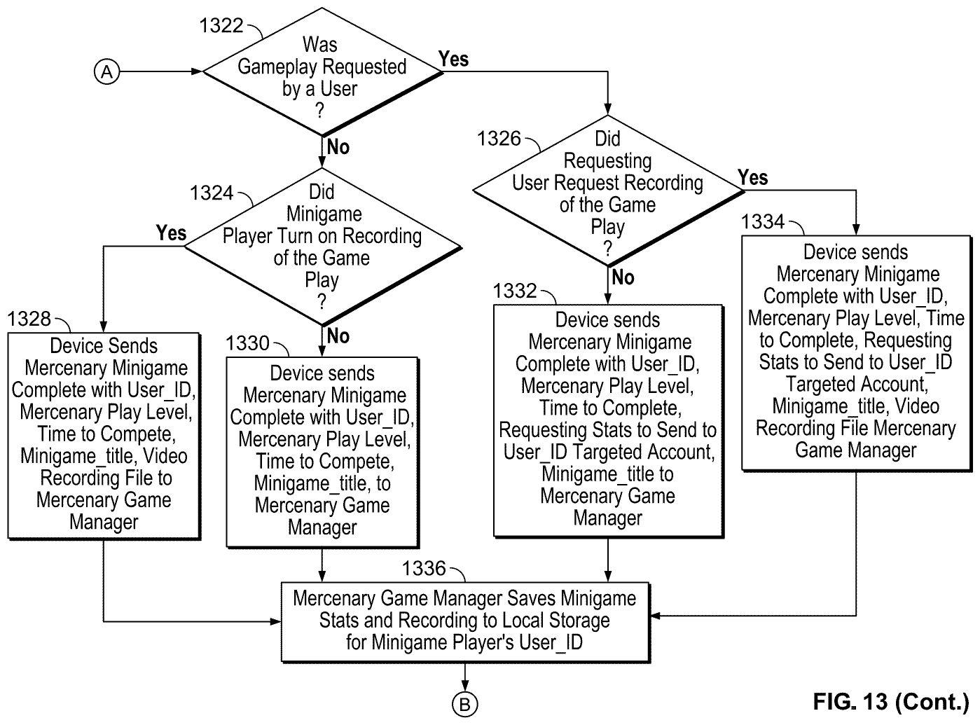

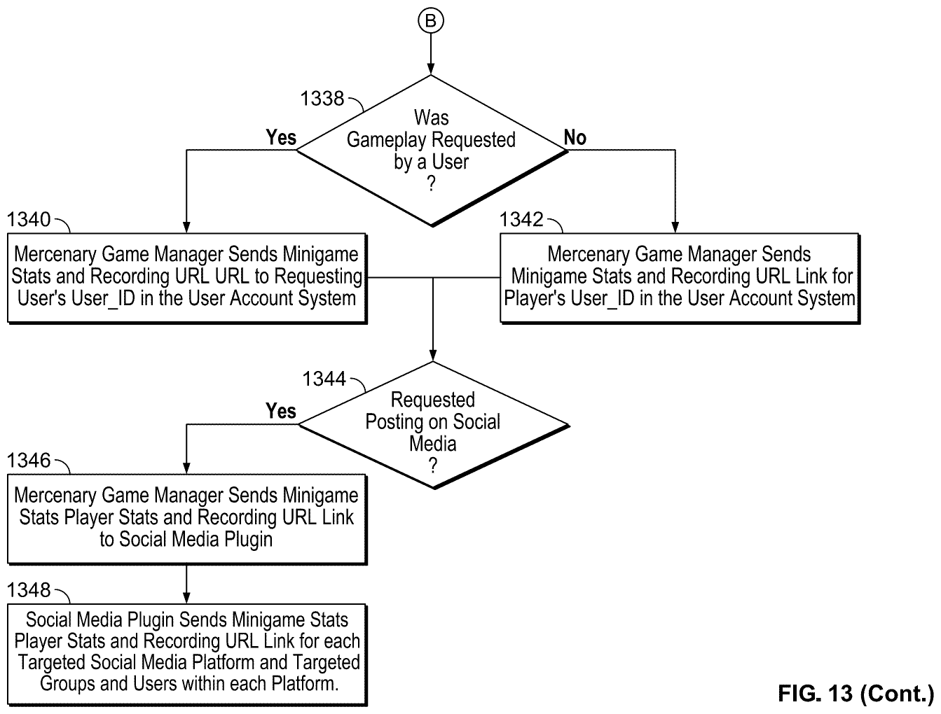

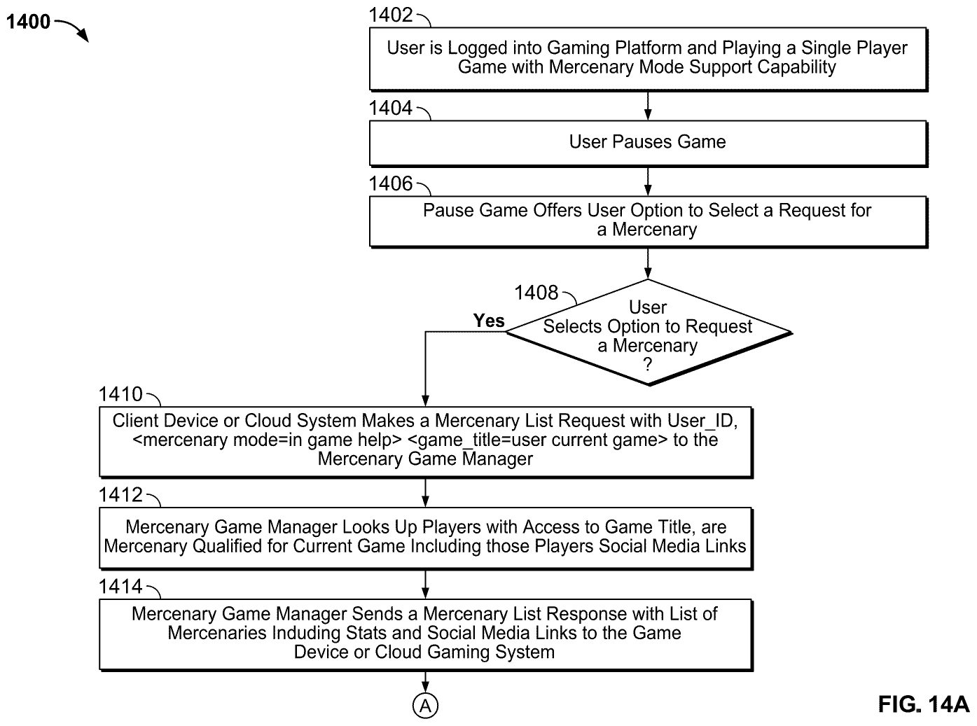

FIG. 13 is an example flowchart of a process 1300 for a user to play and complete mercenary mode minigames, in accordance with some examples of the disclosure. The process 1300 may be implemented, in whole or in part, by the gaming systems shown in FIGS. 9 and 10. One or more actions of the process 1300 may be incorporated into or combined with one or more actions of any other process or embodiments described herein. The process 1300 may be saved to a memory or storage (such as any one or more of those shown in FIGS. 9-10) as one or more instructions or routines that may be executed by a corresponding device or system to implement the process 1300.

At step 1302, the gaming system determines whether the user has selected a mercenary minigame to play. If no minigame was selected, the process 1300 ends. If a minigame was selected, the gaming system determines at step 1304 whether the minigame was requested based on a user looking to hire a mercenary. If not, the process 1300 ends. If the minigame was requested based on a user looking to hire a mercenary, the gaming system determines at step 1306 whither the requesting user sent the minigame title, and requested a particular minigame player role. If not, the process 1300 ends. It the requesting user sent the minigame title and requested a particular minigame player role, the gaming system determines at step 1308 whether the user made a request to watch the play of the minigame. If the requesting user did request to watch the play of the minigame, the gaming system loads the minigame based on the requested parameters with recording on at step 1310.

At step 1312, if the requesting user did not make a request to watch the play of the mercenary minigame, the process 1300 includes loading the mercenary minigame based on the requested parameters form the requesting user with recording turned off.

At steps 1314-1320, the process 1300 includes starting a timer while the user plays the minigame, and stopping the timer when the minigame level is complete.

At step 1322, the gaming system determines whether the gameplay of the minigame has been requested by a user. If no gameplay was requested, the gaming system determines at step 1324 whether the minigame player turned on recording of their gameplay. If the gaming system determines that the minigame player did turn on recording of their gameplay, the user device sends an indication that the minigame is complete, along with the user ID of the player, the player level, the time to complete, and the video of the gameplay, to the mercenary game manager at step 1328. Alternatively, if the minigame player did not turn on recording of their gameplay, the user device sends all the same information except for the video of the gameplay to the mercenary game manager at step 1330.

If, at step 1322, gameplay of the minigame was requested by a user, step 1326 include the gaming system determining whether the requesting user also requested a video recording of the gameplay. If the user did not request a video recording of the gameplay, at step 1332 the user device sends an indication that the minigame is complete, along with the user ID of the player, the player level, the time to complete, and the requested stats to send to the requesting user's account, along with the minigame title, to the mercenary game manager. Alternatively, if the requesting user did request a recording of the gameplay, the user device sends all the same information, in addition to a video recording of the gameplay, to the mercenary game manager at step 1334.

At step 1336, the mercenary game manager saves the minigame stats and recording to local storage for the minigame player's user ID. At step 1338, the gaming system determines whether gameplay was requested by a user. If the gameplay was requested, at step 1340 the mercenary game manager sends the minigame stats and recording URL to the requesting user's user ID in the user account system. If the gameplay was not requested by a user, the mercenary game manager sends the minigame stats and recording URL to the minigame player's user ID in the user account system.

At step 1344, the gaming system determines whether a user has requested to post the minigame stats and/or video of gameplay on social media. If so, step 1346 includes the mercenary game manager sending the minigame player stats and recording URL link to the social media plugin. And at step 1348, the social media plugin sends the minigame player stats and recording URL to each targeted social media platform and targeted groups and users within each platform.

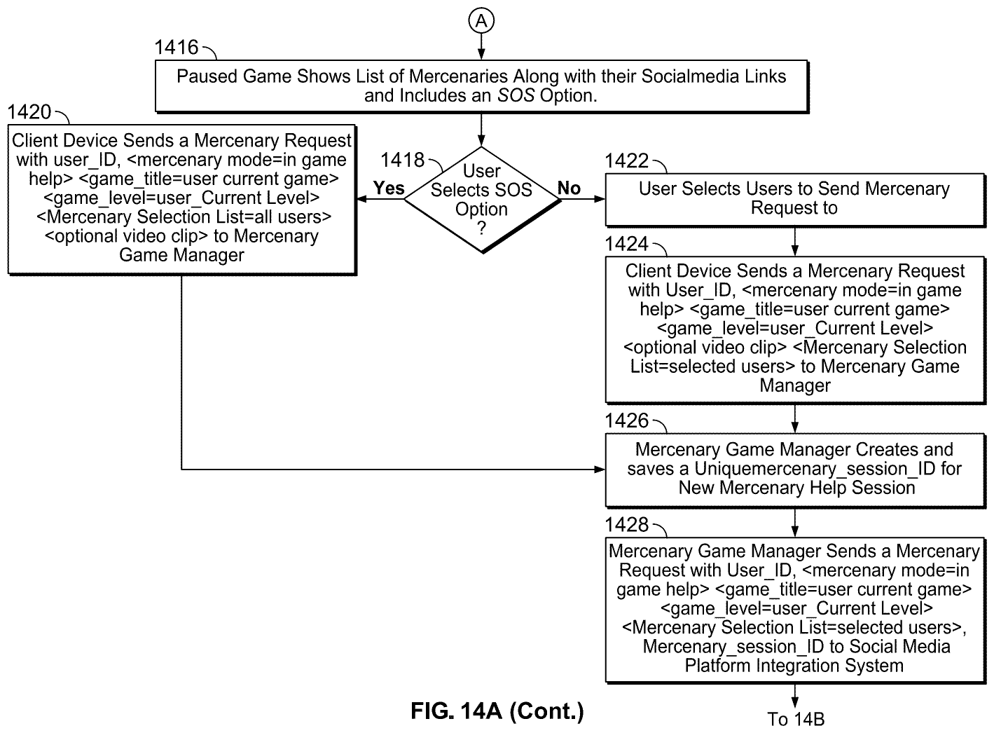

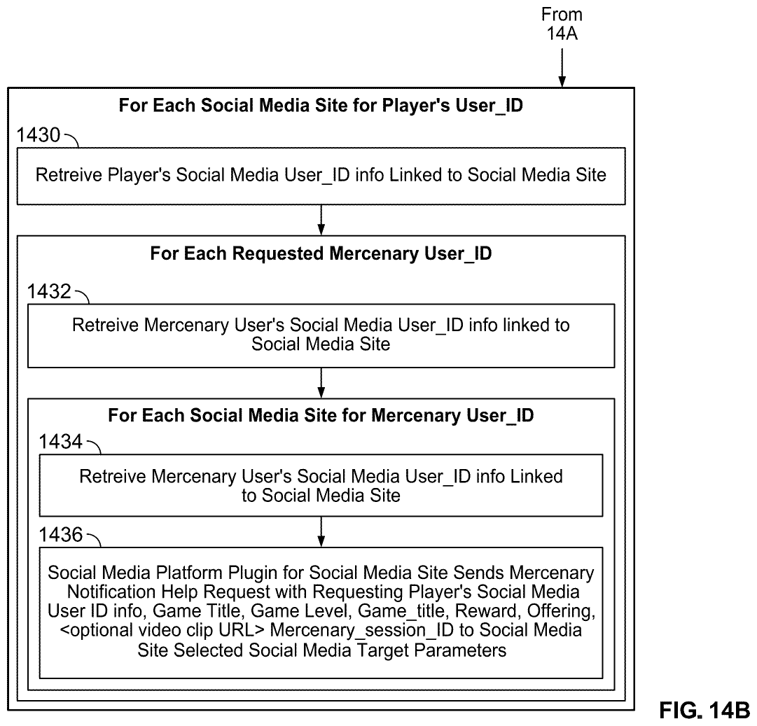

FIGS. 14A-B are an example flowchart of a process 1400 for a user to request help from a mercenary during a gaming session, in accordance with some examples of the disclosure. Process 1400 illustrates an example method for a user requesting a mercenary when stuck in a single player game to get past a particular level, as well as a method for the mercenary to accept the request. Process 1400 also enables the single player mode switch to mercenary single player mode when the mode is set for cooperative play where both players can attack the computer bots, but each player cannot attack the other. The computer bots can kill both players. A specific mercenary player may be invited by the requesting player, or a notification may be sent to multiple requested mercenary players. Also, an SOS may be sent which will be forwarded to all players with mercenary mode enabled allowing the first player who accepts to join the requesting user. The process 1400 may be implemented, in whole or in part, by the gaming systems shown in FIGS. 9 and 10. One or more actions of the process 1400 may be incorporated into or combined with one or more actions of any other process or embodiments described herein. The process 1400 may be saved to a memory or storage (such as any one or more of those shown in FIGS. 9-10) as one or more instructions or routines that may be executed by a corresponding device or system to implement the process 1400. Process 1400

At step 1402 the gaming system determines that the user is logged into the gaming platform and is playing a single player game with mercenary mode support capability. At step 1404, the user pauses the game, and at step 1406, the gaming system provides a selectable option to request assistance from a mercenary.

At step 1408, the gaming system determines whether the user has selected the option to request a mercenary. If not, the process 1400 may remain in a pause state, or may end. If the user selected the option to request a mercenary, the process 1400 includes, at step 1410, the client device or cloud system making a mercenary list request, including the user ID of the user, an indicator of the mercenary mode, and the game title, and sends the request to the mercenary game manager.

At step 1412, the mercenary game manager looks up players with access to the game title who are qualified for the current game of the user, including those players' social media accounts. And at step 1414, the mercenary game manager sends a mercenary list response with the list of mercenaries to the client device or cloud system that requested the list, including the stats and social media account links of the relevant candidate mercenaries. At step 1416, the gaming system presents the list of mercenaries to the user, along with their social media links and an SOS option. The SOS option, as noted above, enables the user to request help from all available players.

At step 1418, the gaming system determines whether the user has selected the SOS option. If so, at step 1420, the client device of the user sends a mercenary request to the mercenary game manager, the request including the user ID, the game title, the type of help requested, the current level, and the list of candidate mercenaries from whom to request help (e.g., all users). If the user did not select the SOS option, the process 1400 at step 1422 includes the user selecting one or more users to send the mercenary request to. At step 1424, the client device of the user sends a mercenary request to the mercenary game manager, the request including the user ID, the game title, the type of help requested, the current level, optional video clips, and the list of selected users.

At step 1426, the mercenary game manager creates and saves a unique mercenary session ID for the new mercenary help session. The gaming system may user this unique mercenary session ID to instantiate a multiplayer gaming session. And at step 1428, the mercenary game manager sends a mercenary request to the social media platform integration system, the request including the user ID, the type of help requested, the game title, the game level, the list of selected users to whom the request should be sent, and the mercenary session ID.

At step 1430, the social media platform integration system retrieves, for the requesting user, the social media user ID information for each social media site for which the requesting user has a social media account. At step 1432, the social media platform integration system retrieves, for each of the list of selected users to whom the request for help should be sent, the respective user's social media user IDs and other information for each relevant social media site.

At step 1434, the social media platform integration system retrieves, for each social media site identified at step 1432 for each of the list of selected users to whom the request for help should be sent, the respective user's social media user ID for that site. And at step 1436, the social media platform plugin sends a mercenary notification help request (e.g., invitation) to the social media accounts of the selected users, the request including information such as the requesting user's social media user ID information, the game title, game level, the reward offered, a video clip, and the mercenary session ID.

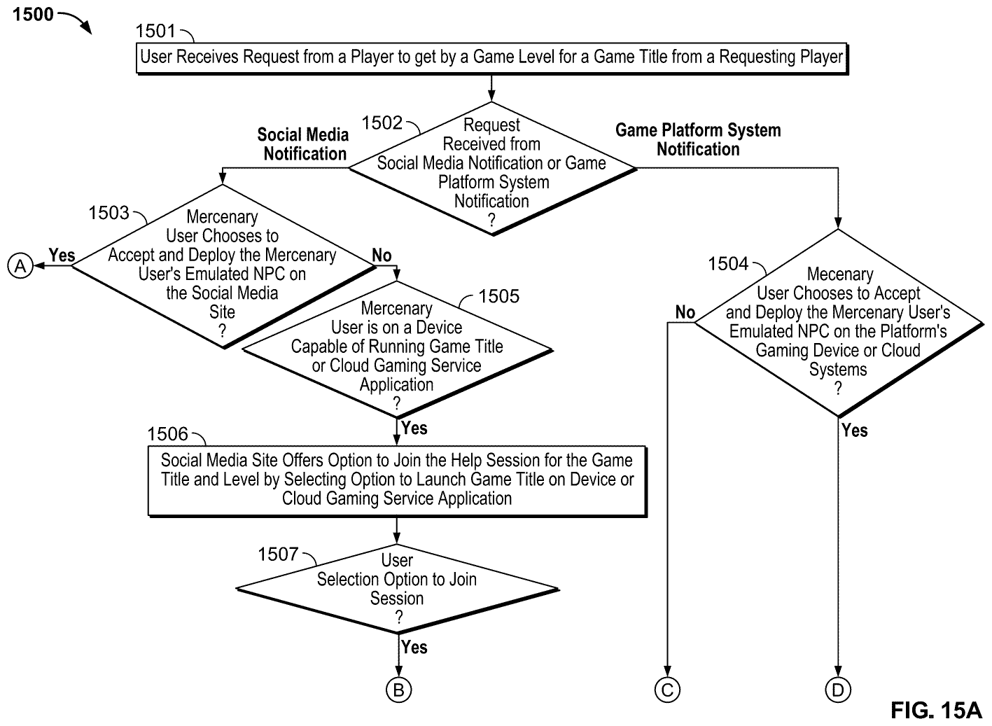

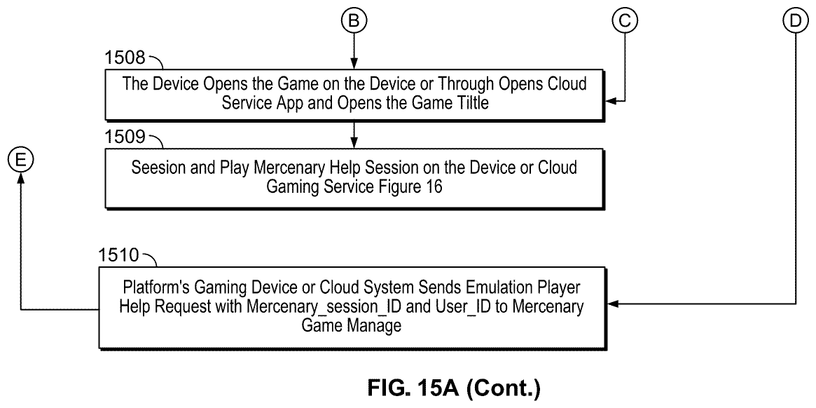

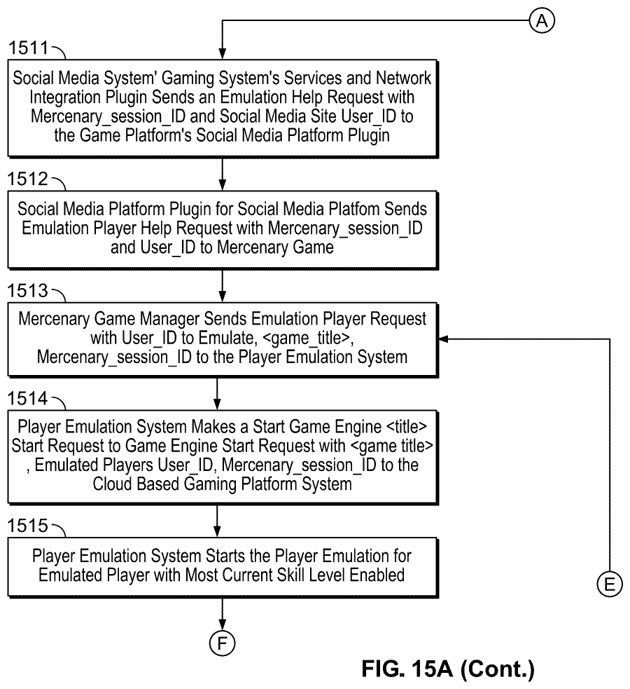

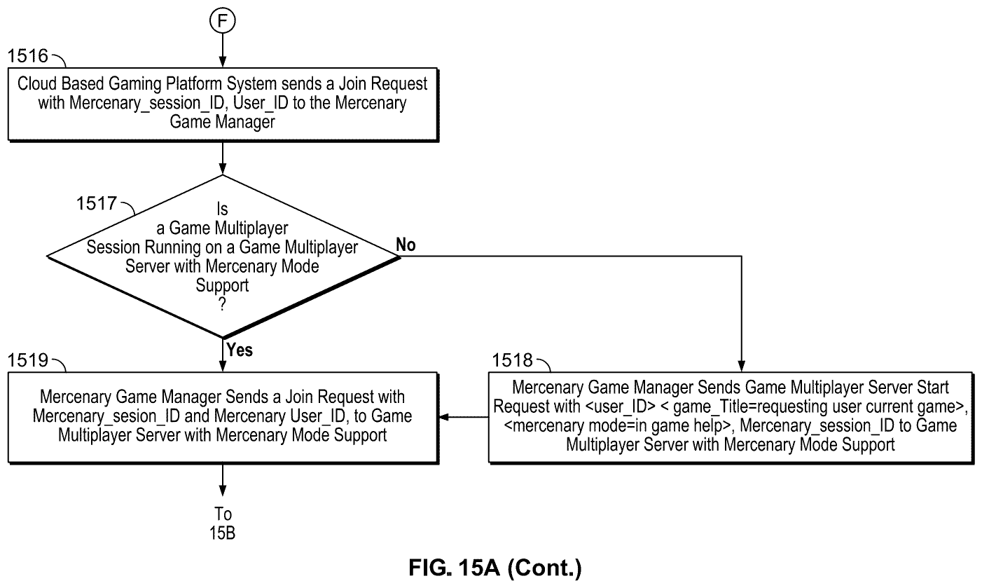

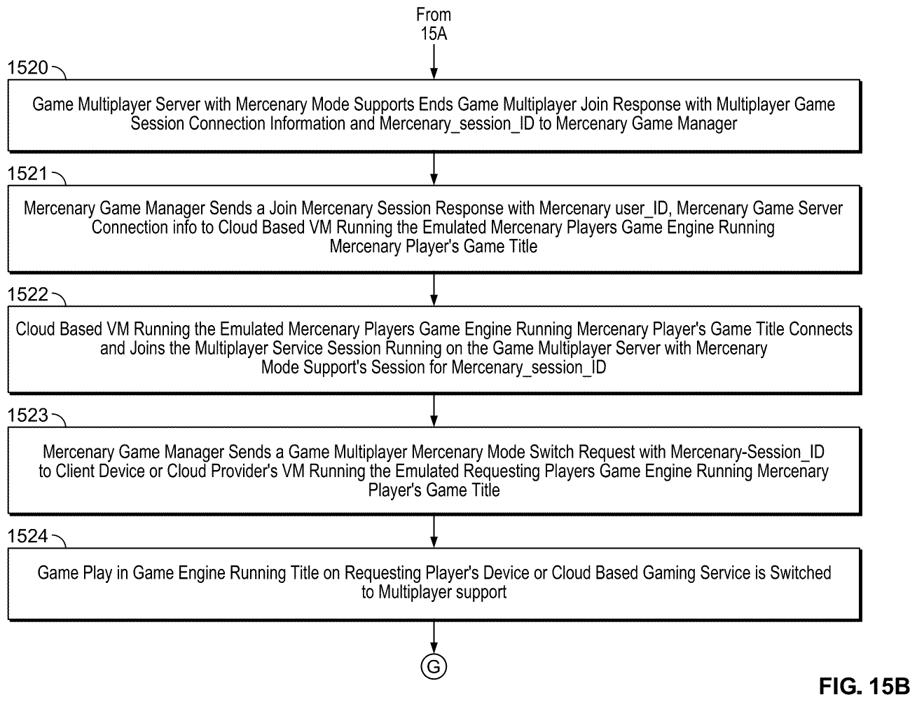

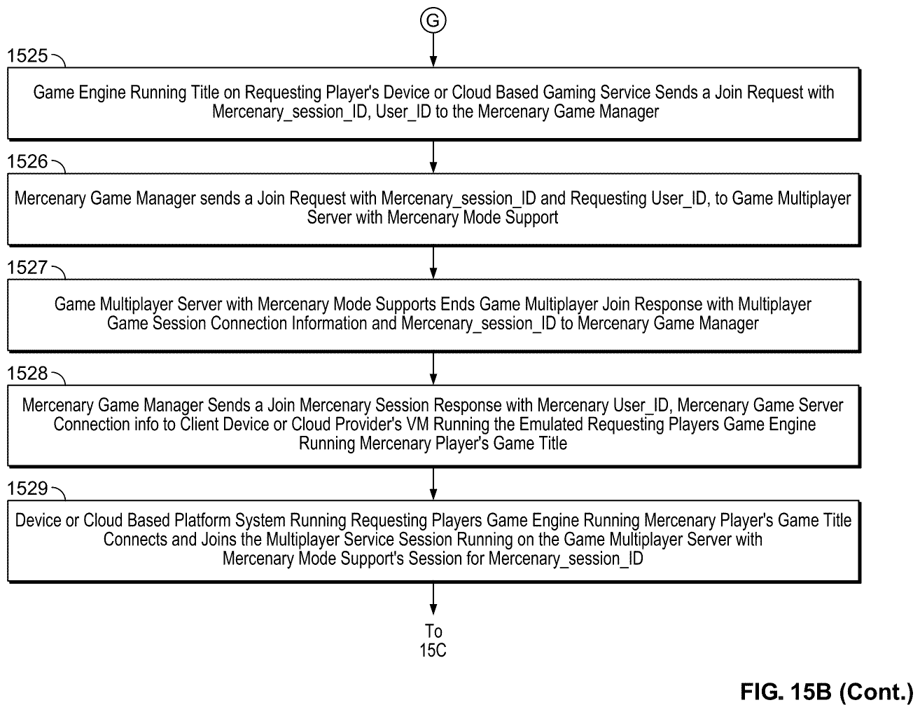

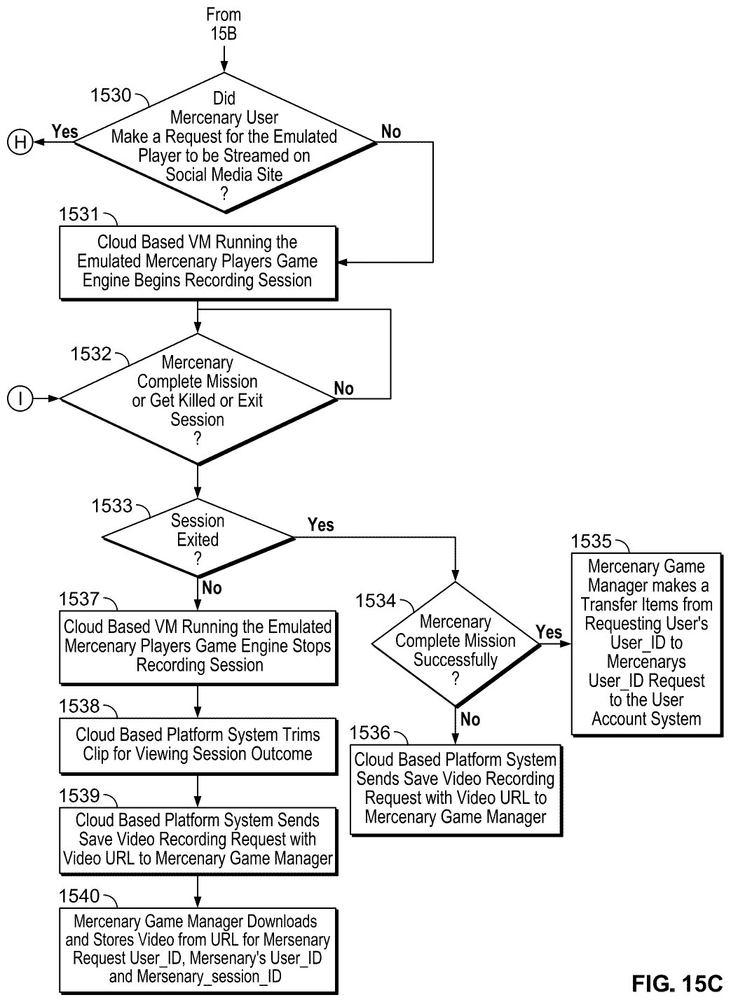

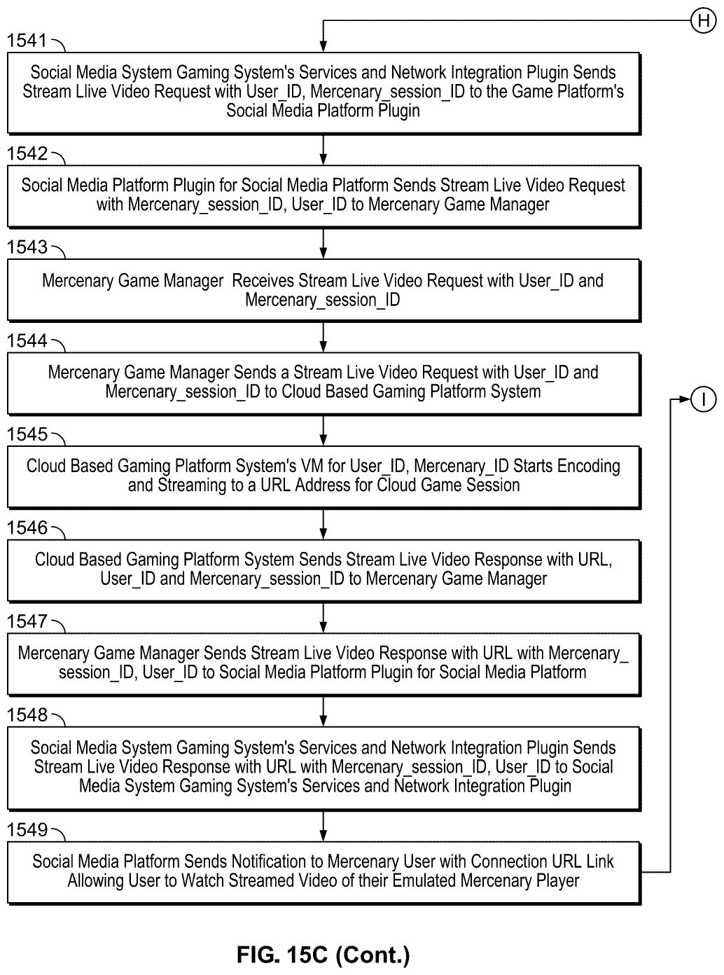

FIGS. 15A-C are an example flowchart of a process 1500 for an invited mercenary to join a user and help the user complete a level in the user's game, using the mercenary's player controlled character or emulated character, in accordance with some examples of the disclosure. As described below, the mercenary may elect to send an emulated version of themself to complete the tasks specified in the invitation. Example processes for developing an emulated version of a mercenary are described further in U.S. application Ser. No. 18/241,106, filed on Aug. 31, 2023, and U.S. Application 18/241, 109, filed on Aug. 31, 2023, both of which are hereby incorporated by reference in their entirety. The process 1500 may be implemented, in whole or in part, by the gaming systems shown in FIGS. 9 and 10. One or more actions of the process 1500 may be incorporated into or combined with one or more actions of any other process or embodiments described herein. The process 1500 may be saved to a memory or storage (such as any one or more of those shown in FIGS. 9-10) as one or more instructions or routines that may be executed by a corresponding device or system to implement the process 1500.

At step 1501, a mercenary user receives a request from a requesting player to help with the requesting user's game. At step 1502, the gaming system determines whether the request was received from a social media notification or from a game platform system notification. If the request was received as a game platform system notification, step 1504 includes determining whether the mercenary user accepted the invitation and selected to deploy the mercenary user's emulated player to assist the requesting user. If the mercenary user selected to deploy their emulated player at step 1504, the process proceeds to step 1510 at which the mercenary player's gaming device or cloud system sends an emulation player help request to the mercenary game manager, including the mercenary session ID and user ID of the mercenary player.

If, however, the mercenary user selects to join the requesting user's game themselves, (and not deploy an emulated character), the process proceeds to step 1508.

Returning back to step 1502, if the invitation was received as a social media invitation, the gaming system determines at step 1503 whether the mercenary use chose to accept and deploy the mercenary user's emulated player. If mercenary chooses to assist the requesting user themself (e.g., no at step 1503), the process 1500 proceeds to step 1505. At step 1505, the gaming system determines whether the mercenary user is on a local or cloud gaming device capable of running the game title. If not, the process 1500 may end. If the mercenary user is operating using a device capable of running the game title, step 1506 includes the social media site offering the option to the mercenary user to join the help session of the requesting user by selecting an option to launch the game title from the invitation.

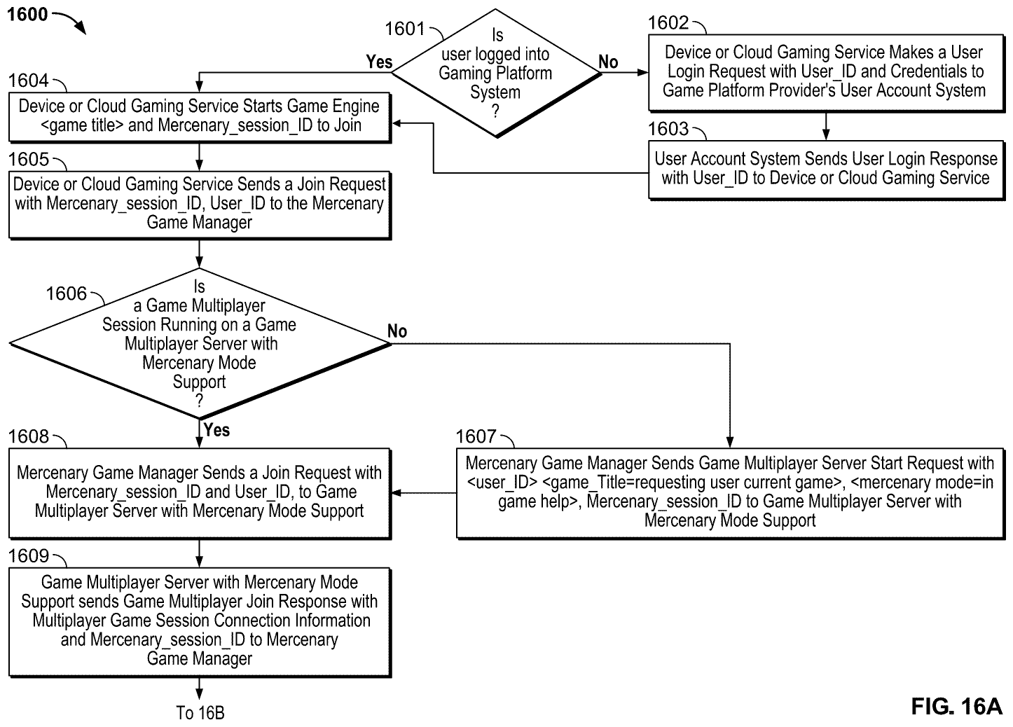

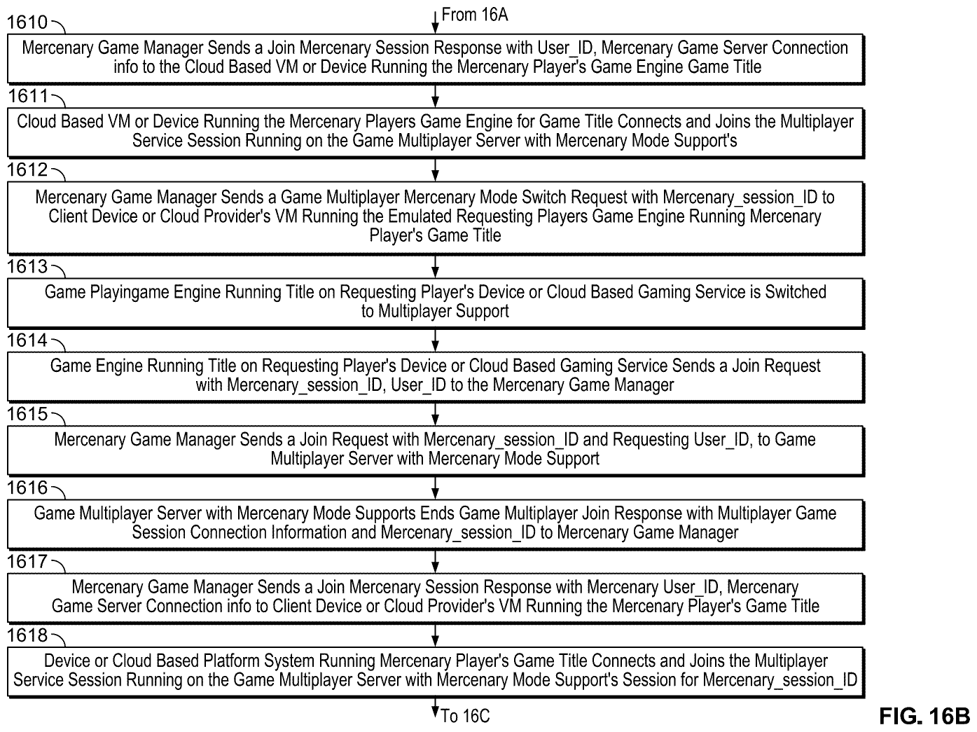

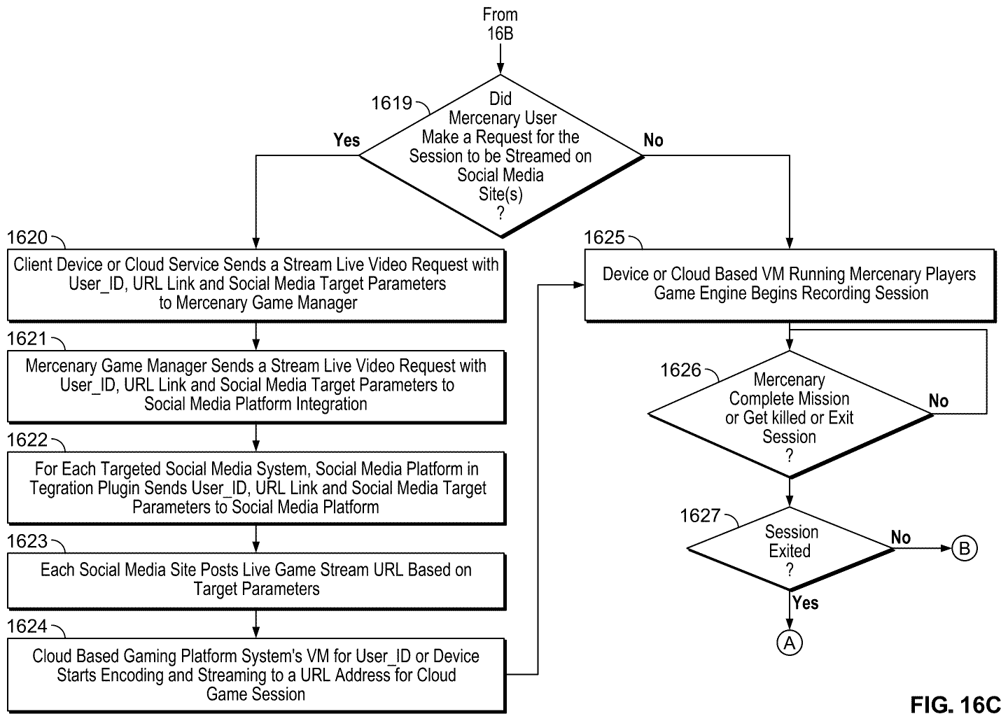

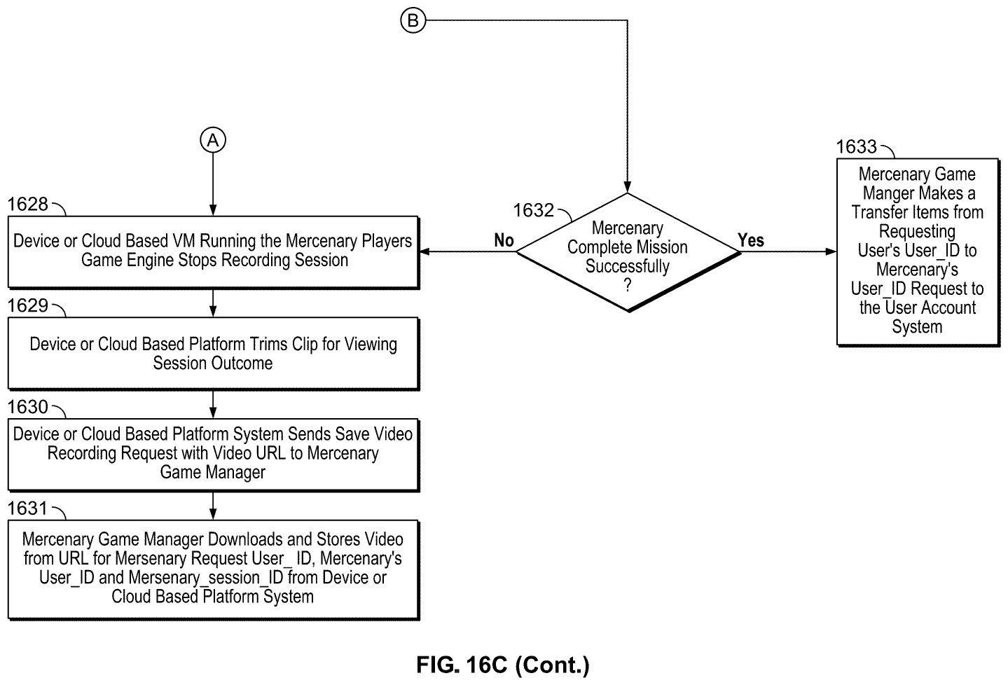

At step 1507, the gaming system determines whether the mercenary user has selected to join the requesting user's gaming session (e.g., accept the invitation). If not, the process 1500 may end. If the mercenary user does select to accept the invitation at step 1507, at step 1508 the mercenary user's device or cloud service opens the game title sent by the requesting user. Then at step 1509, the process proceeds to the process 1600 described below with respect to FIGS. 16A-C.

If at step 1503 the mercenary user chooses to send an emulated player to assist the requesting user, the process proceeds to step 1511. At step 1511, the social media platform integration system sends an emulation help request including the mercenary session ID and the user ID of the mercenary user to the social media platform plugin. And at step 1512, the social media platform plugin sends the emulation player help request to the mercenary game manager. At step 1513, the mercenary game manager sends the emulation player help request to the player emulation system.

At step 1514, the player emulation system makes a start game engine request including the game title, emulated player ID, and mercenary session ID, to the cloud based gaming platform system. At step 1515, the player emulation system starts the player emulation for the emulated player (e.g., the mercenary), with the most current skill level enabled. At step 1516, the cloud based gaming platform system sends a join request to the mercenary game manager, including the mercenary session id and the user ID of the mercenary.

At step 1517, the gaming system determines whether a game multiplayer session is running on a game multiplayer server with mercenary mode support. If not, the mercenary game manager sends a start request to the game multiplayer server to start a multiplayer game session, at step 1518. This may otherwise be referred to as instantiating a multiplayer mode, or instantiating a multiplayer game session.

At step 1519, the mercenary game manager sends a join request to the game multiplayer server. At step 1520, the game multiplayer server sends a join response to the mercenary game manager. at step 1521, the mercenary game manager sends a response to the cloud based virtual machine running the emulated mercenary player.

At step 1522, the cloud based virtual machine running the emulated mercenary player connects and joins the multiplayer service session running on the game multiplayer server for the mercenary session ID. At step 1523, the mercenary game manager sends a mode switch request including the mercenary session ID to the client device or cloud based virtual machine. At step 1524, the game play in the game engine running the title on the requesting player's device or cloud based gaming service is switched to multiplayer support.

At step 1525, the game engine running the title on the requesting player's device or cloud based gaming service sends a join request to the mercenary game manager. At step 1526, the mercenary game manager sends a join request to the game multiplayer server with mercenary support. At step 1527, the game multiplayer server with mercenary support sends a join response including connection information and the mercenary session ID to the mercenary game manager. At step 1528, the mercenary game manager sends a response including the connection information and mercenary session ID to the requesting players game engine. And at step 1529, the device or cloud based platform system running the requesting user's game connects and joins the multiplayer service running on the multiplayer server with mercenary support.

At step 1530, the gaming system determines whether the mercenary made a request for the emulated player to be streamed on a social media site. If so, at step 1541 the social media platform integration system sends a stream request to the social media platform plugin. And at step 1542, the social media platform plugin sends the stream request to the mercenary game manager. At step 1543, the mercenary game manager receives the stream request, and at step 1544 the mercenary game manager sends the stream request to the cloud based gaming platform system.

At step 1545, the cloud based gaming platform starts encoding and streaming to a URL address for the cloud gaming session. At step 1546, the cloud based gaming platform sends a stream response to the mercenary game manager. At step 1547, the mercenary game manager sends a stream response to the social media platform plugin. At step 1548, the social media platform plugin sends a stream response to the social media platform integration system. And at step 1549, the social media platform sends a notification to the mercenary user including the URL link, enabling the mercenary to watch the streamed video of their emulated player.

If, at step 1530, the gaming system determines that the mercenary did not make a request for the emulated player to be streamed, step 1531 includes the cloud based virtual machine running the emulated player's game to begin a recording session. At step 1532, the gaming system determines whether the mercenary has completed the mission, has been killed, or has exited the session.

At step 1533, if the mercenary exited the session, the process 1500 proceeds to step 1534. At step 1534, the gaming system determines whether the mercenary has successfully completed the mission. If so, at step 1535, the mercenary game manager transfers the agreed upon reward to the mercenary. If not, the cloud based gaming platform sends a save video request to the mercenary game manager.

At step 1533, if the mercenary has not exited the session (and the mission has been completed as determined at step 1532), the process proceeds to step 1537. At step 1537, the cloud based virtual machine running the emulated mercenary players game engine stops recording. At step 1538, the cloud based gaming platform trims the recording. At step 1539, the cloud based gaming platform sends a save video request to the mercenary game manager. And at step 1540, the mercenary game manager downloads and stores the video.

FIGS. 16A-C are an example flowchart of a process 1600 for an invited mercenary to join a user and help the user complete a task in the user's game, in accordance with some examples of the disclosure. The process 1600 may be implemented, in whole or in part, by the gaming systems shown in FIGS. 9 and 10. One or more actions of the process 1600 may be incorporated into or combined with one or more actions of any other process or embodiments described herein. The process 1600 may be saved to a memory or storage (such as any one or more of those shown in FIGS. 9-10) as one or more instructions or routines that may be executed by a corresponding device or system to implement the process 1600.

At step 1601, the gaming system determines whether the user is logged into the gaming platform system. If not, at step 1602, the device of cloud gaming system of the user makes a user login request to the user account system. At step 1603, the user account system sends a response to the user device or cloud gaming service.

At step 1604, the device or cloud gaming service starts the game engine for the game title and mercenary session ID. At step 1605, the device or cloud gaming service sends a join request to the mercenary game manager. At step 1606, the gaming system determines whether the game is running on a multiplayer game server with mercenary mode support. If not, at step 1607, the mercenary game manager sends a multiplayer server start request to the multiplayer server (e.g., instantiating a multiplayer mode or multiplayer gaming session).

At step 1608, the mercenary game manager sends a join request to the multiplayer server. At step 1609, the multiplayer server sends a join response with connection information and the mercenary session ID to the mercenary game manager.

At step 1610, the mercenary game manager sends a join response including the connection information to the device of cloud based virtual machine running the mercenary player's game engine. At step 1611, the cloud based virtual machine running the mercenary player's game engine connects and joins the multiplayer service session running on the multiplayer server with mercenary support.

At step 1612, the mercenary game manager sends a switch request to the client device or cloud based virtual machine running the mercenary players game engine. At step 1613, the game engine running on the requesting player's device is switched to multiplayer support. At step 1614, the game engine running on the requesting player's device sends a join request to the mercenary game manager. At step 1615, the mercenary game manager sends the join request to the multiplayer server with mercenary support. At step 1616, the multiplayer server sends a join response to the mercenary game manager. At step 1617, the mercenary game manager sends the join response including the mercenary user ID and the connection information to the client device or cloud based virtual machine running the mercenary player's game. And at step 1618, the device or cloud based virtual machine running the mercenary player's game connects and joins the multiplayer service session running on the multiplayer server.

At step 1619, the gaming system determines whether the mercenary made a request for the session to be streamed on a social media site. If so, at step 1620 the mercenary player device sends a stream request to the mercenary game manager. At step 1621, the mercenary game manager sends the stream request to the social media platform integration system. At step 1622, for each targeted social media system, the social media platform plugin sends the user ID, link, and social media target parameters to the social media platform integration system. At step 1623, each social media side posts the stream of the session based on the target parameters. At step 1624, the cloud based gaming platform starts encoding and streaming the session.

If, at step 1619, the gaming system determines that the mercenary did not make a request for the session to be streamed, step 1625 includes the cloud based virtual machine running the emulated player's game to begin recording the session. At step 1626, the gaming system determines whether the mercenary has completed the mission, has been killed, or has exited the session.

At step 1627, if the mercenary did not exit the session, the process 1600 proceeds to step 1632. At step 1632, the gaming system determines whether the mercenary has successfully completed the mission. If so, at step 1633, the mercenary game manager transfers the agreed upon reward to the mercenary. If not, the process 1600 proceeds to step 1628.

At step 1628, if the mercenary has exited the session, the device or cloud-based virtual machine running the emulated mercenary players game engine stops recording the session. At step 1629, the device or cloud based gaming platform trims the recording. At step 1630, the device or cloud based gaming platform sends a save video request to the mercenary game manager. And at step 1631, the mercenary game manager downloads and stores the video.

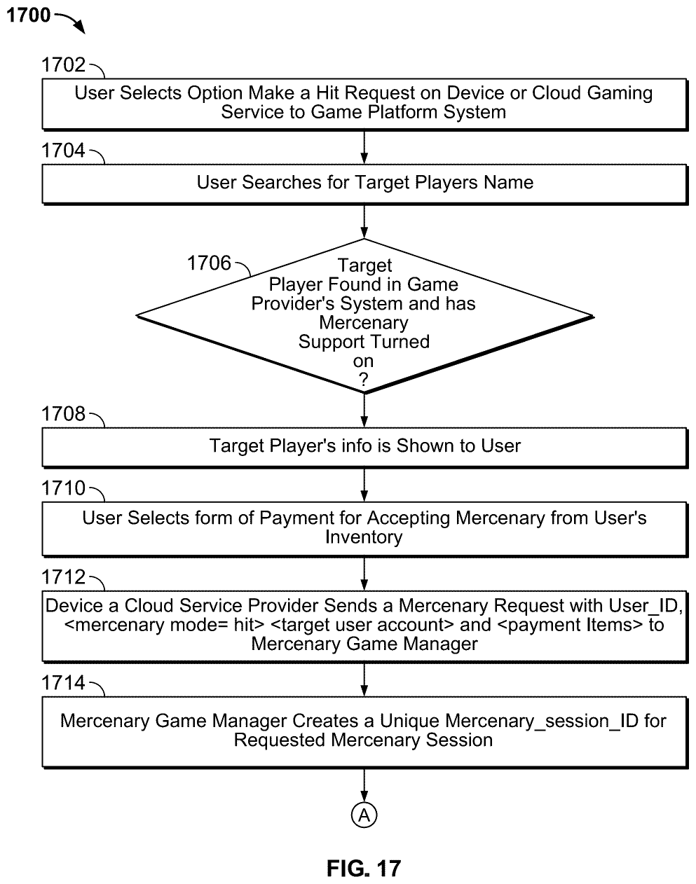

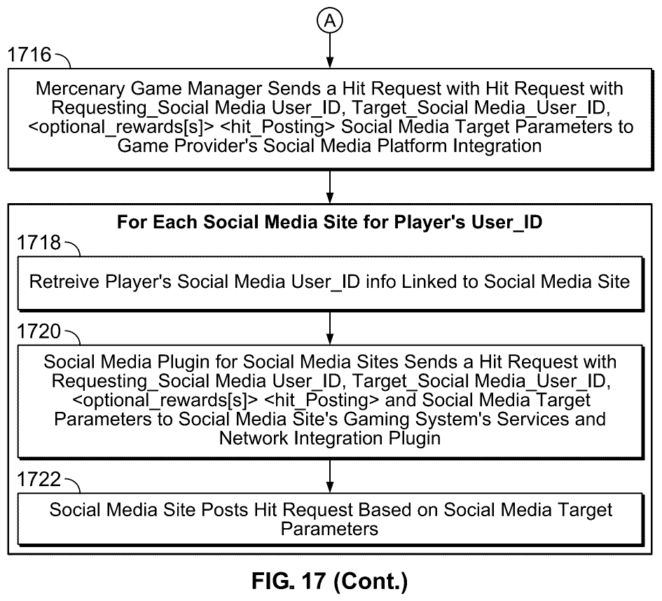

FIG. 17 is an example flowchart of a process 1700 for a user to take out a hit or make an elimination request with respect to a target user's player character, from a gaming system platform, in accordance with some examples of the disclosure. The process 1700 may be implemented, in whole or in part, by the gaming systems shown in FIGS. 9 and 10. One or more actions of the process 1700 may be incorporated into or combined with one or more actions of any other process or embodiments described herein. The process 1700 may be saved to a memory or storage (such as any one or more of those shown in FIGS. 9-10) as one or more instructions or routines that may be executed by a corresponding device or system to implement the process 1700.

At step 1702, the gaming system determines that the user has selected an option to make a hit request or elimination request via the user's device or cloud gaming service. At step 1704, the gaming system searched for the target players name or other identifying information. At step 1706, the gaming system determines whether the target player has been found and has mercenary support turned on. If not, the process 1700 may end.

At step 1708, the gaming system provides the target player's information to the requesting user. At step 1710, the requesting user selects a form of payment (or reward) to provide to the mercenary, from the requesting user's inventory. At step 1712, the requesting user's device sends a mercenary request to the mercenary game manager. At step 1714, the mercenary game manager creates a unique mercenary session ID. At step 1716, the mercenary game manager sends the hit request (e.g., invitation) to the social media platform integration system.

At steps 1718, 1720, and 1722, for each social media site associated with the requesting user, the gaming system retrieves the requesting user's social media user ID, the social media plugin sends the hit request (invitation) and related information to the social media integration plugin, and the respective social media site posts the hit request (invitation) based on the target parameters (e.g., all friends, only subset of friends, etc.).

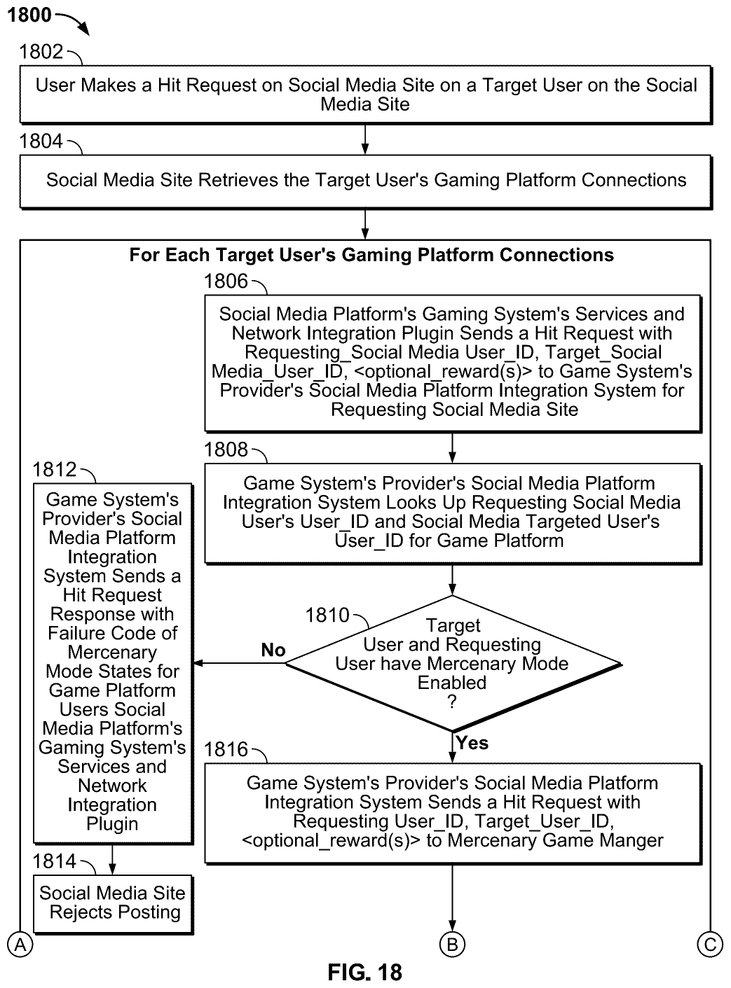

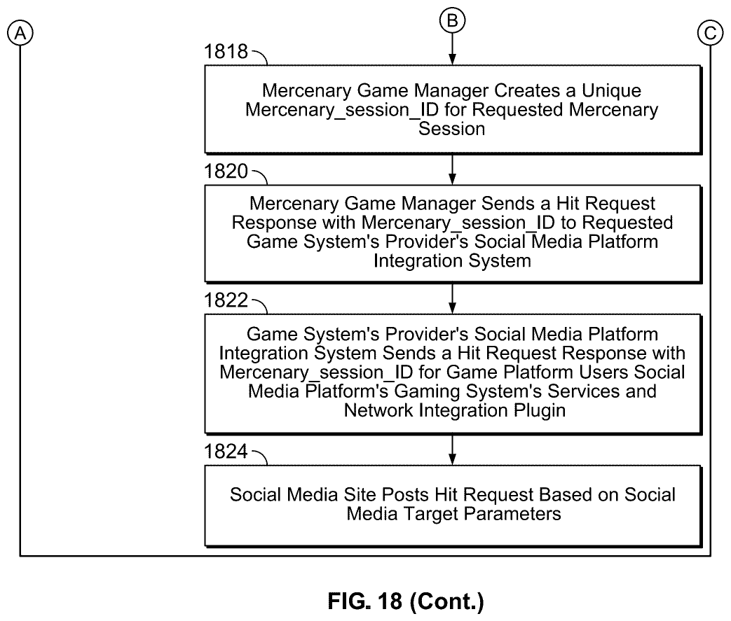

FIG. 18 is an example flowchart of a process 1800 for a user to take out a hit or make an elimination request with respect to a target user's player character, from a social media account, in accordance with some examples of the disclosure. The process 1800 may be implemented, in whole or in part, by the gaming systems shown in FIGS. 9 and 10. One or more actions of the process 1800 may be incorporated into or combined with one or more actions of any other process or embodiments described herein. The process 1800 may be saved to a memory or storage (such as any one or more of those shown in FIGS. 9-10) as one or more instructions or routines that may be executed by a corresponding device or system to implement the process 1800.

At step 1802, the gaming system determines that a requesting user has made a hit request or elimination request on a social media site, against a target user on the social media site. At step 1804, the social media site retrieves the target user's information, including the target user's gaming platform information.

Steps 1806-1824 are then performed for each relevant gaming platform for the target user.

At step 1806, the social media platform plugin sends the hit request (e.g., invitation) to the social media platform integration system for the requesting social media site. At step 1808, the social media platform integration system looks up the requesting user's social media user ID and the target user's user ID.

At step 1810, the gaming system determines whether the target user and the requesting user both have mercenary mode enabled. If not, at step 1812, the social media platform integration system sends a hit request response with a failure code to the social media platform plugin. And at step 1814, the social media site rejects the requesting user's hit request posting.

If, at step 1810, the gaming system determines that both the requesting user and the target user have mercenary mode enabled, the process 1800 proceeds to step 1816. At step 1816, the social media platform integration system sends the hit request to the mercenary game manager. At step 1818, the mercenary game manager creates a unique mercenary session ID. At step 1820, the mercenary game manager sends a hit request response to the social media platform integration system. At step 1822, the social media platform integration system sends a hit request response to the social media platform plugin, and at step 1824 the relevant social media site posts the hit request (e.g., invitation).

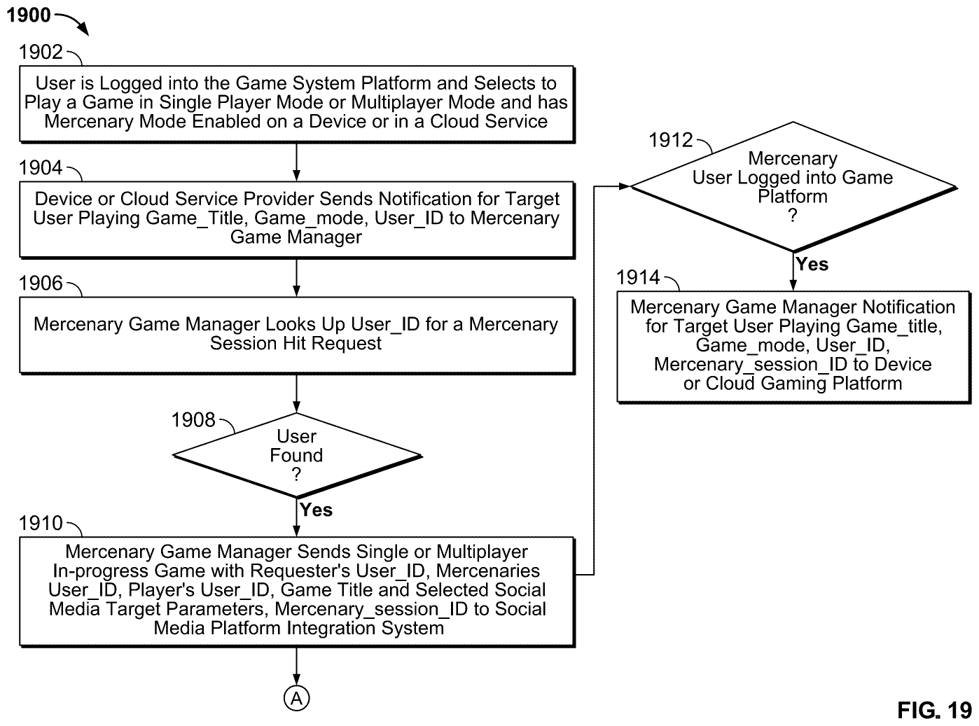

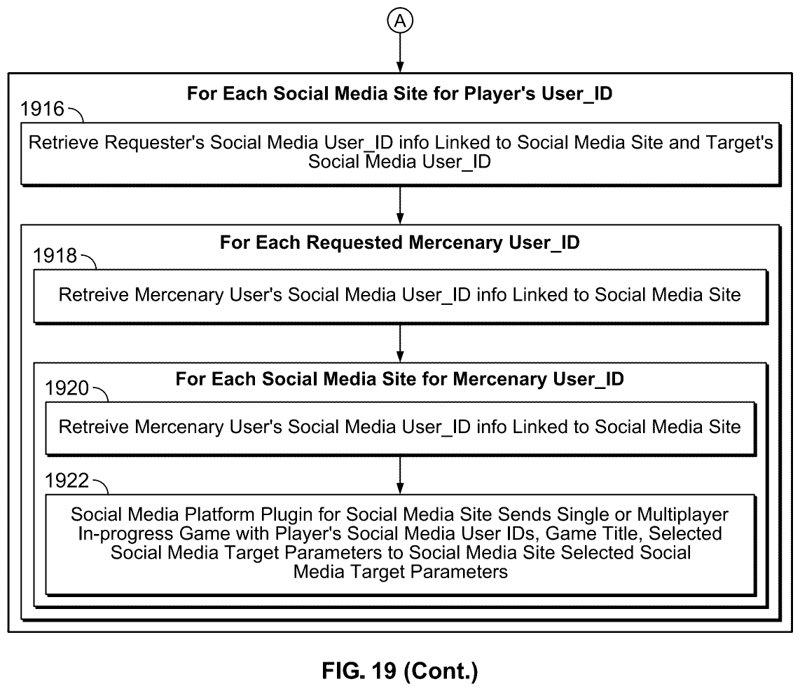

FIG. 19 is an example flowchart of a process 1900 for notifying a mercenary when the target player of a requested hit or elimination request is playing a relevant game, in accordance with some examples of the disclosure. The process 1900 may be implemented, in whole or in part, by the gaming systems shown in FIGS. 9 and 10. One or more actions of the process 1900 may be incorporated into or combined with one or more actions of any other process or embodiments described herein. The process 1900 may be saved to a memory or storage (such as any one or more of those shown in FIGS. 9-10) as one or more instructions or routines that may be executed by a corresponding device or system to implement the process 1900.

At step 1902, the gaming system determines that the target user is logged into the game system platform and has selected to play a game, and has mercenary mode enabled. At step 1904, the device or cloud-based service provide sends a notification to the mercenary game manager indicating that the target user is playing a game, the game mode, and the user ID.

At step 1906, the mercenary game manager looks up the received user ID to determine which hit request (invitation) it corresponds to.

At step 1908, the gaming system determines whether the target user has been found in the gaming system. If not, the process 1900 ends. If the target user is found, at step 1910 the mercenary game manager sends information to the social media platform integration system, the information pertaining to the hit request user and the mercenary user, and that the target user is currently playing a game. The information also includes the requesting user's user ID, the mercenary user ID, the target user ID, the game title, the selected social media target parameters, and the mercenary session ID.

At step 1912, the gaming system determines whether the mercenary user is logged in to the gaming platform. If the mercenary is logged in, the mercenary game manager provides a notification to the mercenary user's device or cloud gaming platform indicating that the target user is online and playing a game title in single player or multiplayer mode.

At step 1916, the gaming system retrieves, for the requesting user, the social media user ID information for each social media site for which the requesting user has a social media account. At step 1918, the gaming system retrieves, for each requested mercenary, the respective mercenary user's social media user IDs and other information for each relevant social media site.

At step 1920, the gaming system retrieves, for each social media site identified at step 1918 for each of the requested mercenaries, the respective mercenary user's social media user ID for that site. And at step 1922, the social media platform plugin sends a notification to the social media accounts of the selected mercenaries, the notification including information such as that the target is online and playing a game, the game title, and whether the target user is playing in a single player or multiplayer mode.

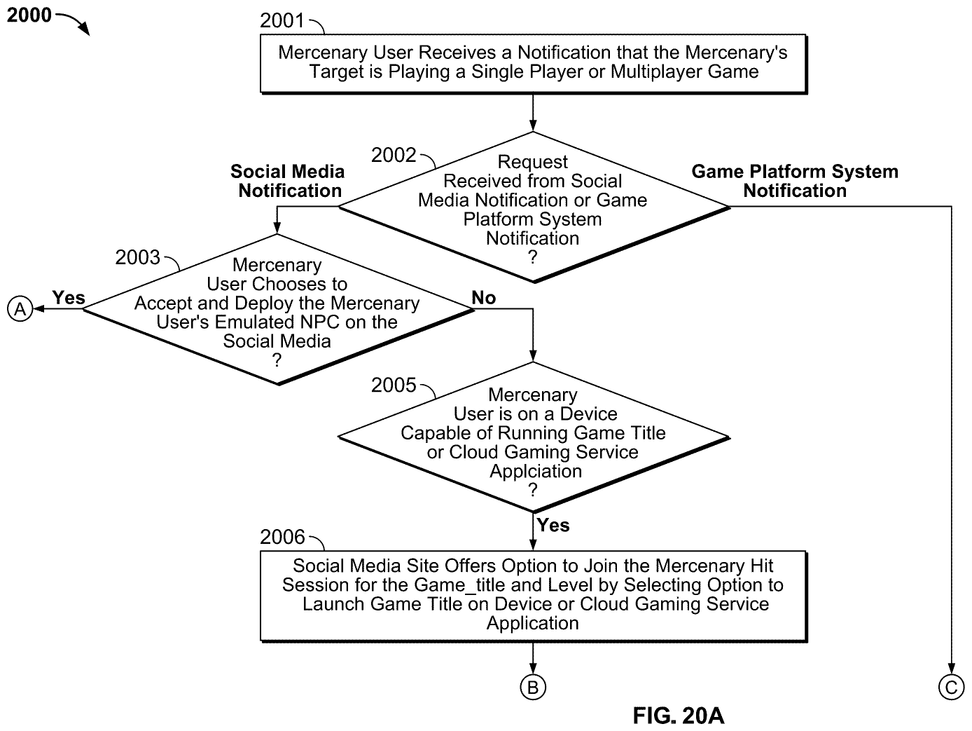

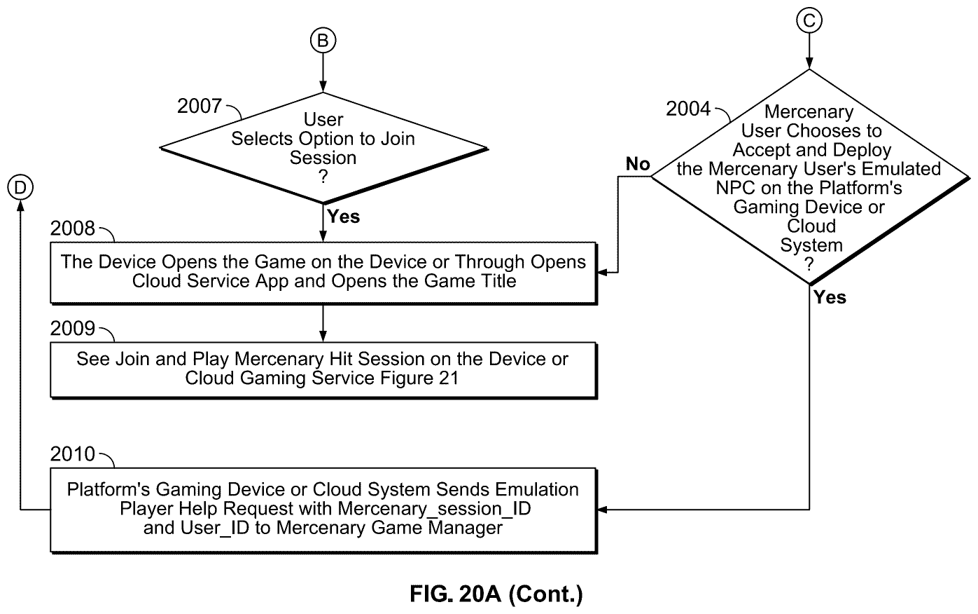

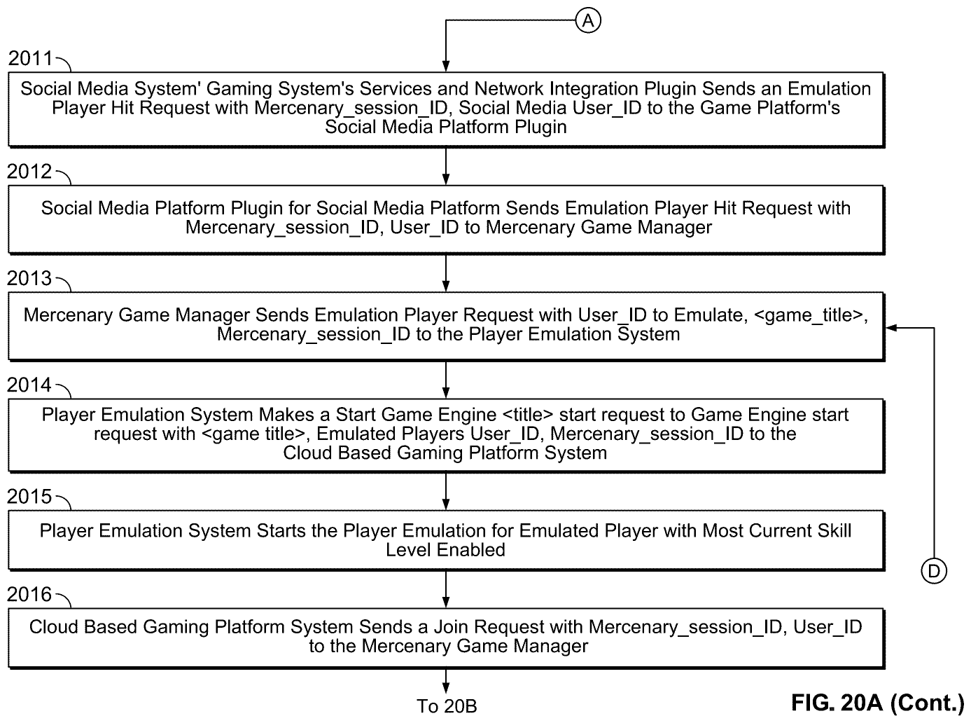

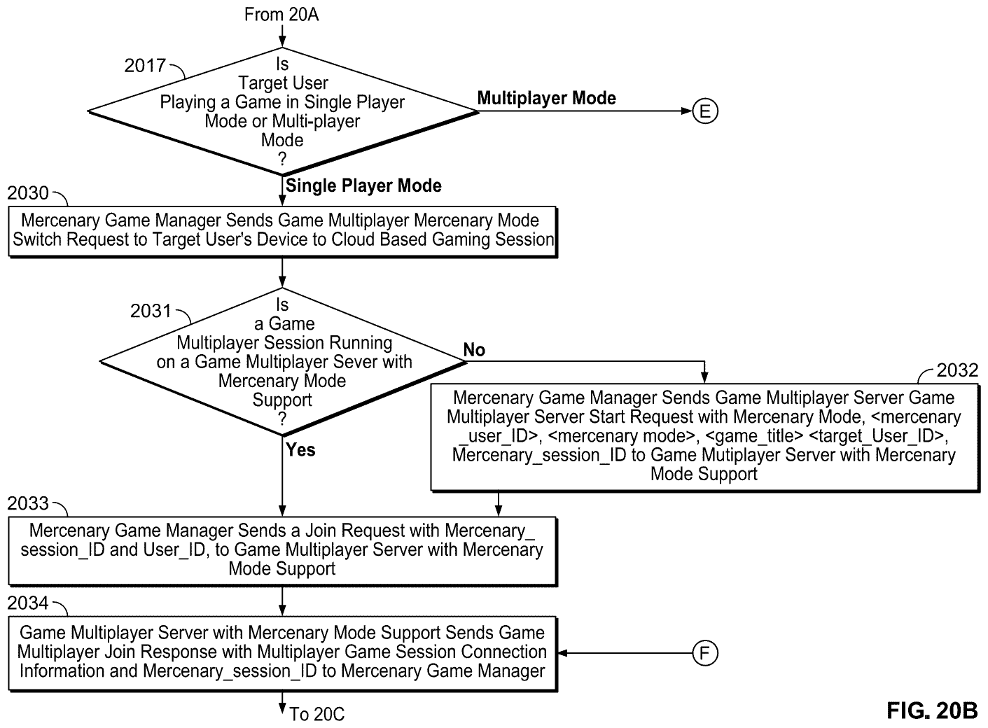

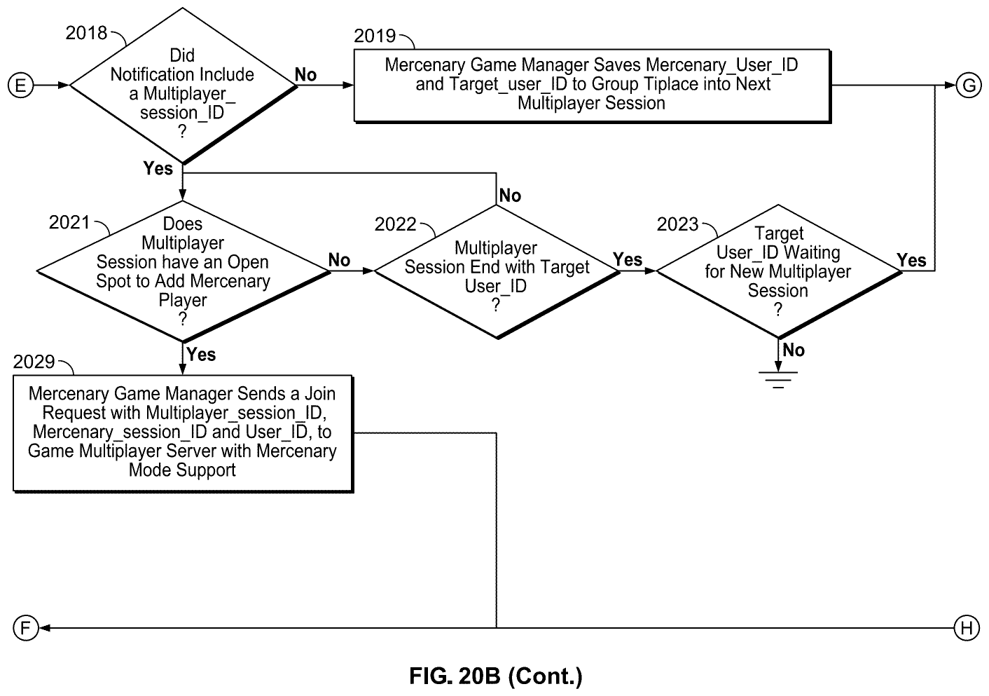

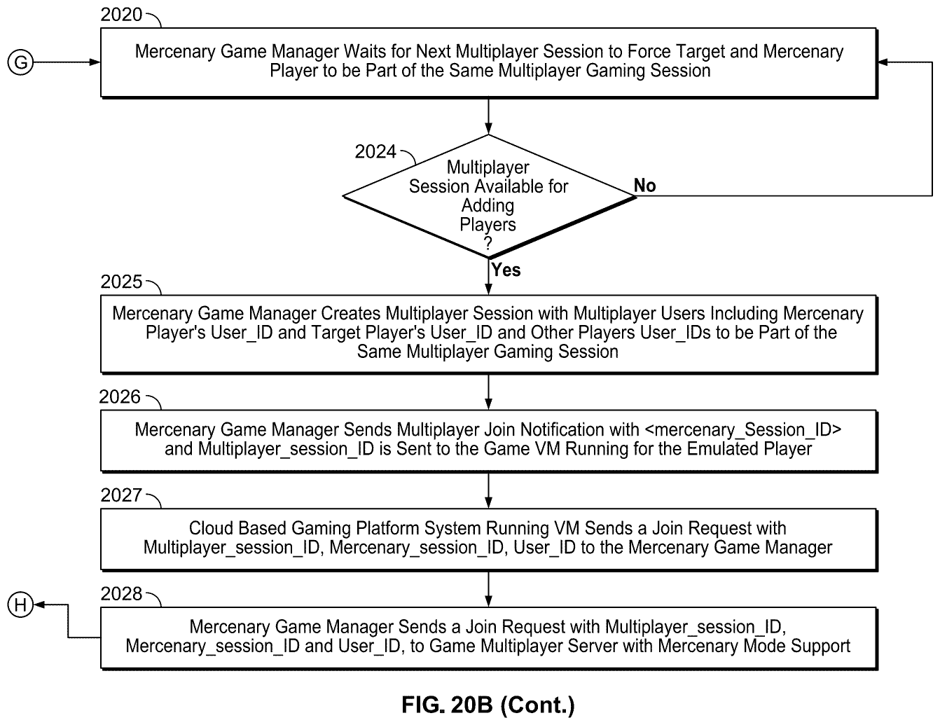

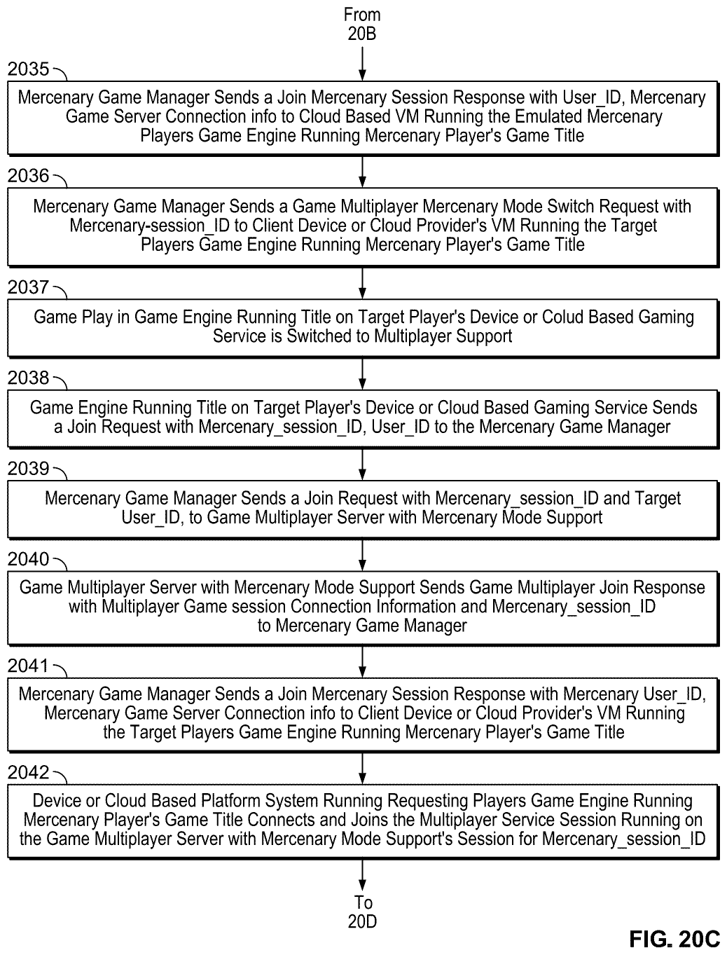

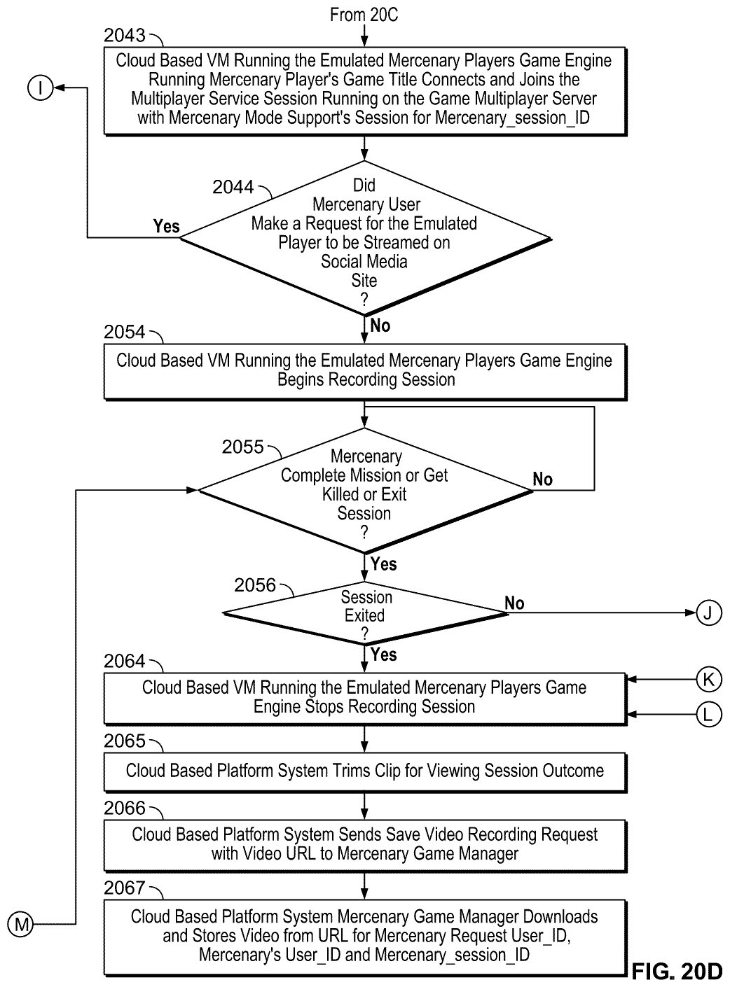

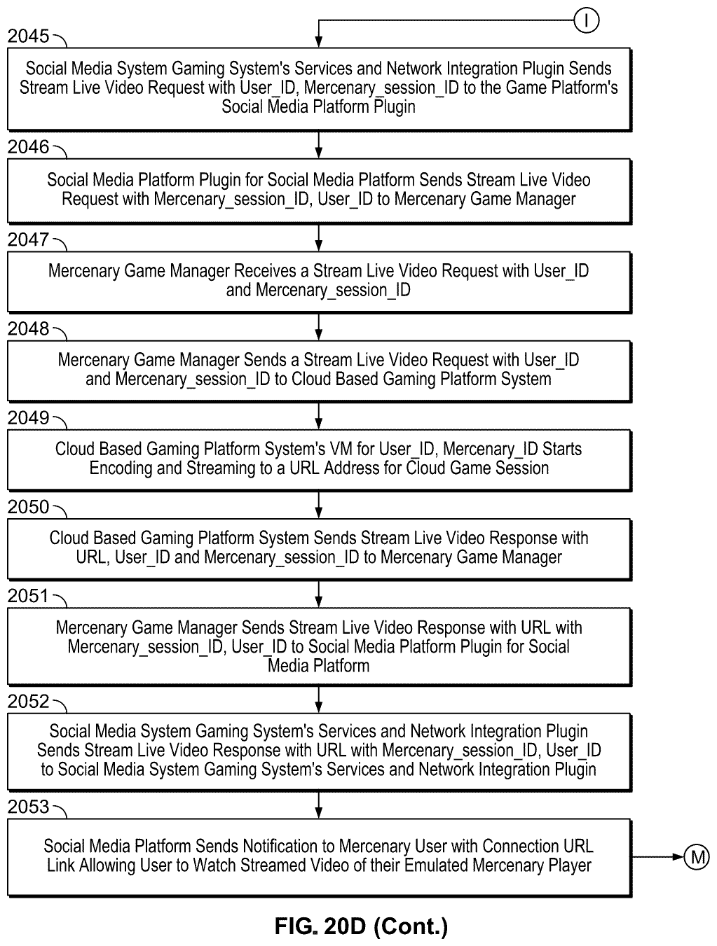

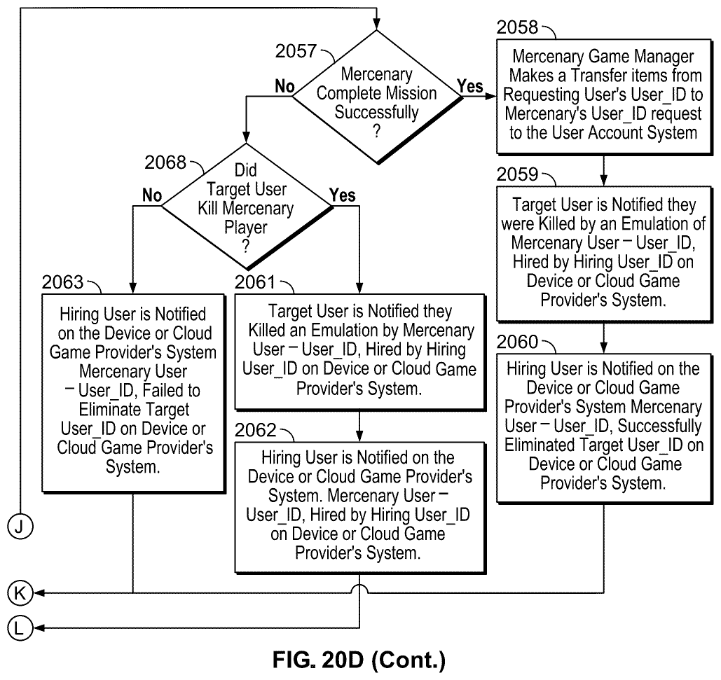

FIGS. 20A-D are an example flowchart of a process 2000 for a mercenary to send an emulated player character to perform a hit or elimination request, in accordance with some examples of the disclosure. The process 2000 may be implemented, in whole or in part, by the gaming systems shown in FIGS. 9 and 10. One or more actions of the process 2000 may be incorporated into or combined with one or more actions of any other process or embodiments described herein. The process 2000 may be saved to a memory or storage (such as any one or more of those shown in FIGS. 9-10) as one or more instructions or routines that may be executed by a corresponding device or system to implement the process 2000.

At step 2001, the gaming system notifies the mercenary user that the target user is playing a single player or multiplayer game. At step 2002, the gaming system determines whether the notification of the target's online presence was received by the mercenary via a game platform or via social media.

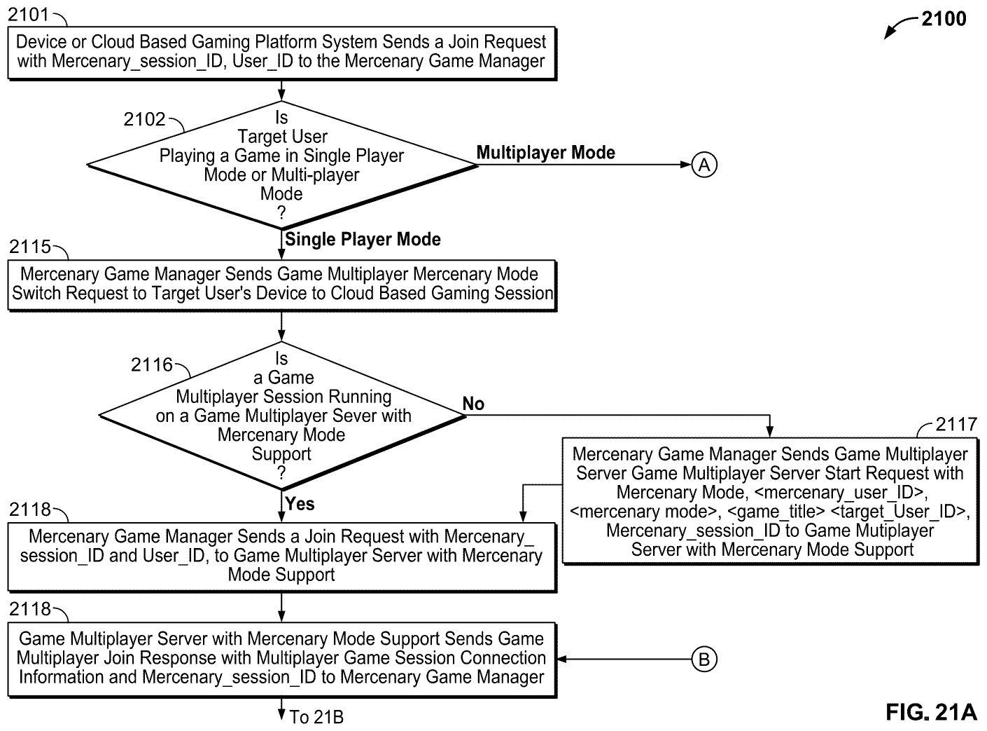

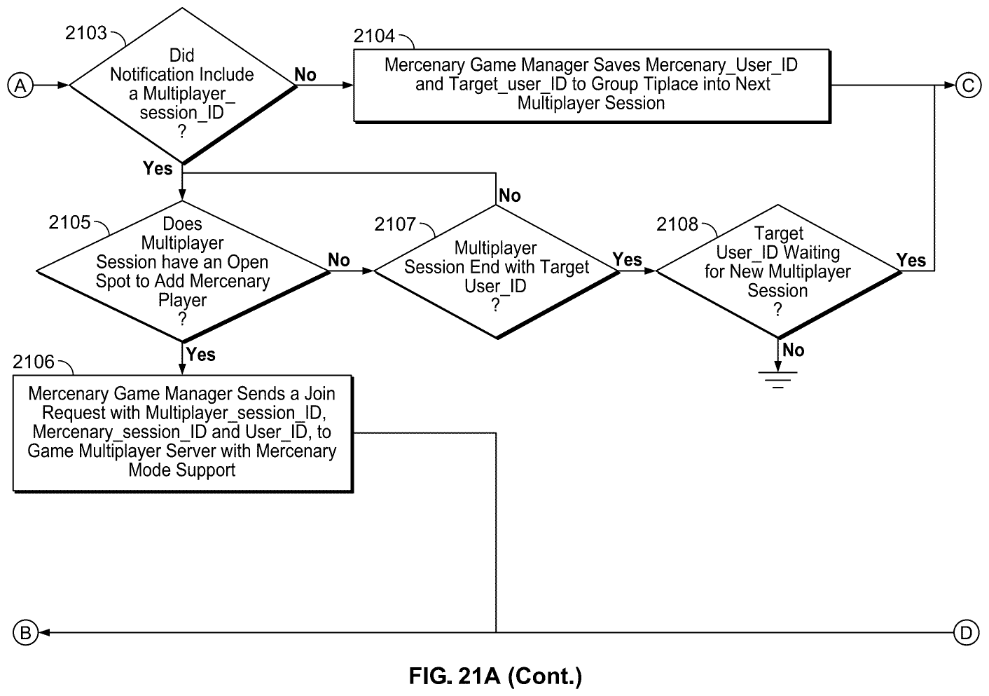

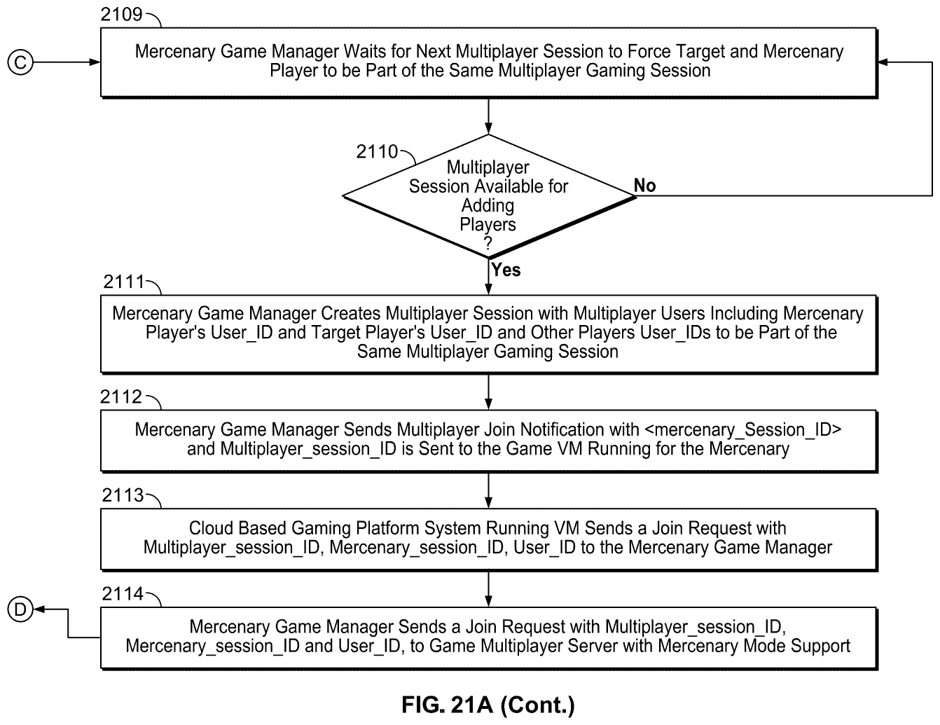

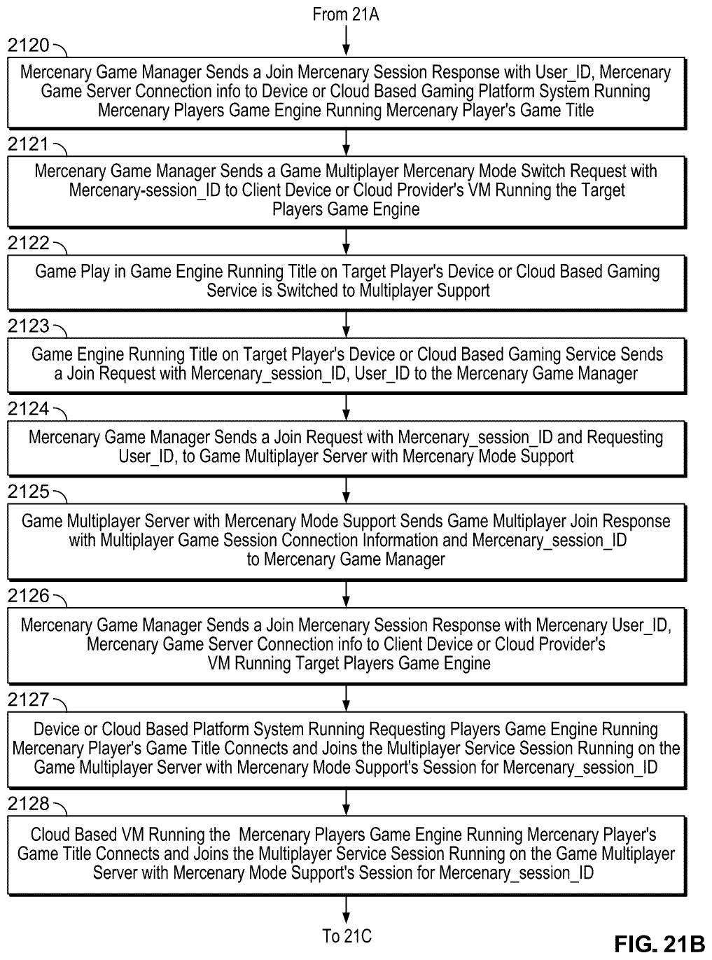

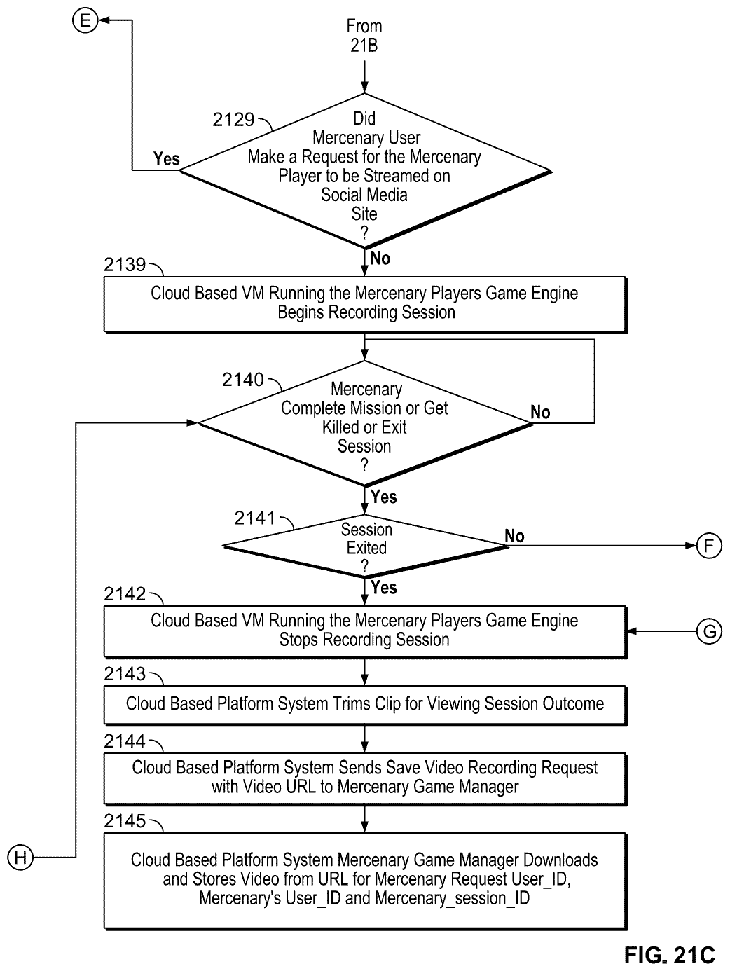

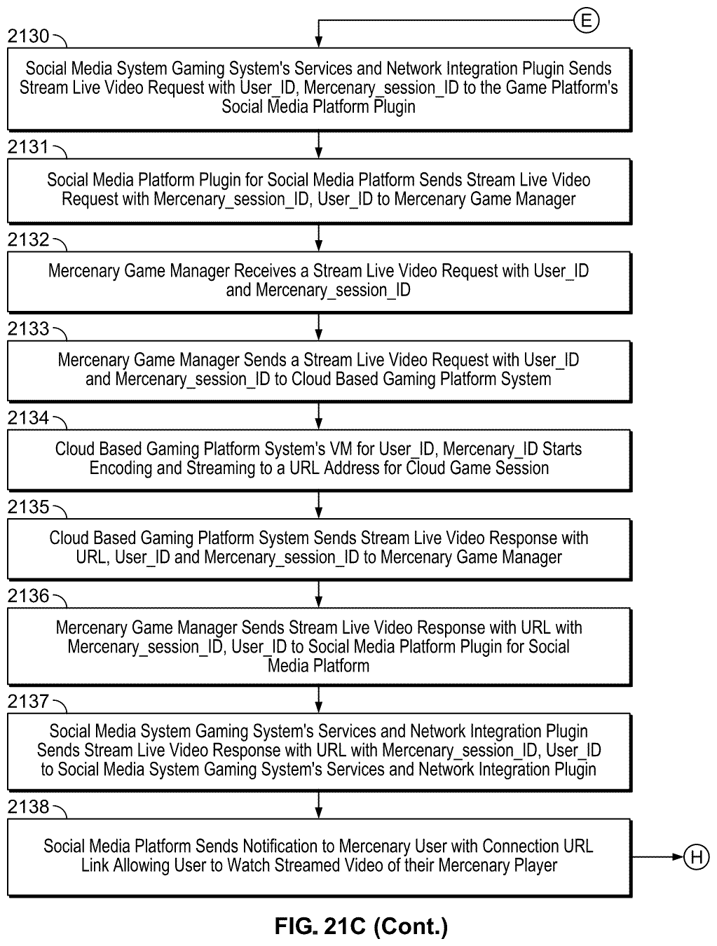

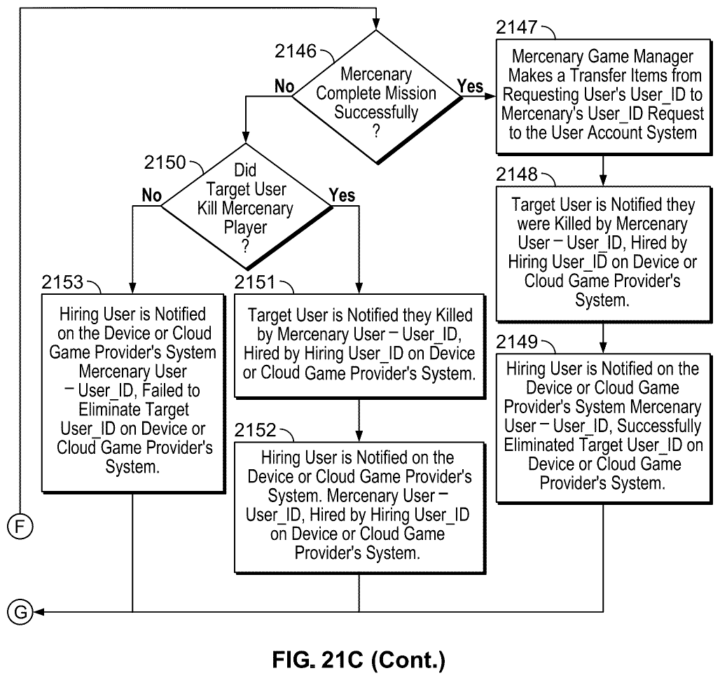

At step 2004, if the mercenary is notified that the target is online via a game platform notification, the gaming system determines whether the mercenary chooses to act on the notification by deploying an emulated player. If the mercenary elects to join the target's game themself (i.e., not send an emulated player), the process proceeds to step 2008. At step 2008, the mercenary's device opens the relevant game, and at step 2009 the process proceeds to the process 2100 described with respect to FIGS. 21A-C.

If the mercenary chooses to send an emulated player at step 2004, the process 2000 proceeds to step 2010. At step 2010, the mercenary device sends an emulation player help request to the mercenary game manager.

If, however, at step 2002, the gaming system determines that the notification of the target user's online status is received by the mercenary via a social media notification, the process proceeds to step 2003. At step 2003, the gaming system determines whether the mercenary user elects to deploy an emulated player to join the target user's game session. If the mercenary elects to join himself (i.e., not send an emulated player), the process 2000 proceeds to step 2005. At step 2005, the gaming system determines whether the mercenary is on a device that is capable of running the game title. If not, the process 2000 may end. If the mercenary user is operating using a device capable of running the game title, step 2006 includes the social media site offering the option to the mercenary user to join the mercenary hit session of the target user by selecting an option to launch the game title from the invitation.

At step 2007, the gaming system determines whether the mercenary user has selected to join the target user's gaming session. If not, the process 2000 may end. If the mercenary user does select to join the target user's session at step 2007, at step 2008 the mercenary user's device or cloud service opens the game title being played by the target user. Then at step 2009, the process proceeds to the process 2100 described below with respect to FIGS. 21A-C.

If at step 2003 the mercenary user chooses to send an emulated player to carry out the elimination request on the target user, the process proceeds to step 2011. At step 2011, the social media platform integration system sends an emulation player hit request including the mercenary session ID and the user ID of the mercenary user to the social media platform plugin. And at step 2012, the social media platform plugin sends the emulation player hit request to the mercenary game manager. At step 2013, the mercenary game manager sends the emulation player hit request to the player emulation system.

At step 2014, the player emulation system makes a start game engine request including the game title, emulated player ID, and mercenary session ID, to the cloud based gaming platform system. At step 2015, the player emulation system starts the player emulation for the emulated player (e.g., the mercenary), with the most current skill level enabled. At step 2016, the cloud based gaming platform system sends a join request to the mercenary game manager, including the mercenary session id and the user ID of the mercenary.

At step 2017, the gaming system determines whether the target user is playing in single player mode or multiplayer mode. If the target user is playing in multiplayer mode, the gaming system at step 2018 determines whether the notification sent to the mercenary player included a multiplayer session ID. If not, the mercenary game manager, at step 2019, saves the mercenary user ID and target user ID to a group to place them together into a next multiplayer session (e.g., via the game matchmaking process).

If the gaming system determines that the notification sent to the mercenary did include a multiplayer session ID at step 2018, the process 2000 proceeds to step 2021. At step 2021, the gaming system determines whether the multiplayer session has an open spot in which to add the mercenary player. If so, at step 2029, the mercenary game manager sends a join request to the multiplayer server to add the mercenary to the multiplayer session. If there is no open spot at step 2021, the gaming system determines whether the multiplayer session including the target user has ended, at step 2022. If not, the process repeats steps 2021-2022 until the target user's multiplayer session has ended. Once the target user's multiplayer session has ended at step 2022, the gaming system determines whether the target user is waiting for a new multiplayer session at step 2023 (e.g., whether the target is attempting to join a new multiplayer session).

At step 2020, the mercenary game manager waits for the next multiplayer session in order to force the mercenary and the target to be part of the same multiplayer session. At step 2024, the gaming system determines whether a multiplayer session is available to add players. If not, the process reverts to step 2020. If a multiplayer session is available at step 2024, the process proceeds to step 2025.

At step 2025, the mercenary game manager creates a multiplayer session for the mercenary and target, along with one or more other players. At step 2026, the mercenary game manager sends a join notification to the virtual machine of the emulated player of the mercenary. At step 2027, the virtual machine of the emulated player sends a join request to the mercenary game manager. And at step 2028, the mercenary game manager sends a join request to the multiplayer server with mercenary support. The process then proceeds to step 2034, described below.

If, at step 2017, the gaming system determines that the target player is playing in a single player mode, the process proceeds to step 2030. At step 2030, the mercenary game manager sends a switch request to the target user's device. At step 2031, the gaming system determines whether the target user game is a multiplayer game session running on a multiplayer server with mercenary support. If not, at step 2032, the mercenary game manager sends a multiplayer server start request to the multiplayer server with mercenary support. At step 2033, the mercenary game manager sends a join request to the multiplayer server with mercenary support to add the emulated player. At step 2034, the multiplayer server with mercenary support sends a join response including connection information to the mercenary game manager.

At step 2035, the mercenary game manager sends a join session response to the virtual machine running the mercenary's emulated player. At step 2036, the mercenary game manager sends a mode switch request including the mercenary session ID to the client device or cloud based virtual machine running the target player's game. At step 2037, the game play in the game engine running the title on the target player's device or cloud based gaming service is switched to multiplayer support.

At step 2038, the game engine running the title on the target player's device or cloud based gaming service sends a join request to the mercenary game manager. At step 2039, the mercenary game manager sends a join request to the game multiplayer server with mercenary support. At step 2040, the game multiplayer server with mercenary support sends a join response including connection information and the mercenary session ID to the mercenary game manager. At step 2041, the mercenary game manager sends a join session response including the connection information to the target players game engine. And at step 2042, the device or cloud based platform system running the requesting player's game engine connects and joins the multiplayer service running on the multiplayer server with mercenary support.

At step 2043, the game engine running the mercenary's emulated player connects and joins the multiplayer server.

At step 2044, the gaming system determines whether the mercenary made a request for the emulated player to be streamed on a social media site. If so, at step 2045 the social media platform integration system sends a stream request to the social media platform plugin. And at step 2046, the social media platform plugin sends the stream request to the mercenary game manager. At step 2047, the mercenary game manager receives the stream request, and at step 2048 the mercenary game manager sends the stream request to the cloud based gaming platform system.

At step 2049, the cloud based gaming platform starts encoding and streaming to a URL address for the cloud gaming session. At step 2050, the cloud based gaming platform sends a stream response to the mercenary game manager. At step 2051, the mercenary game manager sends a stream response to the social media platform plugin. At step 2052, the social media platform plugin sends a stream response to the social media platform integration system. And at step 2053, the social media platform sends a notification to the mercenary user including the URL link, enabling the mercenary to watch the streamed video of their emulated player.

If, at step 2044, the gaming system determines that the mercenary did not make a request for the emulated player to be streamed, step 2054 includes the cloud based virtual machine running the emulated player's game to begin a recording session. At step 2055, the gaming system determines whether the mercenary has completed the mission, has been killed, or has exited the session.

At step 2056, if the mercenary has exited the session (and the mission has been completed as determined at step 2055), the process proceeds to step 2064. At step 2064, the cloud based virtual machine running the emulated mercenary player's game engine stops recording. At step 2065, the cloud based gaming platform trims the recording. At step 2066, the cloud based gaming platform sends a save video request to the mercenary game manager. And at step 2067, the mercenary game manager downloads and stores the video.

If, however, at step 2056, the mercenary has not exited the session, the process 2000 proceeds to step 2057. At step 2057, the gaming system determines whether the mercenary has successfully completed the mission. If so, at step 2058, the mercenary game manager transfers the agreed upon reward to the mercenary. Then at step 2059, the target user is notified that they were eliminated by an emulation of the mercenary, hired by a requesting user. And at step 2060, the requesting user is notified that the target was successfully eliminated.

If the emulated player was not successful at step 2057, the gaming system determines whether the target eliminated the mercenary's emulated player at step 2068. If the target user did kill the mercenary's emulated player, the process proceeds to step 2061. At step 2016, the target user is notified that they eliminated an emulation of a mercenary user. And at step 2062, the hiring user or requesting user is notified that the target user eliminated the mercenary's emulated player.

If the gaming system determines that the target user did not eliminate the mercenary at step 2068, and the mercenary mission was not successfully completed at step 2057, the process 2000 proceeds to step 2063. At step 2063, the hiring user is notified that the mercenary failed to eliminate the target user. The process 2000 then proceeds to steps 2064-2067, described above.

FIGS. 21A-C are an example flowchart of a process 2100 for a mercenary to join the target user's gaming session to perform a hit or elimination request, in accordance with some examples of the disclosure. The process 2100 may be implemented, in whole or in part, by the gaming systems shown in FIGS. 9 and 10. One or more actions of the process 2100 may be incorporated into or combined with one or more actions of any other process or embodiments described herein. The process 2100 may be saved to a memory or storage (such as any one or more of those shown in FIGS. 9-10) as one or more instructions or routines that may be executed by a corresponding device or system to implement the process 1000.

At step 2101, the mercenary device sends a join request to the mercenary game manager. At step 2102, the gaming system determines whether the target user is playing in single player mode or multiplayer mode. If the target user is playing in multiplayer mode, the gaming system at step 2103 determines whether the notification sent to the mercenary player included a multiplayer session ID. If not, the mercenary game manager, at step 2104, saves the mercenary user ID and target user ID to a group to place them together into a next multiplayer session (e.g., via the game matchmaking process).

If the gaming system determines that the notification sent to the mercenary did include a multiplayer session ID at step 2103, the process 2100 proceeds to step 2105. At step 2105, the gaming system determines whether the multiplayer session has an open spot in which to add the mercenary player. If so, at step 2106, the mercenary game manager sends a join request to the multiplayer server with mercenary support to add the mercenary to the multiplayer session. If there is no open spot at step 2105, the gaming system determines whether the multiplayer session including the target user has ended, at step 2107. If not, the process repeats steps 2105 and 2107 until the target user's multiplayer session has ended. Once the target user's multiplayer session has ended at step 2107, the gaming system determines whether the target user is waiting for a new multiplayer session at step 2108 (e.g., whether the target is attempting to join a new multiplayer session).

At step 2109, the mercenary game manager waits for the next multiplayer session in order to force the mercenary and the target to be part of the same multiplayer session. At step 2110, the gaming system determines whether a multiplayer session is available to add players. If not, the process reverts to step 2109. If a multiplayer session is available at step 2110, the process proceeds to step 2111.

At step 2111, the mercenary game manager creates a multiplayer session for the mercenary and target, along with one or more other players. At step 2112, the mercenary game manager sends a join notification to the virtual machine of the mercenary. At step 2113, the virtual machine of the mercenary sends a join request to the mercenary game manager. And at step 2114, the mercenary game manager sends a join request to the multiplayer server. The process then proceeds to step 2119, described below.

If, at step 2102, the gaming system determines that the target player is playing in a single player mode, the process proceeds to step 2115. At step 2115, the mercenary game manager sends a switch request to the target user's device. At step 2116, the gaming system determines whether the target user game is a multiplayer game session running on a multiplayer server. If not, at step 2117, the mercenary game manager sends a multiplayer server start request to the multiplayer server with mercenary support. At step 2118, the mercenary game manager sends a join request to the multiplayer server with mercenary support to add the mercenary player. At step 2119, the multiplayer server with mercenary support sends a join response including connection information to the mercenary game manager.

At step 2120, the mercenary game manager sends a join session response to the virtual machine running the mercenary's game. At step 2121, the mercenary game manager sends a mode switch request including the mercenary session ID to the client device or cloud based virtual machine running the target player's game. At step 2122, the game play in the game engine running the title on the target player's device or cloud based gaming service is switched to multiplayer support.

At step 2123, the game engine running the title on the target player's device or cloud based gaming service sends a join request to the mercenary game manager. At step 2124, the mercenary game manager sends a join request to the game multiplayer server with mercenary support. At step 2125, the game multiplayer server with mercenary support sends a join response including connection information and the mercenary session ID to the mercenary game manager. At step 2126, the mercenary game manager sends a join session response including the connection information to the target players game engine. At step 2127, the device or cloud based platform system running the requesting player's game engine connects and joins the multiplayer service running on the multiplayer server with mercenary support. And at step 2128, the device or cloud based platform system running the mercenary player's game engine connects and joins the multiplayer service running on the multiplayer server with mercenary support.

At step 2129, the gaming system determines whether the mercenary made a request for the mercenary player to be streamed on a social media site. If so, at step 2130 the social media platform integration system sends a stream request to the social media platform plugin. And at step 2131, the social media platform plugin sends the stream request to the mercenary game manager. At step 2132, the mercenary game manager receives the stream request, and at step 2133 the mercenary game manager sends the stream request to the cloud based gaming platform system.

At step 2134, the cloud based gaming platform starts encoding and streaming to a URL address for the cloud gaming session. At step 2135, the cloud based gaming platform sends a stream response to the mercenary game manager. At step 2136, the mercenary game manager sends a stream response to the social media platform plugin. At step 2137, the social media platform plugin sends a stream response to the social media platform integration system. And at step 2138, the social media platform sends a notification to the mercenary user including the URL link, enabling the mercenary to watch the streamed video of their emulated player.

If, at step 2129, the gaming system determines that the mercenary did not make a request for the mercenary player to be streamed, step 2139 includes the cloud based virtual machine running the mercenary player's game to begin a recording session. At step 2140, the gaming system determines whether the mercenary has completed the mission, has been killed, or has exited the session.

At step 2141, if the mercenary has exited the session (and the mission has been completed as determined at step 2140), the process proceeds to step 2142. At step 2142, the cloud based virtual machine running the emulated mercenary player's game engine stops recording. At step 2143, the cloud based gaming platform trims the recording. At step 2144, the cloud based gaming platform sends a save video request to the mercenary game manager. And at step 2145, the mercenary game manager downloads and stores the video.

If, however, at step 2041, the mercenary has not exited the session, the process 2100 proceeds to step 2146. At step 2146, the gaming system determines whether the mercenary has successfully completed the mission. If so, at step 2147, the mercenary game manager transfers the agreed upon reward to the mercenary. Then at step 2148, the target user is notified that they were eliminated by the mercenary player, hired by a requesting user. And at step 2149, the requesting user is notified that the target was successfully eliminated.

If the mercenary player was not successful at step 2146, the gaming system determines whether the target eliminated the mercenary player at step 2150. If the target user did kill the mercenary player, the process proceeds to step 2151. At step 2151, the target user is notified that they eliminated the mercenary user. And at step 2152, the hiring user or requesting user is notified that the target user eliminated the mercenary player.

If the gaming system determines that the target user did not eliminate the mercenary at step 2150, and the mercenary mission was not successfully completed at step 2146, the process 2100 proceeds to step 2153. At step 2153, the hiring user is notified that the mercenary failed to eliminate the target user. The process 2100 then proceeds to steps 2142-2145, described above.

FIG. 22 is a block diagram representing devices, components of each device, and data flow therebetween for carrying out the functions and features disclosed herein, in accordance with some embodiments of the disclosure. System 2200 is shown to include a client device 2218, a server 2202, and a communication network 2214. It is understood that while a single instance of a component may be shown and described relative to FIG. 22, additional instances of the component may be employed. For example, server 2202 may include or may be incorporated in, more than one server. Similarly, communication network 2214 may include or may be incorporated in, more than one communication network. Server 2202 is shown communicatively coupled to client device 2218 through communication network 2214. While not shown in FIG. 22, server 2202 may be directly communicatively coupled to client device 2218, for example, in a system absent or bypassing communication network 2214.

Communication network 2214 may comprise one or more network systems, such as, without limitation, an internet, LAN, WIFI, or other network systems suitable for audio processing applications. In some embodiments, system 2200 excludes server 2202, and functionality that would otherwise be implemented by server 2202 is instead implemented by other components of system 2200, such as one or more components of communication network 2214. In still other embodiments, server 2202 works in conjunction with one or more components of communication network 2214 to implement certain functionality described herein in a distributed or cooperative manner. Similarly, in some embodiments, system 2200 excludes client device 2218, and functionality that would otherwise be implemented by the client device 2218 is instead implemented by other components of system 2200, such as one or more components of communication network 2214 or server 2202 or a combination. In still other embodiments, the client device 2218 works in conjunction with one or more components of communication network 2214 or server 2202 to implement certain functionality described herein in a distributed or cooperative manner.

The client device 2218 includes control circuitry 2228, display 2234, and input-output circuitry 2216. Control circuitry 2228 in turn includes transceiver circuitry 2262, storage 2238, and processing circuitry 2240. In some embodiments, client device 2218 or control circuitry 2228 may be configured as user device 2235 of FIG. 22.

Server 2202 includes control circuitry 2220 and storage 2224. Each of the storages 2224 and 2238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Each storage 2224, 2238 may be used to store various types of content, media data, and or other types of data (e.g., they can be used to store media content such as audio, video, and advertisement data). The non-volatile memory may also be used (e.g., to launch a boot-up routine and other instructions). Cloud-based storage may be used to supplement storages 2224, 2238 or instead of storages 2224, 2238. In some embodiments, the pre-encoded or encoded media content, in accordance with the present disclosure, may be stored on one or more of storages 2224, 2238.

In some embodiments, control circuitry 2220 and/or 2228 executes instructions for one or more application (e.g., implemented by the gaming system) stored on the memory (e.g., storage 2224 and/or storage 2238). Specifically, control circuitry 2220 and/or 2228 may be instructed by the application to perform the functions discussed herein. In some implementations, any action performed by control circuitry 2220 and/or 2228 may be based on instructions received from the application. For example, the application may be implemented as software or a set of executable instructions that may be stored on storage 2224 and/or 2238 and executed by control circuitry 2220 and/or 2228. In some embodiments, the application may be a client/server application where only a client application resides on client device 2218, and a server application resides on server 2202.

The application may be implemented using any suitable architecture. For example, it may be a stand-alone application wholly implemented on client device 2218. In such an approach, instructions for the application are stored locally (e.g., in storage 2238), and data for use by the application is downloaded periodically (e.g., from an out-of-band feed, from an internet resource, or using another suitable approach). Control circuitry 2228 may retrieve instructions for the application from storage 2238 and process the instructions to perform the functionality described herein. Based on the processed instructions, control circuitry 2228 may determine a type of action to perform in response to input received from the input/output path (or input-output circuitry) 2216 or the communication network 2214. For example, in response to a receiving a notification on the client device 2218, control circuitry 2228 may perform the steps of processes relative to various embodiments discussed herein.

In client/server-based embodiments, control circuitry 2228 may include communication circuitry suitable for communicating with an application server (e.g., server 2202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 2214). In another example of a client/server-based application, control circuitry 2228 runs a web browser that interprets web pages provided by a remote server (e.g., server 2202). For example, the remote server may store the instructions for the application in a storage device. The remote server may process the stored instructions using circuitry (e.g., control circuitry 2228) and/or generate displays. Client device 2218 may receive the displays generated by the remote server and may display the content of the displays locally via display 2234. This way, the processing of the instructions is performed remotely (e.g., by server 2202) while the resulting displays, such as the display windows described elsewhere herein, are provided locally on the client device 2218. Client device 2218 may receive inputs from the user via input circuitry 2216 and transmit those inputs to the remote server for processing and generating the corresponding displays. Alternatively, client device 2218 may receive inputs from the user via input circuitry 2216 and process and display the received inputs locally, by control circuitry 2228 and display 2234, respectively.

Server 2202 and client device 2218 may transmit and receive content and data such as media content via communication network 2214. For example, server 2202 may be a media content provider, and client device 2218 may be a smart television configured to download or stream media content, such as a YouTube video, from server 2202. Control circuitry 2220, 2228 may send and receive commands, requests, and other suitable data through communication network 2214 using transceiver circuitry 2260, 2262, respectively. Control circuitry 2220, 2228 may communicate directly with each other using transceiver circuitry 2260, 2262, respectively, avoiding communication network 2214.

It is understood that client device 2218 is not limited to the embodiments and methods shown and described herein. In non-limiting examples, the client device 2218 may be a gaming system or gaming platform, television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, client equipment, or wireless device, and/or combination of the same capable of suitably displaying and manipulating media content.

Control circuitry 2220 and/or 2218 may be based on any suitable processing circuitry such as processing circuitry 2226 and/or 2240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 2220 and/or control circuitry 2218 are configured to implement a media content operation system, such as systems, or parts thereof, that perform various processes described herein.

Client device 2218 receives a user input 2204 at input circuitry 2216. For example, client device 2218 may receive a user input like a user swipe or user touch, as previously discussed. In some embodiments, client device 2218 is a media device (or player), with the capability to access media content. It is understood that client device 2218 is not limited to the embodiments and methods shown and described herein. In non-limiting examples, the client device 2218 may be a gaming system or gaming platform, a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other television equipment, computing equipment, or wireless device, and/or combination of the same.

User input 2204 may be received from a user selection-capturing interface that is separate from device 2218, such as a remote-control device, trackpad, or any other suitable user movement sensitive or capture devices, or as part of device 2218, such as a touchscreen of display 2234. Transmission of user input 2204 to client device 2218 may be accomplished using a wired connection, such as an audio cable, USB cable, ethernet cable, or the like attached to a corresponding input port at a local device, or may be accomplished using a wireless connection, such as BLUETOOTH, Wi-Fi, WiMAX, ZIGBEE, GSM, UTMS, CDMA, TDMA, 3G, 4G, 4G LTE, or any other suitable wireless transmission protocol. Input circuitry 2216 may comprise a physical input port such as a 3.5 mm audio jack, RCA audio jack, USB port, ethernet port, or any other suitable connection for receiving audio over a wired connection, or may comprise a wireless receiver configured to receive data via BLUETOOTH, Wi-Fi, WiMAX, ZIGBEE, GSM, UTMS, CDMA, TDMA, 3G, 4G, 4G LTE, or other wireless transmission protocols.

Processing circuitry 2240 may receive input 2204 from input circuitry 2216. Processing circuitry 2240 may convert or translate the received user input 2204 that may be in the form of gestures or movement to digital signals. In some embodiments, input circuitry 2216 performs the translation to digital signals. In some embodiments, processing circuitry 2240 (or processing circuitry 2226, as the case may be) carries out disclosed processes and methods.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods. In this specification, the following terms may be understood given the below explanations:

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent or similar purpose unless expressly stated otherwise. Thus, unless expressly stated otherwise, each feature disclosed is one example only of a generic series of equivalent or similar features.

The invention(s) are not restricted to the details of any foregoing embodiments. The invention(s) extend to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract, and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A computer-implemented method comprising:
transmitting an invitation to join a future or a current gaming session of a first user;
receiving, from a second user via a second computing device, an acceptance of the invitation;
determining that the gaming session has commenced, the gaming session comprising the video game being played, by the first user on a first computing device, in a single player mode in which a first character of the first user is participating without characters of other users;
determining whether a current point in the gaming session for the video game corresponds to an insertion point;
in response to determining that the current point in the gaming session for the video game corresponds to the insertion point:
modifying the gaming session by (1) instantiating a multiplayer mode to cause the gaming session for the video game to change from the single player mode to the multiplayer mode, and (2) causing the first computing device to connect to a multiplayer video game server, wherein the multiplayer video game server enables the second user to control a second character of the modified gaming session, and wherein the modified gaming session comprises each of the first character of the first user and the second character of the second user participating in the video game;
determining whether a current point in the modified gaming session for the video game corresponds to an end trigger point; and
in response to determining that the current point in the modified gaming session corresponds to the end trigger point:
removing the second user from the modified gaming session; and
causing the modified gaming session for the video game to change from the multiplayer mode back to the single player mode.

2. The method of claim 1, wherein transmitting the invitation comprises sending the invitation via a social media account corresponding to the first user.

3. The method of claim 1, wherein the invitation is transmitted to a set of users of the video game comprising at least one of (a) friends of the first user, (b) users currently playing the video game, (c) users with a skill level in the video game above a threshold level, or (d) users of the video game having a character with a predetermined class.

4. The method of claim 1, wherein the invitation is transmitted by a third user via a third computing device, and the method further comprises preventing the first user from being alerted that the invitation was transmitted.

5. The method of claim 1, wherein the insertion point comprises a start of the gaming session for the video game, and wherein determining whether the current point in the gaming session corresponds to the insertion point of the gaming session comprises determining that the first user has started the video game.

6. The method of claim 1, wherein the insertion point comprises a cutscene of the video game, and wherein determining whether the current point in the gaming session corresponds to the insertion point of the gaming session comprises determining that the first character of the first user playing the video game has reached a checkpoint in the video game that initiates the cutscene.

7. The method of claim 1, wherein the end trigger point comprises at least one of (a) a death of the first character of the first user in the video game, (b) a death of the second character of the second user in the video game, (c) a death of a boss in the video game, (d) a completion of a level of the video game, (e) a completion of a task in the video game, or (f) a passage of a predetermined duration of play of the video game.

8. The method of claim 1, wherein the invitation is transmitted by a third user, the invitation comprising a request to eliminate the first character of the first user in the video game, the method further comprising:
transmitting an alert to the second user indicating that the first user has started the gaming session of the video game.

9. The method of claim 8, wherein the alert is a first alert, and wherein the end trigger point comprises (a) an elimination of the first character of the first user in the video game or (b) an elimination of the second character of the second user in the video game, the method further comprising:
in response to determining that the current point in the modified gaming session corresponds to the end trigger point, transmitting a second alert to the third user, the second alert indicating whether the first character of the first user was eliminated.

10. The method of claim 1, further comprising:
in response to determining that the current point in the modified gaming session corresponds to the end trigger point, providing a reward to the second user.

11. The method of claim 1, wherein transmitting the invitation further comprises:
determining, based on first settings of the first user, that the first user has activated a standby request, the standby request comprising one or more requirements within the gaming session that must be satisfied in order for the invitation to join the gaming session to be automatically transmitted; and
in response to determining that the one or more requirements within the gaming session have been satisfied, automatically transmitting the invitation to join the gaming session of the first user.

12. A system:
input/output circuitry configured to:
transmit an invitation to join a future or a current gaming session of a first user; and
receive, from a second user via a second computing device, an acceptance of the invitation; and
control circuitry configured to:
determine that the gaming session has commenced, the gaming session comprising the video game being played, by the first user on a first computing device, in a single player mode in which a first character of the first user is participating without characters of other users;
determine whether a current point in the gaming session for the video game corresponds to an insertion point;
in response to determining that the current point in the gaming session for the video game corresponds to the insertion point:
modify the gaming session by (1) instantiating a multiplayer mode to cause the gaming session for the video game to change from the single player mode to the multiplayer mode, and (2) causing the first computing device to connect to a multiplayer video game server, wherein the multiplayer video game server enables the second user to control a second character of the modified gaming session, and wherein the modified gaming session comprises each of the first character of the first user and the second character of the second user participating in the video game;
determine whether a current point in the modified gaming session for the video game corresponds to an end trigger point; and
in response to determining that the current point in the modified gaming session corresponds to the end trigger point:
remove the second user from the modified gaming session; and
cause the modified gaming session for the video game to change from the multiplayer mode back to the single player mode.

13. The system of claim 12, wherein the input/output circuity is further configured to transmit the invitation by sending the invitation via a social media account corresponding to the first user.

14. The system of claim 12, wherein the input/output circuitry is further configured to transmit the invitation to a set of users of the video game comprising at least one of (a) friends of the first user, (b) users currently playing the video game, (c) users with a skill level in the video game above a threshold level, or (d) users of the video game having a character with a predetermined class.

15. The system of claim 12, wherein the invitation is transmitted by a third user via a third computing device, and the control circuitry is further configured to prevent the first user from being alerted that the invitation was transmitted.

16. The system of claim 12, wherein the insertion point comprises a start of the gaming session for the video game, and wherein the control circuitry is configured to determine whether the current point in the gaming session corresponds to the insertion point of the gaming session by determining that the first user has started the video game.

17. The system of claim 12, wherein the insertion point comprises a cutscene of the video game, and wherein the control circuitry is configured to determine whether the current point in the gaming session corresponds to the insertion point of the gaming session by determining that the first character of the first user playing the video game has reached a checkpoint in the video game that initiates the cutscene.

18. The system of claim 12, wherein the end trigger point comprises at least one of (a) a death of the first character of the first user in the video game, (b) a death of the second character of the second user in the video game, (c) a death of a boss in the video game, (d) a completion of a level of the video game, (e) a completion of a task in the video game, or (f) a passage of a predetermined duration of play of the video game.

19. The system of claim 12, wherein the invitation is transmitted by a third user, the invitation comprising a request to eliminate the first character of the first user in the video game, wherein the input/output circuitry is further configured to:
transmit an alert to the second user indicating that the first user has started the gaming session of the video game.

20. The system of claim 19, wherein the alert is a first alert, and wherein the end trigger point comprises (a) an elimination of the first character of the first user in the video game or (b) an elimination of the second character of the second user in the video game, and wherein the input/output circuitry is further configured to:
in response to determining by the control circuitry that the current point in the modified gaming session corresponds to the end trigger point, transmit a second alert to the third user, the second alert indicating whether the first character of the first user was eliminated.

21-55. (canceled)
